(19) United States
(12) Patent Application Publication
(10) Pub. No.: US 2007/0119069 A1
(43) Pub. Date: May 31, 2007

(54) Electromagnetically-shielded hair drying systems and methods

(76) Inventor: Youngtack Shim, Port Moody (CA)

Correspondence Address: Youngtack Shim, 155 Aspenwood Drive, Port Moody, BC, V3H 5A5, CA

(21) Appl. No.: 11/289,578

(22) Filed: Nov. 30, 2005

(51) Int. Cl. A45D 20/12; F26B 3/34

(52) U.S. Cl. 34/96; 34/245

(57) ABSTRACT

The present invention generally relates to electromagnetically-shielded hair drying systems for drying or dehumidifying hair. More particularly, the present invention relates to hair drying systems for preventing or at least minimizing electromagnetic waves emitted by actuator and heating members of the system from propagating to a target using various modalities such as, e.g., installing magnetic and electric shields between such members and target, varying distances from the members to the target, generating counter electromagnetic waves for canceling at least portions of the waves irradiated by the actuator and heating members, and so on. The present invention also relates to various methods of preventing or minimizing such waves irradiated by the system from propagating to the target. The present invention further relates to various processes for providing such members of the system.

### CROSS-REFERENCES TO RELATED APPLICATIONS

The present application is related to various patent applications which have been filed by the same Applicant. The first is the U.S. Utility patent application entitled “Shunted Magnet Systems and Methods,” filed on Aug. 30, 2005, and bearing a Ser. No. 11/213,703. The second is the U.S. Utility patent application entitled “Magnet-Shunted Systems and Methods,” filed on Aug. 30, 2005, and bearing a Ser. No. 11/213,686. The third is the U.S. Provisional patent application entitled “Electromagnetic Shield Systems and Methods,” filed on Oct. 3, 2005, and bearing a Ser. No. U.S. Ser. No. 60/723,274, and the Disclosure Document entitled the same, deposited in the U.S. Patent and Trademark Office (the “Office”) on Oct. 3, 2005 under the Disclosure Document Deposit Program (the “DDDP”) of the Office, and bearing a Ser. No. 587,338. The fourth is the U.S. Provisional Patent Application entitled “Electromagnetically-Shielded Heat Generating Systems and Methods,” filed on Nov. 3, 2005, and bearing a Ser. No. 60/732,470, and the Disclosure Document entitled the same, deposited in the Office on Nov. 3, 2005 under the DDDP of the Office, and bearing a Ser. No. 589,146. The last of such applications is the U.S. Provisional Patent Application entitled “Electromagnetically-Shielded Hair Drying Systems and Methods,” filed on Nov. 18, 2005, and bearing a Ser. No. 60/737,486, and the Disclosure Document entitled the same, deposited in the Office on Nov. 18, 2005, and bearing a Ser. No. 5______. All of such Patent Applications and/or Documents are referred to hereinafter as the “co-pending Applications” all of which are to be incorporated herein in their entirety by reference.

### FIELD OF THE INVENTION

The present invention generally relates to electromagnetically-shielded hair drying systems for drying or dehumidifying hair. More particularly, the present invention relates to hair drying systems for preventing or at least minimizing electromagnetic waves emitted by actuator and heating members of the system from propagating to a target using various modalities. The system may incorporate at least one magnetic shield and/or electric shield between such members and target so as to prevent at least portions of such waves from reaching the target. Such a system may include at least one mobile unit which may move one of such members toward and away from an air outlet thereof, thereby varying distances from the members to the target and dispersing more of such waves away from the target. Such a system may also be arranged to generate counter electromagnetic waves which may cancel at least portions of the waves emitted by the actuator and heating members. A separate article with or without such shields may also be provided to couple with the air outlet and/or to be disposed on an exterior of the system for the above purposes. The system may also include a hand unit and a base unit, where the actuator and/or heating members may be disposed in the base unit, thereby reducing a volume and a weight of the hand unit, suppressing formation of the line of sight between the air outlet disposed in the hand unit and the actuator and/or heating members disposed in the base unit, and the like. The present invention relates to various methods of preventing or minimizing such waves emitted by such members of the system from propagating to the target. More particularly, such methods may include various steps of blocking a line of sight between the air outlet and at least one wave source of the system, dispersing more of such waves by increasing the distance between the air outlet and the wave source, canceling at least portions of the waves irradiated by multiple sources, generating counter waves which may cancel at least portions of the waves emitted by such sources, disposing the wave source in one unit while defining the air outlet in another unit, reducing a weight and volume of a hand unit of a multiunit system, and the like. The present invention relates to various processes for making such a system, fabricating various conduits with or without any the baffles and/or bends, forming mobile members and/or units thereof, providing various magnetic and electric shields for the members and/or units of the systems, fabricating assemblies of such actuator and heating members capable of canceling at least portions of the waves emitted thereby, making various counter members capable of canceling at least portions of the waves irradiated by such actuator and heating members, fabricating separate articles capable of blocking and/or dispersing at least portions of such waves from the target, and the like.

### BACKGROUND OF THE INVENTION

It is now well established in the scientific community that electromagnetic waves of varying frequencies irradiated by various devices may be hazardous to human health. In some cases, such electromagnetic waves in mega- and giag-hertz range may be the main culprit, whereas the 60-hertz electromagnetic waves may be the main health concern in other cases. It cannot be too emphasized that it is very difficult to shield against magnetic waves of the 60-hertz electromagnetic waves which have wavelengths amounting to thousands of kilometers and that such 60-hertz magnetic waves are omnipresent in any corner of the current civilization.

Intensities of the electromagnetic waves generally decrease inversely proportional to a square of a distance between a source of such waves and a target to be protected. Accordingly, potential health hazard may be minimized simply by keeping a safe distance from the wave source. However, some electrical devices are intended to be used in proximity to a target. One typical example is a hair dryer which includes therein a heat generator and an AC motor and which also causes a major health concern, for both of the motor and heat generator inevitably include multiple wires wound into a shape of coils, a well-known source of strong electromagnetic waves and for the user has to point the hair dryer in a close proximity toward his or her brain, a major warehouse of the most sensitive cells of a human body.

Accordingly, there is an urgent need for hair drying systems capable of preventing (or at least minimizing) the electromagnetic waves irradiated thereby from propagating toward the target. There also is an urgent need for hair drying systems which emit the electromagnetic waves of which the intensities may not exceed a certain limit, such as 2 mG when measured at a distance as is normally used.

### SUMMARY OF THE INVENTION

The present invention generally relates to electromagnetically-shielded hair drying systems for drying or dehumidifying hair. More particularly, the present invention relates to hair drying systems for preventing (or at least minimizing) electromagnetic waves emitted by actuator and heating members of the system from propagating to a target using various modalities such as, e.g., installing magnetic and electric shields between such members and target, varying distances from the members to the target, generating counter electromagnetic waves for canceling at least portions of the waves irradiated by the actuator and heating members, and so on. The present invention also relates to various methods of preventing or minimizing such waves irradiated by the system from propagating to the target. The present invention further relates to various processes for providing such members of the system.

Therefore, one objective of the present invention is to reduce magnetic waves and/or electric waves (to be abbreviated as “MWs” and/or “EWs”, respectively, hereinafter) which are generated by various members of various hair drying systems. A related objective is to reduce the MWs generated by a heating member and/or an actuator member of the system. Another related objective is to reduce the EWs generated by the heating and/or actuator members of the system. Another related objective is to reduce such MWs and/or EWs which are irradiated through an air outlet of the system. Another related objective is to reduce such MWs and/or EWs which propagate through sides of the system.

Another objective of the present invention is to form a hair drying system with configurations capable of preventing or suppressing lines of sight between the air outlet of the system and its wave sources such as actuator and heating members. In one example, one or more baffles may be installed along the conduit in order to obstruct a cross-section of such a conduit, thereby preventing or at least suppressing such a line of sight. In another example, the conduit may also be bent about one or more bends until such a line of sight may be blocked by such bends.

Another objective of the present invention is to form a electromagnetically-shielded hair drying system for preventing or at least minimizing magnetic and/or electric waves irradiated by such wave sources from propagating toward the target through the air outlets of such a system. In one example, at least one magnetic shield (to be abbreviated as “MS” hereinafter) and/or at least one electric shield (to be abbreviated as “ES” hereinafter) may be disposed along the conduit so as to obstruct a cross-section of the conduit, thereby preventing or at least suppressing a line of sight for such waves from the air outlet to the wave sources. Such a shield may be incorporated into the baffle similarly installed along the conduit as well. In another example, the conduit may be bent about one or more bends and the MS and/or ES may then be installed along the conduit until the line of sight for such waves may be blocked thereby.

Another objective of the present invention is to form a hair drying system capable of changing a distance between the air outlet and at least one wave source such that they are disposed closer to each other when not in use and that they then move apart from each other during use. One or more members, units, and/or sections of the hair drying system may be arranged to move with respect to the others thereof by various mechanisms.

Another objective of the present invention is to form a electromagnetically-shielded hair drying system capable of reducing intensities of the MWs and/or EWs propagating toward the target. In one example, the system may have a mobile air outlet which may move toward and away from the wave sources so that the intensities of the waves may be weakened by moving the air outlet away from the wave sources during use. Conversely, the system may have mobile wave sources which may move the sources toward and away from the air outlet (and target) such that the intensities of such waves may be reduced by moving such sources away from the air outlet (and target) during use.

Another objective of the present invention is to provide a hair drying system for disposing the air outlet and wave sources in different positions in and around such a system based upon various arrangements. The system may include a body member with multiple units, in which the air outlet and waves sources may be incorporated into different units at least one of which may translate, pivot or otherwise move with respect to the rest of such units. The body member may include an elongated unit and one or more transverse units which may couple with the elongated unit at a preset angle.

Another objective of the present invention is to form a hair drying system capable of improving an efficiency of heat transfer from the heating member to a stream of air flowing through the conduit by the actuator member. In one example, the conduit may form a single or multiple paths of air having tortuous shapes, thereby increasing a length of total air paths per unit distance along such a conduit. By disposing at least a portion of the heating member along a greater length of the conduit, the heat transfer efficiency may be improved. In another example, the conduit may define at least one portion with a bigger or wider dimension than the rest thereof, thereby increasing a residence time of the air flowing therethrough. Accordingly, the heating element may transfer more heat to the air residing for an extended period of time. In another example, the conduit may include at least one heat exchange member therealong, where the latter may similarly form a single or multiple tortuous air paths, a bigger or wider portion than the conduit, and the like, thereby enhancing the heat transfer efficiency. In yet another example, at least one thermal insulating material may enclose an exterior and/or interior of the conduit, thereby minimizing loss of heat through sides of the conduit and increasing the efficiency of heat transfer.

Another objective of the present invention is to form a hair drying system capable of canceling at least portions of electromagnetic waves irradiated by one or all wave sources of such a system by counter waves which are generated by the other wave source and/or a separate counter member. In one example, the heating and actuator members may be oriented and/or receive the electric current in such a way that the electromagnetic waves generated by one of such members may propagate in a direction at least partially opposite to another direction of the waves generated by the other of such members, thereby canceling at least portions of one of such waves by the other of such waves. In another example, the heating (or actuator) member may include an extra portion of a conductor which may then be disposed around an interior or exterior of the actuator (or heating) member in such a way that the waves emitted by the extra portion may cancel at least portions of one of such members. In another example, at least one counter member may be provided around such actuator and/or heating members and arranged to irradiate counter waves which may propagate in a direction at least partially opposite to a direction of the waves irradiated by one or both of such actuator and heating members, thereby canceling at least portions of such waves from the actuator and/or heating members. In yet another example, any cable of the system which is a part of the actuator and heating members may be recruited to emit such counter waves by e.g., oriented and/or disposed in a preset configuration or receiving electric current in a preset direction, thereby canceling at least portions of the waves from the actuator and/or heating members.

Another objective of the present invention is to fabricate an article capable of coupling with a preset portion of a hair drying system and reducing such electromagnetic waves propagating toward the target. In one example, an article may be shaped and sized to couple with such an air outlet of the system and to increase the distance from the wave sources of the system to the air outlet. In another example, an article may be arranged to prevent or suppress formation of the line of sight between the wave sources and air outlet, while optionally including the MS and/or ES therein. In another example, an article may be arranged to conform to an exterior of at least a portion of a side and/or a rear of the system and to incorporate the MS and/or ES thereon, thereby preventing or at least suppressing such waves to penetrate therethrough toward the target.

Another objective of the present invention is to provide a hair drying system capable of limiting intensities of the MWs and/or EWs emitted by its wave sources below a preset limit when measured at a preset distance from a preset landmark such as, e.g., the air outlet, the wave sources such as the actuator and/or heating members, various locations along a longitudinal or radial direction of the conduit, and so on. Any of the aforementioned techniques may be incorporated and fortified, when necessary, until the intensities of the waves may fall below such a limit.

Another objective of the present invention is to form a hair drying system having multiple units, where the air outlet may be defined in one of the units, while at least one of the actuator and heating members may be disposed in another of the units. By moving such one of the units with respect to such another unit while maintaining a minimum distance therebetween, such a system may minimize the intensities of the MWs and/or EWs propagating through the air outlet, through other parts of such one unit, and the like.

Another objective of the present invention is to form a hair drying system including a hand unit and a base unit, where the hand unit may define the air outlet, while the base unit may couple with a stationary object and incorporate the actuator and/or heating members. Accordingly, the system may form the hand unit with a less weight and volume and minimize the intensifies of the MWs and/or EWs propagating through the air outlet.

Another objective of the present invention is to form a hair drying system having such a hand unit and base unit, where the actuator member emitting more of such MWs and EWs may be disposed in the base unit, while the heating member emitting less of such MWs and EWs may be disposed in the hand unit. The system may not only reduce the weight and volume of the hand unit but also improve the heat transfer efficiency between the heating member and air flowing through the hand unit.

Another objective of the present invention is to form a hair drying system having such a hand unit and base unit both of which may be fluidly coupled by an intervening coupling unit. In particular, such a coupling unit may have a preset length which may be generally greater than a length of such a conduit disposed in the hand unit, thereby capable of decreasing the intensities of the MWs and EWs below a preset limit.

Another objective of the present invention is to form a hair drying system including the above hand unit, base unit, and coupling unit at least a portion of which may be incorporated into or along a separate object. Therefore, the hand and base units may be coupled to opposing portions of such a portion of the coupling unit.

Another objective of the present invention is to form a hair drying system including the above hand unit and base unit, where the base unit may be arranged to be retained by and/or in a separate object. Thus, the user may fixedly or releasably couple the base unit to the article, while manipulating the hand unit more readily.

Another objective of the present invention is to form a hair drying system having such a hand unit and base unit, where the actuator member which makes most of noises from such a system may be incorporated into the base unit which may be in turn disposed away from the hand unit. In addition, the system may include the coupling unit as well which may absorb at least a portion of such noises while transporting the flow of heated or room-temperature air therethrough. Accordingly, the system may significantly reduce the noises near its hand unit.

The present invention also aims to attain other objectives which have already been described in the co-pending Applications described hereinabove.

Various hair drying systems as well as their members and/or features of the present invention may be applied for various purposes. For example, such systems may be used as household and/or commercial devices for treating hair. Examples of such devices may include, but not be limited to, hair dryers, hair setters, hair curlers, and the like. When the device may not involve any flow of heated air toward the target but may only provide heat theretoward, the hair drying system of this invention may be modified by removing its conduit and actuator members while retaining the rest of the members and their features. Some conventional hair setters and curlers may belong to this category.

Various hair drying systems of this invention may be used to provide the flow of heated air not to the hair but to other parts of the user and other objects. For example, such systems may be utilized to provide the flow of heated air to the body of the user or to a space such as a room, thereby being used as convective heaters. In another example, such systems may be used as heat-guns designed to provide the flow of heated air to an object to substantially increase its temperature. In addition, the systems may be used to provide the flow of steam to the hair. As long as it is desirable to provide the flow of heated air or other gases and/or fluids, various systems of the present invention may be used to meet the needs while preventing or minimizing propagation of magnetic and electric waves toward the target.

Various hair drying systems of the present invention may also be modified to provide a flow of air with a temperature lower than the atmosphere. Such systems may include conventional cooling or air-conditioning units instead of the heating member and may be arranged to provide a flow of cooled air through its air outlet. Various mechanisms for the hair drying system may then be applied in order to prevent or at least minimize propagation of electromagnetic waves emitted by the actuator member and cooling and/or air-conditioning units as well.

Various aspects and/or embodiments of various systems, methods, and/or processes of this invention will now be described. Such systems, methods, and/or processes, however, may also be embodied in many other different forms and, accordingly, should not be limited to such aspects and/or embodiments which are set forth herein. Rather, various exemplary aspects and/or embodiments as described herein are provided such that this disclosure will fully convey the scope of this invention to one of ordinary skill in the relevant art.

In one aspect of the present invention, a hair drying system is provided for generating a flow of heated air through at least one air outlet thereof while preventing (or at least minimizing) formation of a line of sight between the air outlet and at least one source of the system emitting magnetic waves and electric waves of electromagnetic waves.

In one exemplary embodiment of this aspect of the invention, a hair drying system may include at least one conduit member, at least one actuator member, as well as at least one heating member. Such a conduit member may be arranged to define therealong at least one conduit for a flow of air, to have at least one air inlet in at least one end of the conduit, and to form the air outlet in at least another end of the conduit, where this conduit member is to be referred to as “the standard conduit members” hereinafter. The actuator member may be arranged to take air into the conduit through the air inlet, to move the air through the conduit, and to discharge the air out of the conduit through the outlet, thereby generating the flow of the air while irradiating the waves. Such an actuator member is to be referred to as “the standard actuator member” hereinafter. Such a heating member may be disposed along the conduit (or near and/or on the air inlet) and may also be arranged to generate heat by flowing electric current therein while irradiating such waves and to transfer at least a portion of such heat onto the air which flows through the conduit, thereby generating the flow of heated air. This heating member is to be referred to as “standard heating member” hereinafter. Such a conduit member may be arranged to prevent (or at least minimize) formation of the line of sight between such an air outlet and at least one of the heating and actuator members but to allow the flow through the conduit.

In another exemplary embodiment of such an aspect of the invention, a hair drying system may include at least one conduit member, at least one standard actuator member, and at least one standard heating member. The conduit member is similar to the standard conduit member but may also include at least one baffle which may be arranged to be disposed along the conduit member and to obstruct a cross-section of such a conduit while allowing the flow through the conduit, thereby preventing (or at least minimizing) formation of the line of sight between the air outlet and at least one of the heating and actuator members.

In another exemplary embodiment of such an aspect of the invention, a hair drying system may include at least one conduit member, at least one standard actuator member, and at least one standard heating member. The conduit member is similar to the standard conduit member but may be arranged to define at least one bend along the conduit. Such a bend may be arranged to be disposed along the conduit member and to prevent (or at least minimize) formation of the line of sight between such an air outlet and at least one of the heating and actuator members.

In another aspect of the present invention, a hair drying system may be formed for generating a flow of heated air through at least one air outlet thereof while varying a distance between such an air outlet and at least one source of the system which emits electromagnetic waves.

In one exemplary embodiment of this aspect of the invention, a hair drying system may include at least one standard conduit member, at least one standard actuator member, as well as at least one standard heating member. At least one of the actuator member, heating member, and a portion of the conduit member may be arranged to move from one to another of at least two states while varying the distance between the air outlet and at least one of the actuator and heating members.

In another exemplary embodiment of such an aspect of the invention, a hair drying system may include at least one conduit member, at least one standard actuator member, and at least one standard heating member. The conduit member may be arranged to define therealong at least one conduit for a flow of air, to form at least one air inlet in at least one end of the conduit, and to also define in at least another end of the conduit the air outlet which may be arranged to translate between at least one off-state and at least one on-state. The air outlet may be arranged to be disposed at one distance from at least one of the actuator and heating members in the off-state, and to translate to a greater distance therefrom in the on-state.

In another exemplary embodiment of such an aspect of the invention, a hair drying system may include at least one conduit member, at least one standard actuator member, and at least one standard heating member. The conduit member may be arranged to define therealong at least one conduit for a flow of air, to define at least one air inlet in at least one end of the conduit, to define the air outlet in at least another end of the conduit, and to include at least one mobile section which may be arranged to translate relative to the rest of the conduit member between at least one off-state and at least one on-state. The air outlet may be arranged to be disposed at one distance from at least one of the actuator and heating members when the mobile section is in the off-state and then to be disposed to a greater distance therefrom when the mobile section translates to the on-state.

In another exemplary embodiment of such an aspect of the invention, a hair drying system may include at least one standard conduit member, at least one standard actuator member, and at least one standard heating member. In one example, at least one of such actuator and heating members may be arranged to move between at least one off-state and at least one on-state, to be also disposed at one distance from the air outlet in the off-state, and then to translate to at a greater distance therefrom in the on-state. In another example, at least one of the actuator and heating members may be arranged to pivot between at least one off-state and at least one on-state, to be disposed at one distance from the air outlet in the off-state, and to be disposed at a greater distance therefrom when the at least one of the members pivots to the on-state.

In another aspect of the present invention, a hair drying system may have at least one air inlet, air conduit, and conduit between the inlet and outlet and may also be capable of generating a flow of heated air from the inlet to the outlet through the conduit while moving at least one of the air outlet and at least one source of the system emitting electromagnetic waves.

In one exemplary embodiment of this aspect of the invention, a hair drying system may include at least one standard actuator member, at least one standard heating member, and at least one body member. The body member may be arranged to include at least one grip unit and at least one non-grip unit, where the grip unit may be arranged to be held by an user of the system, while the non-grip unit may be arranged to not be held thereby. One of such units may be arranged to include the air outlet, the other of such units may be arranged to include at least one of the actuator and heating members, while at least one of the units may be mobile and arranged to move between at least two states while varying a distance from the air outlet to the at least one of the members.

In another exemplary embodiment of such an aspect of the invention, a hair drying system may include at least one standard actuator member, at least one standard heating member, and at least one body member. The body member may be arranged to have at least one grip unit and at least one non-grip unit, where the grip unit may be arranged to be held by an user, while the non-grip unit may not be intended to be held by the user. In one example, the non-grip unit may be arranged to have the air outlet therein, while the grip unit may be arranged to include at least one of the actuator and heating members therein. One of such units may be mobile and arranged to move toward and away from the other of such units between at least two states while varying a distance from the air outlet to such at least one of the members. In another example, the grip unit may be arranged to include the air outlet therein, whereas the non-grip unit may be arranged to include at least one of the actuator and heating members therein. One of such units may be mobile and arranged to move toward and away from the other of the units between at least two states while varying a distance from the air outlet to such at least one of the members.

In another exemplary embodiment of such an aspect of the invention, a hair drying system may include at least one standard actuator member, at least one standard heating member, and at least one body member. The body member may be arranged to have at least one grip unit and at least one non-grip unit, where the grip unit may be arranged to be held by an user, and the non-grip unit may not be intended to be held by the user. In one example, one of such units may be arranged to include at least one stationary section and at least one mobile section, where the air outlet may be disposed in one of the sections, while at least one of the actuator and heating members may be disposed in at least one of the other of the sections and the other of the units. The mobile section may be arranged to move toward and away from at least one of the other of the sections and the other of the units between at least two states while varying a distance between the air outlet and such at least one of the heating and actuator members. In another example, the non-grip unit may be arranged to include at least one stationary section and at least one mobile section. The air outlet may be disposed in the stationary (or mobile) section, while at least one of the actuator and heating members may be disposed in the mobile (or stationary) section. The mobile section may also be arranged to move toward and away from the stationary section while varying a distance between the air outlet and such at least one of the heating and actuator members. In another example, the non-grip unit may be arranged to include at least one stationary section and at least one mobile section, and the air outlet may be disposed in the stationary (or mobile) section. At least one of the actuator and heating members may be disposed inside the grip unit, while the mobile section may be arranged to move toward and away from the stationary section and grip unit while varying a distance between the air outlet and such at least one of the members. In another example, the grip unit may be arranged to include at least one stationary section and at least one mobile section. The air outlet may be disposed in the non-grip unit, at least one of such actuator and heating members may be disposed in the mobile section, and the mobile section may be arranged to move toward and away from the non-grip unit while varying a distance between the air outlet and such at least one of the members.

In another exemplary embodiment of such an aspect of the invention, a hair drying system may include at least one standard actuator member, at least one standard heating member, and at least one body member. The body member may be arranged to have at least one grip unit, at least one non-grip unit, and at least one mobile unit, where the grip unit may be intended to be held by an user, while the non-grip unit may not be intended to be held thereby. The mobile unit may be arranged to be movably disposed to move toward and away from at least one of the units between at least two states while varying a distance between the air outlet and such at least one of the members.

In another exemplary embodiment of such an aspect of the invention, a hair drying system may include at least one standard actuator member, at least one standard heating member, and at least one body member. The body member may be arranged to have at least one grip unit, at least one first non-grip unit, and at least one second non-grip unit, where the grip unit may be intended to be held by an user, while the non-grip units may be intended not to be held by the user. The first non-grip unit may be arranged to include the air outlet, while the second non-grip unit may be arranged to have at least one of the actuator and heating members, to be disposed away from the grip unit, and to be disposed farther away from the air outlet. One of the first and second non-grip units may be mobile and further arranged to move toward and away from the other thereof between at least two states while varying a distance between the air outlet and such at least one of the members.

In another aspect of the present invention, another hair drying system may further be provided for generating a flow of heated air through at least one air outlet thereof while preventing (or at least minimizing) formation of a line of sight for magnetic (and electric) waves between the air outlet and at least one source of the system irradiating the waves and protecting a target from the waves.

In one exemplary embodiment of this aspect of the invention, a hair drying system may include at least one standard conduit member, at least one standard actuator member, at least one standard heating member, and at least one magnetic (and electric) shield which may be arranged to prevent (or at least minimize) at least a preset portion of the waves from penetrating therethrough, to be disposed in the conduit member in at least one location thereof which may be positioned between the air outlet and at least one of the actuator and heating members, and to obstruct a cross-section of the conduit while allowing the flow, thereby preventing (or at least minimizing) formation of the line of sight for the magnetic (and electric) waves therebetween and thereby protecting the target from the waves.

In another exemplary embodiment of such an aspect of the invention, a hair drying system may include at least one conduit member, at least one standard actuator member, and at least one standard heating member. The conduit member may be arranged to define therealong at least one conduit for a flow of air, to define at least one air inlet in at least one end of the conduit, to define the air outlet in at least another end of the conduit, and to include at least one baffle which may be arranged to include in at least a portion thereof at least one magnetic (and electric) shield which may also be arranged to prevent (or at least minimize) at least a preset portion of such waves from penetrating therethrough. Such a magnetic (and electric) shield may be arranged to be disposed between the air outlet and at least one of the actuator and heating members and to obstruct a cross-section of the conduit while allowing the flow through the conduit, thereby preventing (or at least minimizing) formation of the line of sight for the magnetic (and electric) waves therebetween as well as protecting the target from the waves.

In another exemplary embodiment of such an aspect of the invention, a hair drying system may include at least one conduit member, at least one standard actuator member, and at least one standard heating member. The conduit member may be arranged to define therealong at least one conduit for a flow of air, to define at least one air inlet in at least one end of the conduit, to define the air outlet in at least another end of the conduit, to define at least one bend in the conduit, and to include in at least a portion thereof at least one magnetic (and electric) shield which may similarly be arranged to prevent (or at least minimize) at least a preset portion of the waves from penetrating therethrough. The bend may be arranged such that the magnetic (and electric) shield which is disposed in the conduit member may be arranged to be positioned between the air outlet and at least one of the actuator and heating members, thereby preventing (or at least minimizing) formation of such a line of sight for the magnetic (and electric) waves therebetween and thereby protecting the target from the waves.

In another aspect of the present invention, a hair drying system may be formed for generating a flow of heated air through at least one air outlet thereof while varying a distance between such an air outlet and at least one source of the system emitting electromagnetic waves and preventing (or at least minimizing) propagation of the waves through the air outlet.

In one exemplary embodiment of this aspect of the invention, a hair drying system may include at least one standard conduit member, at least one standard actuator member, as well as at least one standard heating member. At least one of the actuator member, heating member, and a portion of the conduit member may be arranged to move between at least two states while varying such a distance between the air outlet and at least one of such actuator and heating members, thereby dispersing a greater portion of the waves away from the air outlet in one of the states than in another thereof and preventing (or at least minimizing) such propagation of a greater portion of the waves through the air outlet in the one of the states than in the another of the states.

In another exemplary embodiment of such an aspect of the invention, a hair drying system may include at least one conduit member, at least one standard actuator member, and at least one standard heating member. The conduit member may be arranged to define therealong at least one conduit for a flow of air, to have at least one air inlet in at least one end of the conduit, and to also define in at least another end of the conduit the air outlet which may be arranged to translate between at least one off-state and at least one on-state. The air outlet may be arranged to be disposed at one distance from at least one of the actuator and heating members in the off-state, and to translate to a greater distance therefrom in the on-state, whereby the system may be capable of dispersing a greater portion of the waves away from the air outlet in the on-state than in the off-state and further preventing (or at least minimizing) the propagation of a greater portion of the waves through the air outlet in the on-state than in the off-state.

In another exemplary embodiment of such an aspect of the invention, a hair drying system may include at least one conduit member, at least one standard actuator member, and at least one standard heating member. The conduit member may be arranged to define therealong at least one conduit for a flow of air, to define at least one air inlet in at least one end of the conduit, to define the air outlet in at least another end of the conduit, and to include at least one mobile section which may be arranged to translate with respect to the rest of the conduit member between at least one off-state and at least one on-state. The air outlet may be arranged to be disposed at one distance from at least one of the actuator and heating members when the mobile section may be in the off-state and to be disposed at a greater distance from such at least one of the members when the mobile section may translate to the on-state, whereby the system may be capable of dispersing a greater portion of the waves away from the air outlet in the on-state than in the off-state as well as preventing (or at least minimizing) the propagation of a greater portion of the waves through such an air outlet in the on-state than in the off-state.

In another exemplary embodiment of such an aspect of the invention, a hair drying system may include at least one standard conduit member, at least one standard actuator member, and at least one standard heating member. In one example, at least one of such actuator and heating members may be arranged to move between at least one off-state and at least one on-state, to also be disposed at one distance from the air outlet in the off-state, and to translate to a greater distance therefrom in the on-state, thereby dispersing a greater portion of the waves away from the air outlet in the on-state than in the off-state and thereby preventing (or at least minimizing) such propagation of a greater portion of the waves through the air outlet in the on-state than in the off-state. In another example, at least one of such actuator and heating members may be arranged to pivot between at least one off-state and at least one on-state, to be disposed at one distance from such an air outlet in the off-state, and to be disposed at a greater distance therefrom when such at least one of the members may pivot to the on-state, thereby dispersing a greater portion of the waves away from the air outlet in the on-state than in the off-state and further preventing (or at least minimizing) such propagation of a greater portion of the waves through the air outlet in the on-state than in the off-state.

Embodiments of the foregoing five aspects of the present invention may include one or more of the following features.

The conduit may extend in any lengths along its curvilinear longitudinal axis, and may define a cross-section of any shapes and/or sizes. The conduit may include multiple sections which may also bifurcate or merge each other. The conduit may be parallel to a line which connects the air inlet and air outlet or may be transverse to such a line. The conduit may include multiple portions at least one of which may be parallel to a line connecting the air inlet and air outlet and at least one of which may be transverse to such a line. The conduit may have a tortuous shape and define a total curvilinear length therealong which is greater than a distance between the air inlet and air outlet.

The baffle may define a cross-section of any shapes and/or sizes as long as it may not totally obstruct the cross-section of the conduit. The baffle may be movably, releasably or fixedly disposed and arranged to obstruct different portions of the cross-section of the conduit. The baffle may define a two- or three-dimensional configuration. The baffle may be solid or porous, rigid or flexible, and the like. The baffle may be disposed at a preset angle with respect to a wall of the conduit member. The baffle may also have a curvature capable of minimizing (or at least reducing) friction of the flow of air thereover. The conduit member may include both of the baffle and bend. Such a conduit member may have multiple baffles and/or bends. At least two of the baffles (and/or bends) may be identical, similar or different. At least two of the baffles (and/or bends) may also be disposed along identical, similar or different locations of the conduit member. At least two of the baffles (and/or bends) may be disposed symmetrically or asymmetrically. At least two of the baffles may be disposed on opposite sides along the conduit. The system may include multiple baffles at least two of which may also obstruct different portions of the cross-section of the conduit.

Such a mobile member and/or its sections may move along a straight path or a curved path. At least a portion of the conduit member may be disposed inside at least a portion of the body member or may be exposed through the body member. At least a portion of the body member may operate as at least a portion of the conduit member. Such conduit and body members may be arranged to terminate together in at least one of the air inlet and air outlet. The conduit member may extend farther than the body member in at least one of the air inlet and air outlet.

The body member (or its units) may extend in any lengths along its curvilinear longitudinal axis. The body member (or its units) may define a cross-section of any shapes and/or sizes. The units of the body member may bifurcate and/or merge each other. The body member (or its units) may include the baffle and/or bend. The body member, its mobile units, and/or its mobile sections may move along a straight path or a curved path.

The air inlet may be disposed in at least one of the other of such units and/or sections in which the air outlet is not disposed. The air inlet may be disposed in only one of the grip and non-grip units. The air inlet may be disposed in both of the grip and non-grip units.

The system may vary the distance while at least substantially maintaining an area of a cross-section of the air outlet. The system may vary the distance without releasably attaching or detaching an article onto or away from the conduit member, respectively. The system may vary the distance by releasably attaching or detaching an article capable of preventing (or at least minimizing) the formation of the line of sight. The member, unit, and/or section which may move between at least two states may be placed in one of multiple preset positions so that the distance of the system may be arranged to have each of multiple preset distances. The member, unit, and/or section moving between at least two states may also move telescopically so that the distance may be any distance between a preset maximum distance and a preset minimum distance.

The system may incorporate at least one MS (and ES) on, over, around, in, and/or into at least a portion of at least one of the conduit, body, heating, and actuator members. The system may vary the distance by releasably attaching (or detaching) an article including at least one MS (and ES) onto (or away from) the conduit member. The MS and ES may be any of those disclosed in the co-pending Applications. For example, the MS may include at least one path member but not include any magnet member both of which have been disclosed in such co-pending Applications. In addition, the MS may optionally include at least one path member and at least one magnet member both of which have been disclosed in the co-pending Applications. The ES may shield a target from electric waves through one or more of mechanisms which have been described in the co-pending Applications. The ES may be grounded. The MS may shield a target from the EWs by one or more of mechanisms described in the co-pending Applications. The MS (and ES) may be disposed on (or over, around, in) at least a portion of at least one of such conduit, actuator, and/or heating members. The MS (and ES) may be disposed over at least a (or entire) portion of the baffle. The MS (and ES) may be disposed along the bend or away therefrom. The system may have at least two baffles at least one of which may include the MS (and ES) and at least another of which may not include the MS (and ES). Such a system may include more than two baffles at least two of which may be identical to, similar to or different from each other. The system may include the MS (or ES) but not the ES (or MS). The system with the mobile member (or section) may not include any of the MS (and ES). The system with the mobile member (or section) may include the MS but not the ES. The system with the mobile member (or section) may include the ES but not the MS. The system may include at least two mobile sections. At least one of the members may be arranged to be mobile with respect to the others thereof.

Such a system may be arranged to irradiate through the air outlet said magnetic waves having a magnetic field strength which may preferably be no stronger than a preset limit when measured at a preset distance from said air outlet. The system may be arranged to emit through any portion thereof the magnetic waves with a magnetic field strength which may be no stronger than a preset limit when measured at a preset distance from said air outlet. Such a preset limit may be any of 0.1 mG, 0.2 mG, 0.3 mG, 0.5 mG, 0.7 mG, 1 mG, 1.5 mG, 2 mG, 3 mG, 4 mG, 5 mG, 7 mG, 10 mG, and so on, while such a preset distance may be 0.1 cm, 0.2 cm, 0.5 cm, 1 cm, 2 cm, 3 cm, 5 cm, 7 cm, 10 cm, 15 cm, 20 cm, 25 cm, 30 cm, and the like.

In another aspect of the present invention, a hair drying system may be formed for generating heat and for providing a flow of heated air through at least one air outlet thereof by transferring the heat to a flow of air while maximizing an amount of the heat transferred to the flow of air.

In one exemplary embodiment of this aspect of the invention, a hair drying system may include at least one standard conduit member, at least one standard actuator member, as well as at least one standard heating member. Such a conduit may be arranged to define a tortuous shape defining a total curvilinear length greater than a distance between the air inlet and air outlet by a preset ratio which is greater than 1.0, thereby maximizing an amount of the heat generated by and transferred from such an heating element to the air flowing through the conduit.

In another exemplary embodiment of such an aspect of the invention, a hair drying system may include at least one conduit member, at least one standard actuator member, and at least one standard heating member. The conduit member may be arranged to define therealong at least one conduit for a flow of air, to define at least one air inlet in at least one end of the conduit, to define the air outlet in at least another end of the conduit, and to also include at least one heat exchange member along at least a portion thereof. In one example, the heat exchange member may be arranged to include at least one curvilinear air path rendering a total curvilinear length of the conduit longer than a distance between the air inlet and air outlet, to receive the air taken in through the air inlet, to discharge the air to the air outlet, and to include at least a portion of the heating member therein, thereby maximizing the amount of the heat generated by and transferred from the heating element to the air. In another example, the heat exchange member may be arranged to include at least one curvilinear air path defining a shape of a zigzag pattern, a reciprocating pattern defining at least one turn, a concentrically wound pattern, a helically wound pattern, and/or a combination thereof, to receive the air taken in through the air inlet, to discharge the air through the air outlet, and then to include at least a portion of the heating member therein, thereby rendering a total curvilinear length of the conduit longer than a distance between the air inlet and air outlet while maximizing the amount of the heat generated by and transferred from the heating element to the air. In another example, the heat exchange member may be arranged to extend over a first distance along the conduit, to include at least one inlet end and at least one outlet end, to receive the air taken in through the air inlet through the inlet end, to discharge the air through the outlet end toward the air outlet, to include at least a portion of the heating member therein, and to also define therein at least one air path which may be arranged to define a total curvilinear length longer than the first distance and through which the air may receive at least a portion of such heat generated by the heating element, thereby maximizing the amount of such heat transferred from the heating element to the air.

In another exemplary embodiment of such an aspect of the invention, a hair drying system may include at least one conduit member, at least one standard actuator member, and at least one standard heating member. The conduit member may be arranged to define therealong at least one conduit for a flow of air, to define at least one air inlet in at least one end of the conduit, to define the air outlet in at least another end of the conduit, and to form at least one mixing portion therealong. The mixing portion may be arranged to have a cross-sectional area which is greater than each of cross-sectional areas of other portions of the conduit neighboring the mixing portion, thus allowing mixing of such air therein, increasing a residence time of such air in the mixing portion than the other portions of the conduit, and maximizing the amount of the heat transferred from the heating element to the air.

In another exemplary embodiment of such an aspect of the invention, a hair drying system may also have at least one standard conduit member, at least one standard actuator member, at least one standard heating member, and at least one thermal insulator which may be arranged to have a thermal conductivity which may be less than a preset threshold, to be disposed at least one of in an interior of, over an exterior of, and inside at least a portion of the conduit, thereby minimizing loss of the heat thereacross and maximizing an amount of such heat generated by and transferred to the air flowing therethrough.

Embodiments of this aspect of the invention may include one or more of the following features.

The contour member may include along the conduit at least one heat distributor, at least one heat diffuser, and so on, in order to enhance heat transfer from the heating member to the air and/or to minimize the loss of the heat. The tortuous shape may be a zigzag pattern, a reciprocating pattern defining at least one turn therealong, a concentrically wound pattern, a helically wound pattern, and/or combination thereof. The preset ratio may be 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.5, 4.0, 4.5, 5.0, 5.5, 6.0, 6.5, 7.0, and so on. The conduit member may include therein an entire portion of the heating member.

The MS (and ES) may be disposed around an exterior of, an interior of, and/or an into a portion of the conduit member in which the heating element is disposed. The MS (and ES) may extend beyond the portion of the conduit member. The heat exchange member may include therein at least one heat distributor, at least one heat diffuser, and so on. The air path may define a shape of a zigzag pattern, a reciprocating pattern with at least one turn therealong, a concentrically wound pattern, a helically wound pattern, a combination thereof, and the like. The length of the air path may be longer than the first distance by a ratio of about 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.5, 4.0, 4.5, 5.0, 5.5, 6.0, 6.5, 7.0, and so on.

The heat exchange and conduit members may also form an unitary article. The heat exchange member may be releasably or fixedly coupled to the conduit member. The heat exchange member may include therein an entire portion of the heating member. At least a portion of an exterior and/or interior of the heat exchange member may also be covered or enclosed by a thermally insulative material.

The MS (and ES) may be disposed around an exterior of, an interior of, and/or an into at least a portion of the heat exchange member. Such MS (and ES) may also extend beyond the heat exchange member toward a neighboring portion of the conduit member. The MS (and ES) for the heat exchange member may be at least partially refractory. Each neighboring portion may be disposed immediately close to each opposing end of the mixing portion or may be disposed facing each opposing end of the mixing portion at a preset distance. Other features of the foregoing aspects may also apply to various systems of this aspect of the invention.

In another aspect of the present invention, a hair drying system may be formed for generating a flow of heated air through at least one air outlet thereof while minimizing amounts of electromagnetic waves irradiated therefrom by generating multiple electromagnetic waves canceling at least portions of each other.

In one exemplary embodiment of this aspect of the invention, a hair drying system may include at least one standard conduit member, at least one standard actuator member, as well as at least one standard heating member. In one example, the actuator and heating members may be arranged to emit the waves in at least partially opposite directions so that the waves irradiated by one of the members may cancel at least a portion of the waves emitted by the other of the members. In another example, the actuator member may be oriented along a first pattern and to irradiate first electromagnetic waves propagating along a first direction while generating the flow of the air, where the heating member may be oriented in a second pattern and to emit second electromagnetic waves propagating in a second direction while heating the flow of the air, where the first and second patterns may be arranged to be at least partially similar to each other, and where the current may be arranged to flow in the first and second conductors along at least partially opposite directions, thereby canceling at least a portion of the first (or second) waves by at least a portion of the second (or first) waves. In another example, the actuator member may be oriented along a first pattern and to irradiate first electromagnetic waves propagating along a first direction while generating the flow of the air, where the heating member may be oriented in a second pattern and to emit second electromagnetic waves propagating in a second direction while heating the flow of the air, where the first and second patterns may be arranged to be at least partially opposite to each other, and where the current is arranged to flow through such first and second conductors in an at least partially similar direction, thereby canceling at least a portion of the first (or second) waves by at least a portion of the second (or first) waves. In another example, the heating member may be arranged to have an extra portion which may be arranged to be disposed around one of an exterior, an interior, and an inside of the actuator member and to irradiate counter electromagnetic waves capable of canceling at least a portion of the waves emitted by the actuator member. In another example, the actuator member may be arranged to include an extra portion which may be arranged to be disposed around one of an exterior, interior, and inside of the heating member and to irradiate counter electromagnetic waves capable of canceling at least a portion of the waves emitted by the heating member.

In another exemplary embodiment of such an aspect of the invention, a hair drying system may also have at least one standard conduit member, at least one standard actuator member, at least one standard heating member, and at least one counter member which may be disposed along a path of the waves which are irradiated by at least one of the actuator and heating members, to emit counter electromagnetic waves propagating in an at least partially opposite direction to the waves emitted by the at least one of the members, and to cancel at least portions of the waves emitted by the at least one of the members.

In another exemplary embodiment of such an aspect of the invention, a hair drying system may also have at least one standard conduit member, at least one standard actuator member, at least one standard heating member, and at least one electric cable which may form a circuit including at least one of the actuator and heating members or another circuit for other parts of the system and may emit counter electromagnetic waves which may cancel at least a portion of the waves emitted by at least one of the members.

Embodiments of this aspect of the invention may include one or more of the following features.

The heating and actuator members may be disposed separately along the conduit member. At least a portion of the heating member may be disposed around or inside the actuator member. Such a portion of the heating member may define different electrical properties from the rest of such a heating member and to not be able to generate the heat when the current flows therein. The counter member may extend in a preset length along its curvilinear longitudinal axis. The counter member may define a cross-section of any shapes and/or sizes. The counter member may define one of shapes of a wire, a strip, a sheet, a bundle thereof, a stack thereof, a braid thereof, a mesh thereof, a concentric article thereof, and the like, where each of the shapes may include at least one conductive material. Such a counter member may include multiple sections which may bifurcate or merge each other. The counter member may draw the current from the actuator and/or heating members. Such actuator and heating member may draw the current from a source, while the counter member may draw the current from another source which may not provide such current to the actuator and/or heating members. Such a counter member may be disposed along the heating member as at least one of the above conductive shapes which may not generate the heat when the current flows therein. At least a portion of such a counter member may be a conductive wire used for other purposes by the system.

The actuator member may be a DC motor with a rotor and at least one permanent magnet and the counter member may be provided as at least one conductive wire and may be disposed over the magnet at a preset distance. The waves emitted by the counter member may be weaker (or stronger) than those emitted by the heating member. The waves emitted by the counter member may be weaker (or stronger) than those emitted by the actuator member. The waves emitted the counter member may be stronger than at least one of those emitted by the actuator and heating members but weaker than a sum of those emitted by the actuator and heating members. The actuator member may instead be an AC motor with a stator and a rotor, while the counter member may be provided as at least one of the foregoing conductive shapes and disposed over the stator at a preset distance. Other features of the foregoing aspects may also apply to various systems of this aspect of the invention.

In another aspect of the present invention, a hair drying system may have at least one air inlet, air outlet, and conduit between the inlet and outlet and may generate a flow of heated air from the air inlet to the air outlet through the conduit while preventing (or at least minimizing) propagation of at least one of magnetic waves and electric waves of electromagnetic waves which may be emitted by such a system through the air outlet.

In one exemplary embodiment of this aspect of the invention, a hair drying system may have at least one standard actuator member, at least one standard heating member, and at least one magnetic shield. The magnetic shield may be arranged to include at least one path member which is arranged to include at least one material having a high magnetic permeability, to absorb the magnetic waves which propagate thereonto, and then to be shapes, sized, and/or disposed in at least one preset location of the system for rerouting the magnetic waves along the path member and away from the air outlet.

In another exemplary embodiment of such an aspect of the invention, a hair drying system may include at least one standard actuator member, at least one standard heating member, and at least one magnetic shield. The magnetic shield may be arranged to be disposed along the conduit to obstruct a cross-section of the conduit while allowing the flow through the conduit, to include at least one path member with at least one material defining a high magnetic permeability, to absorb the magnetic waves propagating thereto, to be shapes, sized, and/or disposed in at least one preset location of the system in order to reroute such magnetic waves along the path member and away from the air outlet, thereby preventing (or at least minimizing) propagation of the magnetic waves through the air outlet.

In another exemplary embodiment of such an aspect of the invention, a hair drying system may include at least one standard actuator member, at least one standard heating member, and at least one magnetic shield. In one example, the magnetic shield may be arranged to be disposed adjacent to, on or over the actuator member and also along a line of sight from the air outlet to the actuator member, to have at least one path member having at least one material of a high magnetic permeability, to absorb the magnetic waves propagating thereto, to be shapes, sized, and/or disposed in at least one preset location of the system in order to reroute the magnetic waves along the path member and away from the air outlet, thereby preventing (or at least minimizing) propagation of the magnetic waves which are emitted by the actuator member through the air outlet. In another example, the magnetic shield may be arranged to define a cross-sectional area larger than a area of the actuator member projected upon a cross-section of the conduit, to be disposed adjacent to, over or on the actuator member, to include at least one path member including at least one material with a high magnetic permeability, to absorb the magnetic waves propagating thereonto, to be shapes, sized, and/or disposed in at least one preset location of the system to reroute the magnetic waves along the path member and away from the air outlet, thereby preventing (or at least minimizing) propagation of the magnetic waves emitted by the actuator member through the air outlet.

Embodiments of this aspect of the invention may include one or more of the following features.

The system may further include at least one ES. The ES and MS may be disposed in the same, adjacent or different locations of the system. When the heating member may be disposed closer to the air outlet and the actuator member may be disposed closer to the air inlet, the MS may be disposed between the air outlet and heating member or between the heating and actuator members. In addition, the system may have at least one MS (and ES) between the air outlet and heating member and at least another MS (and ES) disposed between the heating and actuator members. Alternatively, when such a heating member may be disposed closer to the air inlet and the actuator member may be disposed closer to the air outlet, the MS may be placed between the air outlet and actuator member or between the actuator and heating members.

The system may include at least one MS (and ES) between the air outlet and actuator member and at least another MS (and ES) disposed between the actuator and heating members. At least two of the MS's (and ES's ) may be arranged to prevent penetration of such magnetic (and electric) waves therethrough by the same, similar or different mechanisms as have been described in the co-pending Applications. The path members of at least two of the MS's may be arranged to form the same, similar or different paths of the magnetic waves, and to include the same, similar or different materials each having the same, similar or different magnetic permeabilities, respectively. The magnet members of at least two of the MS's may be arranged to include the same, similar or different number of permanent magnets therein, to define the same, similar or different number (or arrangement) of magnetic poles, and so on. Other features of the foregoing aspects may also apply to various systems of this aspect of the invention.

In another aspect of the present invention, an article may be provided for coupling with an air outlet of a hair drying system which may be arranged to take in air through an air inlet by an actuator member, to heat the air by an heating member, and to discharge the heated air through the air outlet by the actuator member.

In one exemplary embodiment of this aspect of the invention, a hair drying system may include a body and at least one magnetic shield. The body may be arranged to form at least one inlet end and at least one outlet end, where the inlet end may be arranged to couple with the air outlet for receiving the heated air therefrom, and the outlet end is arranged to discharge the heated air therethrough. The magnetic shield may be arranged to minimize magnetic waves which are irradiated by such members from penetrating therethrough and to obstruct a cross-section of the body while allowing the heated air to flow through the body, thereby minimizing propagation of the magnetic waves through the outlet end.

In another exemplary embodiment of such an aspect of the invention, a hair drying system may include at least one body and at least one magnetic shield. The body may be arranged to have at least one inlet end, at least one outlet end, and at least one baffle. The inlet end may be arranged to couple with the air outlet for receiving the heated air therefrom, the outlet end may be arranged to discharge the heated air therethrough, while the baffle may be disposed between the inlet end and outlet end. The magnetic shield may be arranged to minimize magnetic waves irradiated by such members from penetrating therethrough and to obstruct a cross-section of the body while allowing the heated air to flow through the body, thereby minimizing propagation of the magnetic waves through the outlet end.

Embodiments of this aspect of the invention may include one or more of the following features.

The baffle may be disposed across at least a portion of the inlet end and/or outlet end. The MS and/or baffle may obstruct not an entire portion but a substantial portion of the cross-section of such a body. The MS and/or baffle may be disposed in a preset location which may lie between the outlet end and at least one of the actuator and heating members. The article may have multiple MS's and/or baffles at least two of which may be disposed in different portions of the body. Such an article may include at least one ES. The ES and MS may be disposed in the same, adjacent or different locations of the article. Other features of the above aspects may also apply to various systems of this aspect of the invention.

In another aspect of the present invention, a hair drying system may include multiple movable units forming at least one air path with at least one air inlet and at least one air outlet through at least one of the units, where examples of such units may include a hand unit, a base unit, and an optional coupling unit.

In one exemplary embodiment of this aspect of the invention, a hair drying system may include at least one heating member and at least one actuator member. The heating member may be arranged to generate heat, to be incorporated into or around the air path in order to transfer at least a portion of the heat to air flowing through the air path, and to be disposed in the hand unit. The actuator member may be arranged to take air in through the air inlet, to move such air through the air path, to discharge the air through the air outlet, and to be incorporated into the base unit. In one example, such hand and base units may be arranged to be movably coupled to each other and to be capable of being disposed apart from and misaligned from each other, and the air outlet may be disposed in only one of the units, thereby reducing a weight and volume of each of the units. In another example, such hand and base units may be arranged to be movably coupled to each other and to be capable of being disposed apart from each other and misaligned from each other so that an user of the system may not be able to see the heating and actuator members through the air outlet.

In another exemplary embodiment of such an aspect of the invention, a hair drying system may have the hand unit, at least one heating member, at least one actuator member, and the base unit. The hand unit may be arranged to define the air outlet and to provide a grip to an user of the system. The heating member may be arranged to generate heat, to be incorporated into or around such an air path in order to transfer at least a portion of the heat to air flowing through the air path, and to be disposed in the base unit. The actuator member may be arranged to take air in through the air inlet, to move the air through the air path, to discharge the air through the air outlet, and to be incorporated into the base unit. In one example, the hand and base units may be arranged to be movably coupled to each other and to be capable of being disposed apart from each other and/or misaligned from each other, and the air outlet may be disposed only in the hand unit, thereby reducing a weight and a volume of the hand unit. In another example, the hand and base units may be arranged to movably couple with each other and to be capable of being disposed apart from each other and/or misaligned from each other so that an user of the system may not be able to see the heating and actuator members through the air outlet

In another exemplary embodiment of such an aspect of the invention, a hair drying system may include at least one heating member, at least one actuator member, and at least one coupling unit. The heating member may be arranged to generate heat, to be incorporated into or around such an air path in order to transfer at least a portion of the heat to air flowing through the air path, and to be disposed in a hand unit. The actuator member may be arranged to take air in through the air inlet, to move the air through the air path, to discharge the air through the air outlet, and to be incorporated into a base unit. The coupling unit may be arranged to be interposed between such hand and base units, to define a length longer than a portion of the air path defined in the hand unit, and to allow the hand unit to move with respect to the base unit.

In another exemplary embodiment of such an aspect of the invention, a hair drying system may also include the hand unit, at least one heating member, at least one actuator member, and at least one coupling unit. The hand unit may be arranged to define the air outlet and to provide a grip to an user of the system. The heating member may be arranged to generate heat, to be incorporated into or around the air path in order to transfer at least a portion of the heat to air flowing through the air path, and to be disposed in a base unit. The actuator member may be arranged to take air in through the air inlet, to move the air through the air path, to discharge the air through the air outlet, and to be incorporated into the base unit. The coupling unit may be arranged to be interposed between the hand and base units, to have a length longer than a portion of the air path defined in the hand unit, and to allow such a hand unit to move with respect to the base unit.

In another aspect of the present invention, a hair drying system may also include multiple units movably coupled to each other and forming at least one air path with at least one air inlet and at least one air outlet through at least one of the units.

In one exemplary embodiment of this aspect of the invention, a hair drying system may include at least one heating member, at least one actuator member, and a body member. The heating member may be arranged to generate heat and to be incorporated into or around the air path so as to transfer at least a portion of the heat to air which may flow through the air path. The actuator member may be arranged to take air in through the air inlet, to move the air through the air path, and to discharge the air through the air outlet. The body member may include at least one hand unit, at least one coupling unit, and at least one base unit, where the hand unit may be arranged to be mobile and to form at least one grip for an user of the system, where the base unit may be arranged to be detached from such a hand unit and to include therein at least a portion of at least one of the heating and actuator members, and where the coupling unit may then be arranged to movably couple the hand unit with the base unit, thereby reducing a weight and a volume of the mobile hand unit.

In another exemplary embodiment of such an aspect of the invention, a hair drying system may include a body member, at least one heating member, and at least one actuator member. Such a body member may be arranged to include at least one hand unit, at least one coupling unit, and at least one base unit, the hand unit may be arranged to be mobile and to define at least one grip for an user of the system, where the base unit may be arranged to be detached from the hand unit, and the coupling unit may also be arranged to movably couple the hand unit with the base unit. The heating member may be arranged to generate heat and to be incorporated into or around the air path so as to transfer at least a portion of the heat to air flowing through the air path, while the actuator member may be arranged to take air in through the air inlet, to move the air through the air path, and to discharge the air through the air outlet. In one example, at least a portion of the heating member may be incorporated into the base unit, thereby reducing a weight and a volume of such a mobile hand unit. In another example, at least a portion of the actuator member may be incorporated into the base unit, thereby reducing a weight and a volume of the mobile hand unit. In another example, at least portions of the heating and actuator members may be arranged to be disposed in the base unit, thereby reducing a weight and a volume of the mobile hand unit.

In another aspect of the present invention, a hair drying system may be provided to generate a flow of heated air through at least one air outlet thereof.

In one exemplary embodiment of this aspect of the invention, a hair drying system may include at least one conduit member, at least one actuator member, at least one heating member, and at least one body member. The conduit member may be arranged to form therealong at least one air path for a flow of air, to form at least one air inlet in at least one end of the air path, and to define the air outlet in at least another end of the air path. The actuator member may be arranged to take air into the air path through the air inlet, to transport the air through the air path, and to discharge the air out of the air path through the air outlet, thereby generating the flow of air while emitting magnetic waves. The heating member may be arranged to generate heat by flowing electric current therein and to be disposed with respect to the air path in order to transfer at least a portion of such heat to the air flowing through the air path, thereby generating the flow of heated air. The body member may include at least one hand unit, at least one base unit, and at least one coupling unit, where such a hand unit may be arranged to define the air outlet therein and to provide an user of the system with a grip, where the base unit may be arranged to be movably disposed apart, to be detachable, and/or to be separable from such a hand unit, and where the coupling unit may be arranged to movably couple the hand unit with the base unit. In one example, both of the actuator and heating members emitting the waves may be arranged to be incorporated into the base unit while transporting the flow of heated air from the base unit to the hand unit through the coupling unit. In another example, the actuator member emitting more of the magnetic waves may be arranged to be incorporated into the base unit, while the heating member which emits less of such magnetic waves may then be arranged to be incorporated into the hand unit. In another example, the heating member which may irradiate more of the magnetic waves may be arranged to be incorporated into the base unit, while the actuator member emitting less of such magnetic waves may be arranged to be incorporated into the hand unit. In yet another example, at least one of the actuator and heating members emitting the waves may be arranged to be incorporated into the coupling unit. In all of these example, the system may thereby minimize the magnetic waves emitted from the hand unit, may thereby dispose the hand unit apart from the base unit and thereby minimize propagation of such waves emitted by at least one of the actuator and heating members through the air outlet, may thereby suppress formation of a line of sight from the air outlet disposed in the hand unit to the actuator and/or heating members disposed in the base unit and thereby minimize propagation of the waves emitted by the at least one of the actuator and heating members through the air outlet.

In another exemplary embodiment of such an aspect of the invention, a hair drying system may include at least one body member, at least one conduit member, at least one actuator member, and at least one heating member. The body member may be arranged to have at least one hand unit, at least one base unit, and at least one coupling unit, where the hand unit may be arranged to define the air outlet therein and to provide an user of the system with a grip, where the base unit may be arranged to be movably disposed apart, to be detachable, and/or to be separable from the hand unit, and where the coupling unit may be arranged to movably couple the hand unit with the base unit. Such a conduit member may be arranged to form therealong a proximal air path and a distal air path for a flow of air, to form at least one air inlet in at least one end of the proximal air path, and to define the air outlet in at least one end of the distal air path, where at least a portion of the distal air path may be arranged to be formed in the hand unit, while at least another portion of the proximal air path may be arranged to be defined in the base unit. The actuator member may be arranged to take air into the proximal air path through the air inlet, to transport the air through the air paths, and to discharge the air through the air outlet, thereby generating the flow of air while emitting magnetic waves. The heating member of one example may be arranged to be disposed along or inside at least a portion of the proximal air path, to generate heat by flowing electric current therein while emitting the waves, and to transfer at least a portion of the heat to the air flowing through the proximal air path so as to generate the flow of heated air. The heating member of another example may be arranged to be disposed along or inside at least a portion of the distal air path, to generate heat by flowing electric current therein while irradiating such waves, and to transfer at least a portion of the heat to the air flowing through the distal air path so as to generate such flow of heated air. The heating member of another example may be arranged to be incorporated into or around at least a portion of the coupling unit, to generate heat by flowing electric current therein while irradiating the magnetic waves, and to transfer at least a portion of such heat to the air which flows through the coupling unit in order to generate the flow of heated air. In all of such examples, such a system may thereby minimize the waves irradiated from the hand unit, may thereby dispose the hand unit apart from the base unit and thereby minimize propagation of the waves which may be emitted by at least one of the actuator and heating members through the air outlet, and/or may thereby suppress formation of a line of sight from the air outlet disposed in such a hand unit to at least one of the actuator and heating members disposed in the base unit and thereby minimize propagation of the waves emitted by such at least one of the actuator and heating members through the air outlet.

In another aspect of the present invention, a hair drying system may be provided to generate a flow of heated air by forming an air path which forms at least one air inlet and at least one air outlet on its opposing ends, taking air into the air path through the air inlet by an actuator member, heating such air by a heating member, moving such heated air through the air path to the air outlet by the actuator member, and discharging the heated air through the air outlet by the actuator member.

In one exemplary embodiment of this aspect of the invention, such a system may also include a body member which may in turn include at least one hand unit, at least one base unit, and at least one coupling unit. The hand unit may be arranged to define the air outlet therein, to provide an user of the system with a grip, and to include at least a portion of the heating member, while the base unit may be arranged to form the air inlet therein and to also include at least a portion of the actuator member. The coupling unit may be arranged to movably couple the hand unit with the base unit and to define at least a portion of the air path therealong. The system of one example may thereby be arranged to allow the user to dispose the actuator member away from the air outlet by at least a minimum distance, while moving the air from the air inlet of the base unit to the air outlet of the hand unit through the coupling unit and while minimizing propagation of magnetic waves emitted by the actuator member through the air outlet. The system of another example may thereby be arranged to allow the user to misalign the actuator member away from a line of sight between the air outlet and the air path while moving the air from the air inlet of the base unit to the air outlet of the hand unit through the coupling unit and while minimizing propagation of magnetic waves emitted by the actuator member through the air outlet. The system of another example may thereby be arranged to prevent the user from seeing the heating and actuator members through the air outlet and to minimize propagation of the waves irradiated by the the actuator and heating members through the air outlet. The system of another example may thereby be arranged to further include at least one magnetic shield capable of preventing (or at least minimizing) propagation of magnetic waves therethrough and disposed along at least one preset location of the base unit, to allow the user to misalign the base unit from the hand unit while transporting the air from the air inlet to the air outlet through the coupling unit and while minimizing formation of a line of sight for the magnetic waves between the actuator member of the base unit and the air outlet of the hand unit.

In another exemplary embodiment of such an aspect of the invention, such a system may also include a body member which may in turn include at least one hand unit, at least one base unit, and at least one coupling unit. The hand unit may be arranged to define the air outlet therein and to provide a grip to an user of the system, while the base unit may be arranged to define the air inlet therein and to include at least portions of the actuator and heating members. The coupling unit may then be arranged to movably couple the hand unit with the base unit and to also form therealong at least a portion of the conduit. The user of one example may thereby dispose the actuator and heating members away from the air outlet by at least a minimum distance while moving such air from the air inlet of the base unit to the air outlet of the hand unit through the coupling unit and minimizing propagation of magnetic waves emitted by the actuator and heating members through the air outlet. The user of another example may thereby misalign the actuator and heating members away from a line of sight between the air outlet and the actuator and/or heating members while transporting the air from the air inlet of the base unit to the air outlet of the hand unit through the coupling unit and minimizing propagation of magnetic waves irradiated by the actuator and heating members through the air outlet. The system of another example may thereby be arranged to prevent the user from seeing the heating and actuator members through the air outlet and to also minimize propagation of the magnetic waves emitted by the the actuator and heating members through the air outlet. The system of another example may thereby be arranged to further include at least one magnetic shield capable of preventing (or at least minimizing) propagation of magnetic waves therethrough and disposed along at least one preset location of the base unit and to allow the user to misalign the base unit from the hand unit while transporting the air from the air inlet to the air outlet through the coupling unit and minimizing formation of a line of sight for such magnetic waves from the air outlet of the hand unit to at least one of the actuator and heating members of the base unit.

In another aspect of the present invention, a hair drying system may be provided to define at least one air path with at least one air inlet and at least one air outlet and capable of dispensing a flow of heated air through the air outlet and incorporating at least a portion of the air path into a separate object.

In one exemplary embodiment of this aspect of the invention, a hair drying system may include a hand unit, a base unit, at least one heating member, and at least one actuator member. Such a hand unit may be arranged to define the air outlet therein and to be fluidly coupled to one end of the portion of the air path, while the base unit may be arranged to fixedly or releasably couple with the object and to fluidly couple with an opposing end of the portion of the air path. The heating member may then be arranged to generate heat, to be incorporated into or around the air path in order to transfer at least a portion of the heat to air which flows through the air path, and to be disposed in the hand unit. Such an actuator member may be arranged to take air in through the air inlet, to move the air through the air path, to discharge the air through the air outlet, and to be disposed in the base unit, thereby reducing a weight and a volume of the hand unit.

In another exemplary embodiment of such an aspect of the invention, a hair drying system may include a hand unit, a base unit, at least one heating member, and at least one actuator member. The hand unit may be arranged to define the air outlet therein and to be fluidly coupled to one end of such a portion of the air path, while the base unit may be arranged to fixedly or releasably couple with the object and to fluidly couple with an opposing end of the portion of the air path. The heating member may be arranged to generate heat, to be incorporated into or around the air path in order to transfer at least a portion of the heat to air flowing through the air path, and to be disposed in the base unit. The actuator member may be arranged to take air in through the air inlet, to transport the air through the air path, to discharge the air through the air outlet, and to be disposed in the base unit, thereby reducing a weight and volume of the hand unit.

In another aspect of the present invention, a chair may incorporate at least a portion of a hair drying system capable of generating a flow of heated air through at least one air outlet thereof and including at least one body member, at least one actuator member, and at least one heating member, where the body member may include a hand unit, a base unit, and a coupling unit which couples such a hand unit with the base unit, where at least one of the units may be arranged to define at least one air path defining at least one air inlet and the air outlet, where the actuator member may be arranged to move air from the air inlet to the air outlet through the air path, and where the heating member may be arranged to generate heat and to be disposed in order to transfer at least a portion of the heat onto air flowing through the air path.

In one exemplary embodiment of such an aspect of the invention, a chair may include a base, a seat, and a back rest. The base may be arranged to be disposed on or over a stationary object and to support the chair, while the seat may be disposed or coupled over the base and arranged to allow an user to sit thereon. The back rest may be arranged to be coupled to the seat and to support a back of the user sitting on the seat. The air path may be arranged to include a proximal air path and a distal air path, where the proximal air path may be arranged to be embedded into and/or coupling with at least a portion of the chair. The actuator member may be arranged to fluidly couple with the proximal air path and to be disposed in the base unit which may in turn be arranged to fixedly or releasably couple with at least another portion of the chair. The distal air path may then be arranged to fixedly or releasably couple with the proximal air path and the hand unit, while the heating member may be arranged to be included in one of the hand and base units. The system of one example may thereby reduce a weight and a volume of the hand unit. The system of another example may thereby dispose such an actuator and/or heating members away from the air outlet of the hand unit and may also minimize propagation of magnetic waves emitted by the actuator and/or heating members through the air outlet. The system of another example may thereby prevent the user from seeing such heating and/or actuator members through the air outlet.

In another exemplary embodiment of such an aspect of the invention, such a chair may include a base, a seat, and a back rest. The base may be arranged to be disposed on a stationary object and to support the chair, while the seat may be disposed or coupled over the base and arranged to allow an user to sit thereon. The back rest may be arranged to be coupled to the seat, to support a back of the user sitting on the seat, and to incorporate at least a portion of the air path therein. The actuator member may be arranged to be fixedly or releasably coupled to one end of the portion of the air path and to be disposed in the base which may be arranged to be fixedly or releasably coupled to a portion of the chair. The distal air path may be arranged to fixedly or releasably couple with the proximal air path and with the hand unit, while the heating member may be arranged to be incorporated into one of the hand unit, the base unit, and the portion of the air path. The system of one example may thereby reduce a weight and a volume of the hand unit. The system of another example may thereby dispose the actuator and/or heating members away from the air outlet of the hand unit and may also minimize propagation of magnetic waves emitted by the actuator and/or heating members through the air outlet. The system of another example may thereby prevent the user from seeing such heating and actuator members through the air outlet.

In another exemplary embodiment of such an aspect of the invention, such a chair may include a base, a seat, and a back rest. The base may be arranged to be disposed on a stationary object and to support the chair, while the seat may be disposed or coupled over the base and arranged to allow an user to sit thereon. The back rest may be arranged to be coupled to the seat and to support a back of the user sitting on the seat. At least a portion of the air path may be arranged to be embedded into at least a portion of the chair or, alternatively, may be fixedly or releasably coupled to at least a portion of the chair. Such a base unit may be arranged to be fixedly or releasably coupled to at least another portion of the chair and to retain at least a portion of the actuator member which may be arranged to fluidly couple with one end of the portion of the air path. The hand unit may be arranged to detachably couple with an opposing end of the portion of the air path, while the heating member may be arranged to be incorporated into one of the hand unit, the base unit, and the portion of the air path. The system of one example may thereby reduce a weight and a volume of the hand unit. The system of another example may thereby dispose such actuator and/or heating members away from the air outlet of the hand unit and minimize propagation of magnetic waves which may be irradiated by the actuator and/or heating members through the air outlet. The system of another example may thereby prevent the user from seeing the heating and actuator members through the air outlet.

In another aspect of the present invention, a magnetically shielded hair drying system may also include multiple movable units such as a hand unit, a base unit, and a coupling unit which may movably couple the hand unit with the base unit.

In one exemplary embodiment of such an aspect of the invention, a magnetically shielded hair drying system may have at least one heating member, at least one actuator member, and at least one magnetic shield. Such a heating member may be arranged to generate heat while irradiating magnetic waves, to be incorporated into or around the air path in order to transfer at least a portion of the heat to air which flows through the air path, and to be disposed in a hand unit. The actuator member may be incorporated into a base unit and arranged to take air in through the air inlet, to move the air through the air path, and to discharge the air through the air outlet while irradiating such magnetic waves. The magnetic shield may be arranged to include at least one path member having at least one material with a high magnetic permeability and to absorb the waves propagating thereto. Such hand and base units may be arranged to be movably coupled to each other and to be capable of being disposed apart from each other and misaligned from each other, while the magnetic shield may be arranged to be shaped, sized, and disposed in at least one preset location of the system for rerouting such magnetic waves along the path member and away from a preset portion of the system, thereby preventing (or at least minimizing) propagation of such waves through the preset portion of such a system while reducing a weight and a volume of the hand unit.

In another exemplary embodiment of this aspect of the invention, a magnetically shielded hair drying system may have a hand unit, at least one heating member, at least one actuator member, and at least one magnetic shield. The hand unit may be arranged to define the air outlet and to provide a grip to an user of such a system. The heating member may be arranged to generate heat, to irradiate magnetic waves, to be included in or along the air path so as to transfer at least a portion of the heat onto air flowing through the air path, and to be disposed in a base unit. The actuator member may be arranged to be disposed in the base unit, to take air in through the air inlet, to move the air through the air path, and then to discharge the air through the air outlet. The magnetic shield may be arranged to include at least one path member having at least one material with a high magnetic permeability and to absorb such waves propagating thereto. such hand and base units may be arranged to be movably coupled to each other and to be capable of being disposed apart from each other and misaligned from each other. The magnetic shield may be arranged to be shaped, sized, and disposed in at least one preset location of the system for rerouting the magnetic waves along the path member and away from a preset portion of the system, thereby preventing (or at least minimizing) propagation of the magnetic waves through the preset portion of the system while reducing a weight and a volume of such a hand unit.

In another exemplary embodiment of this aspect of the invention, a magnetically shielded hair drying system may include at least one hand unit, at least one base unit, at least one coupling unit, at least one heating member, at least one actuator member, and at least one magnetic shield. The hand unit may be arranged to define a distal air path in at least a portion thereof, to form an air outlet in one end of the distal air path, and to provide a grip to an user of such a system, and the base unit may be arranged to define a proximal air path along at least a portion thereof and to form an air inlet in one end of the proximal air path. The coupling unit may be arranged to movably couple with opposing ends of the hand and base units and to fluidly couple the air inlet with the air outlet therethrough. The heating member may be arranged to generate heat and emit magnetic waves, to be included along or around the air path in order to transfer at least a portion of the heat onto air flowing through the air path, and to be disposed in at least one of the hand and base units. The actuator member may be incorporated into the base unit and arranged to take air in through the air inlet, to move the air through the air path, and to discharge the air heated by the heating member through the air outlet while emitting the waves. The magnetic shield may be arranged to include at least one path member having at least one material with a high magnetic permeability, to absorb the waves propagating thereto, and to be shaped, sized, and disposed in at least one preset location of the system for rerouting such waves along the path member, thereby preventing (or at least minimizing) such magnetic waves from propagating through at least one of the air outlet, distal air path, grip of the hand unit, the base unit, and proximal air path.

Embodiments of the foregoing aspects of the present invention may include one or more of the following features.

The hand unit may include one or more baffles and/or define one or bends described in the co-pending Applications. The hand unit may define a first unit of the co-pending Applications, but not any second unit of the co-pending Applications. In the alternative, the hand unit may have both of the first and second units of the co-pending Applications. The first unit may fixedly or movably couple with the second unit. The first unit may have at least one mobile section and at least one stationary section as described in the co-pending Applications, and the second unit may include at least one mobile section and at least one stationary section as described in such co-pending Applications. When the hand unit includes the first and second units, the grip may be formed in the second unit. When the first unit may include the mobile and stationary sections, however, the grip may be disposed in any of the sections.

The body member (or its units) may extend in any lengths along its curvilinear longitudinal axis. The body member (or its units) may define a cross-section of any shapes and/or sizes. Various units of the body member may bifurcate and/or merge each other. The body member (or its units) may also include the above baffles and/or may also form the above bends. The air inlet may be disposed in at least one of the other of the units and/or sections in which the air outlet may not be disposed.

When such actuator and/or heating members are disposed in the hand unit, the members may be disposed only in the first unit, only in the second unit, or in both of the first and second units. The actuator member may have at least one impeller, at least one motor, and at least one axle. The motor may be arranged to generate a torque and to be disposed in the base unit, while the impeller may be disposed in the hand unit. The axle may then be arranged to mechanically couple the motor with the impeller and to transfer the torque to the impeller. The axle may be arranged to transfer such torque along a straight or curved path. The actuator member may also include at least one joint with which the motor may transfer the torque to the impeller through the axle.

The base unit may not define the grip thereon. The base unit may include a coupler capable of releasably or fixedly coupling the base unit with a stationary object or a semi-stationary object, where the coupler may be a mechanical coupler, a magnetic coupler, and the like. Examples of such objects may include, but not be limited to, a structure, a furniture, a device, and so on, where such a structure may be a wall, a floor, a ceiling, and so on, where such a furniture may be a vanity, a desk, a chair, a cabinet, a mirror, and so on, while such a device may be any mechanical or electric devices defining an area onto which the coupler may form a fixed or releasable coupling.

The coupling unit may be arranged to enable the hand (or base) unit to move such as, e.g., to translate, to reciprocate, to rotate, to pivot, and the like, with respect to the base (or hand) unit. Such a coupling unit may allow the hand (or base) unit to move in any direction with respect to the base (or hand) unit while a length of the coupling unit may allow. The coupling unit may provide and maintain fluid communication between the hand and base units during movement of the hand unit with respect to the base unit when the air path is defined through at least portions of the base and hand units. The coupling unit may not provide such fluid communication when the base unit may include include the air path therein. The coupling unit may releasably or fixedly couple with the hand and/or base units. The coupling unit may allow the hand unit to be disposed (or spaced) apart from the base unit by at least a distance which may be greater than a length of a portion of the air path formed inside and/or along the hand unit by a preset number of times, where the preset number may be about 1.0, 1.25, 1.5, 2.0, 3.0, 4.0, 5.0, 6.0, 7.0, 8.0, 9.0, and 10.0.

The coupling unit may also be arranged to change its shape and/or size such as, e.g., a length between opposing ends thereof. The coupling unit may be made of and/or include at least one flexible material which may be able to change its shape, curvature, length between its opposing ends, and/or distance therebetween. The coupling unit may be made of and/or include at least one material which is thermally resistant, when the heating element may be incorporated into the base unit and where the coupling unit may transport the flow of heated air. The coupling unit may include multiple rigid sections movably coupled to each other to vary its shape, curvature, distance between its opposing ends, and the like. At least a portion of the coupling unit may include at least one bellow. The coupling unit may be retractable. For example, the coupling unit may move between a fixed number of stops. In another example, the coupling unit may instead move telescopically. The coupling unit may include at least one outer layer and at least one inner layer, where such an outer layer may provide mechanical, electrical, and/or magnetic protection, while the inner layer may provide fluid communication between the base and hand units, may provide a space for electric wire and/or axle for delivering torque therealong, and the like.

The system may include at least one switch which may be arranged to turn on and off at least one of the actuator and heating members and to be disposed in one of the hand, coupling, and base units. The system may include multiple switch which may be arranged to be disposed in at least two of the hand, coupling, and base units and to operate as two-way switches. Such a switch disposed in one of the coupling and base units may be electrically connected to a power source through a wire at least a portion of which may run along the coupling unit.

The object may include a furniture such as, e.g., a chair with or without a back rest, a stool, a vanity, a drawer, a cabinet, a shelf, and so on. Such an object may define a receptacle for fixedly or releasably receiving at least a portion of the actuator member therein. Such a system may include at least one heat exchange member of the co-pending Applications. Such a system may include at least one counter member of the co-pending Applications.

In addition, such a system may include at least one magnetic shield (or MS) and/or at least one electric shield (or ES) as described in the co-pending Applications disposed in preset locations. Such a system may incorporate at least one MS (and ES) on, over, around, in, and/or into at least a portion of at least one of the conduit, body, heating, and actuator members. The system may also change the distance by releasably attaching (or detaching) an article including at least one of the MS and ES onto (or away from) the conduit member. The MS and ES may be any of those disclosed in the co-pending Applications. For example, the MS may have at least one path member but may not have any magnet member both of which are disclosed in the co-pending Applications. The MS may optionally include at least one path member and at least one magnet member both of which are disclosed in the co-pending Applications. The ES may shield a target from EWs through one or more of mechanisms as described in the co-pending Applications. The ES may be grounded. The MS may shield a target from the EWs by one or more of mechanisms as described in the co-pending Applications. The MS (and ES) may be disposed on, over, around, and/or in at least a portion of at least one of such conduit, actuator, and/or heating members. The MS (and ES) may be disposed over at least a (or entire) portion of the baffle. The MS (and ES) may be disposed along the bend or away therefrom. The system may have at least two baffles at least one of which may include the MS (and ES) and at least another of which may not include the MS (and ES). The system may include more than two baffles at least two of which may be identical to each other, similar to each other or different from each other. The system may include the MS (or ES) but not the ES (or MS). The system may be arranged to irradiate through the air outlet, hand unit, and/or coupling unit the magnetic waves having a magnetic field strength no stronger than a preset limit when measured at a preset distance from the air outlet. The system may also be arranged to emit through any portion thereof such magnetic waves with a magnetic field strength which may be no stronger than a preset limit when measured at a preset distance from such an air outlet. Examples of the preset limit may be 0.1 mG, 0.2 mG, 0.3 mG, 0.5 mG, 0.7 mG, 1 mG, 2 mG, 3 mG, 4 mG, 5 mG, 7 mG, 10 mG, and the like, while examples of the preset distance may be 0.1 cm, 0.2 cm, 0.5 cm, 1 cm, 2 cm, 3 cm, 5 cm, 7 cm, 10 cm, 15 cm, 20 cm, 25 cm, 30 cm, and the like. The system may also include at least one filter which may generally be disposed proximal to the actuator member and arranged to filter foreign materials from the air taken in toward the air inlet. Other features of the above aspects of the present invention may also apply to the above seven aspects described herein.

In another aspect of the present invention, a method may be provided for forming a hair drying system for taking in air by an actuator member, heating the air by a heating member, transporting the heated air along a conduit, and discharging the heated air through an air outlet by the actuator member while preventing (or at least minimizing) formation of a line of sight between the air outlet and at least one of the members.

In one exemplary embodiment of this aspect of the present invention, a method may include the steps of: disposing at least a portion of at least one of the above members along the conduit; installing at least one baffle between the air outlet and such at least one of the members; and then shaping and sizing the baffle enough to obstruct a cross-section of such a conduit while allowing the heated air to flow through the baffle, thereby preventing (or at least minimizing) formation of the line of sight inside or through an interior of the conduit.

In another exemplary embodiment of this aspect of the present invention, a method may include the steps of: disposing at least a portion of at least one of such members along the conduit; installing multiple baffles between the air outlet and such at least one of the members in different portions of the conduit; and then arranging at least two of the baffles to overlap a cross-section of the conduit while allowing the heated air to flow through the conduit, thereby obstructing a cross-section of the conduit and preventing (or at least minimizing) formation of the line of sight through an interior of the conduit.

In another exemplary embodiment of this aspect of the present invention, a method may include the steps of: disposing at least a portion of at least one of the members along the conduit; and bending at least a portion of the conduit about at least one bend until the bend prevents (or at least minimizes) the line of sight.

In another exemplary embodiment of this aspect of the present invention, a method may include the steps of: coupling at least one second unit with at least a portion of the conduit at a preset angle which is neither 0° nor 180°; and disposing inside the transverse unit a preset portion of at least one of the members until the second unit may prevent such a line of sight while at least one of allowing the heating member to heat the air and allowing the actuator member to transport such heated air through the conduit.

In another aspect of the present invention, a method may be provided for forming a hair drying system for taking in air by an actuator member, heating the air by a heating member, transporting the heated air along a conduit, and discharging the heated air through an air outlet by the actuator member while varying a distance between the air inlet and the air outlet (and/or at least one of the members).

In one exemplary embodiment of this aspect of the present invention, a method may include the steps of: disposing at least a portion of at least one of the members along the conduit; defining at least one mobile unit including the air outlet in the conduit; movably coupling the mobile unit with the conduit; forming a preset number of stops along the conduit; and moving the mobile unit toward and away from the members into each of the stops, thereby varying the distance between the air outlet and such at least one of the members.

In another exemplary embodiment of this aspect of the present invention, a method may include the steps of: disposing at least a portion of at least one of the members along the conduit; defining at least one mobile unit having the air outlet in the conduit; telescopically coupling the mobile unit with the conduit; and then moving such a mobile unit toward and away from such at least one of the members continuously, thereby varying the distance between such at least one of the members and air outlet between a preset maximum distance and a preset minimum distance.

In another exemplary embodiment of this aspect of the present invention, a method may include the steps of: disposing at least a portion of at least one of the members along the conduit; defining at least one mobile unit including such at least one of the members in the conduit; movably coupling such a mobile unit with the conduit; forming a preset number of stops along the conduit; and moving such a mobile unit toward and away from the air outlet into each of such stops, thereby varying the distance between such at least one of the members and the air outlet.

In another exemplary embodiment of this aspect of the present invention, a method may include the steps of: disposing at least a portion of at least one of the members along the conduit; defining at least one mobile unit including such at least one of the members in the conduit; telescopically coupling the mobile unit with the conduit; and continuously moving the mobile unit toward and away from the air outlet, thereby varying the distance between such at least one of the members and air outlet between a preset maximum distance and a preset minimum distance.

In another exemplary embodiment of this aspect of the present invention, a method may include the steps of: disposing at least a portion of at least one of such members along the conduit; forming a preset number of stops along the conduit; translating such at least one of the members along such a conduit at each of the stops; and moving such at least one of the members toward and away from the air outlet to each of the stops, thereby varying the distance between the air outlet and such at least one of the members.

In another exemplary embodiment of this aspect of the present invention, a method may include the steps of: disposing at least a portion of at least one of such members along the conduit; translating such at least one of the members along the conduit telescopically; and moving such at least one of the members toward and away from the air outlet continuously, thereby varying such a distance between such at least one of the members and air outlet.

In another exemplary embodiment of this aspect of the present invention, a method may include the steps of: disposing at least a portion of at least one of such members along the conduit; arranging such at least one of the members to pivot about a portion of the conduit; and pivoting such at least one of the above members toward and away from the portion of the conduit, thereby varying the distance between such at least one of the members and air outlet.

In another aspect of the present invention, a method may be provided for protecting a target from magnetic (and electric) waves of electromagnetic waves irradiated by a hair drying system for transporting and heating air by its members which also emit such waves and for discharging a flow of heated air through an air outlet thereof while moving at least one of the air outlet and members.

In one exemplary embodiment of this aspect of the present invention, a method may include the steps of: defining at least two units in the system; disposing the air outlet in one of the units; disposing at least a portion of at least one of the members in the other of the units; and moving one of such units away from the other of the units when the system is in use, thereby dispersing more of such waves away from the target and, therefore, protecting the target.

In another exemplary embodiment of this aspect of the present invention, a method may include the steps of: defining a grip unit for being held by an user and a non-grip unit; disposing the air outlet in the grip (or non-grip) unit; disposing at least a portion of at least one of the members in the non-grip (or grip) unit; and moving one of the units away from the other of the units when the system is in use, thereby dispersing more of the waves from the target and, therefore, protecting the target.

In another exemplary embodiment of this aspect of the present invention, a method may include the steps of: defining an elongated unit and a transverse unit disposed transverse to the elongated unit; defining a mobile section including the air outlet in the elongated unit; defining a stationary section including at least one of the members in the elongated unit; and moving the mobile section away from the stationary section as the system is in use, thereby dispersing more of the waves from the target and, therefore, protecting the target.

In another exemplary embodiment of this aspect of the present invention, a method may include the steps of: defining an elongated unit and a transverse unit disposed transverse to the elongated unit; disposing the air outlet in the elongated unit; defining a stationary section in the transverse unit; defining a mobile section including at least one of the members in the transverse unit; and moving such a mobile section away from the elongated unit when the system is in use, thereby dispersing more of the waves from the target and, therefore, protecting the target.

In another aspect of the present invention, a method may be provided for protecting a target from magnetic (and electric) waves of electromagnetic waves irradiated through an air outlet of a hair drying system for taking in air by an actuator member, heating the air with a heating member, moving or transporting the heated air along a conduit, and discharging the heated air through the air outlet by the actuator member toward the target.

In one exemplary embodiment of this aspect of the present invention, a method may include the steps of: disposing at least a portion of at least one of such members along the conduit; providing at least one magnetic (and electric) shield capable of preventing (or at least minimizing) such magnetic (and electric) waves from penetrating therethrough; and positioning the magnetic (and electric) shield between such at least one of the members and air outlet, thereby obstructing a line of sight for such waves therebetween and preventing (or at least minimizing) propagation of such waves toward the target.

In another exemplary embodiment of this aspect of the present invention, a method may include the steps of: disposing at least a portion of at least one of the members along the conduit; installing at least one baffle between such at least one of the members and air outlet but allowing such air to flow through the conduit; providing at least one magnetic (and electric) shield capable of preventing (or at least minimizing) the magnetic (and electric) waves from penetrating therethrough; and positioning the magnetic (and electric) shield on (or into) the baffle, thereby obstructing a line of sight for the waves between such at least one of the members and air outlet as well as preventing (or at least minimizing) propagation of the waves toward the target.

In another exemplary embodiment of this aspect of the present invention, a method may include the steps of: disposing at least a portion of at least one of such members along the conduit; installing multiple baffles between the air outlet and such at least one of the members in different portions of the conduit while allowing the air to flow through such a conduit; providing multiple magnetic (and electric) shields in order to prevent (or to at least minimize) the magnetic (and electric) waves from penetrating therethrough; and positioning at least two of such magnetic (and electric) shields on (or into) at least two of the baffles while overlapping a cross-section of the conduit for obstructing a line of sight for such waves between such at least one of the members and air outlet, thereby preventing (or at least minimizing) propagation of the waves toward the target.

In another exemplary embodiment of this aspect of the present invention, a method may include the steps of: disposing at least a portion of at least one of such members along the conduit; bending at least a portion of such a conduit about at least one bend; providing at least one magnetic (and electric) shield in order to prevent (or to at least minimize) the magnetic (and electric) waves from penetrating therethrough; and positioning the magnetic (and electric) shield in at least one position of the conduit to obstruct a line of sight for such waves between such at least one of the members and the air outlet, thereby preventing (or at least minimizing) propagation of the waves toward the target.

In another exemplary embodiment of this aspect of the present invention, a method may include the steps of: coupling at least one second unit with at least a portion of the conduit at a preset angle which is neither 0° nor 180°; disposing at least a portion of at least one of the members in the second unit; providing at least one magnetic (and electric) shield capable of preventing (or at least minimizing) the magnetic (and electric) waves from penetrating therethrough; and positioning the magnetic (and electric) shield in at least one position along at least one of the conduit and second unit for obstructing a line of sight for such waves between the air outlet and such at least one of the members, thereby preventing (or at least minimizing) propagation of the waves toward the target.

In another aspect of the present invention, a method may be provided for protecting a target from magnetic (and electric) waves of electromagnetic waves irradiated through an air outlet of a hair drying system for taking in air by an actuator member, heating the air by a heating member, moving the heated air along a conduit, and discharging the heated air through an air outlet by the actuator member through varying a distance between the air outlet and at least one of the members which is a source irradiating the waves.

In one exemplary embodiment of this aspect of the present invention, a method may include the steps of: disposing at least a portion of the source along the conduit; defining at least one mobile unit with the air outlet in the conduit; movably coupling such a mobile unit with the conduit between at least two states; and then operating the mobile unit toward and away from the source between the states, thereby varying the distance and dispersing more of such waves away from the target in one of the states then the other thereof.

In another exemplary embodiment of this aspect of the present invention, a method may include the steps of: disposing at least a portion of the source along the conduit; defining at least one mobile unit with the source in the conduit; movably coupling the mobile unit with the conduit between at least two states; and operating such a mobile unit toward and away from the air outlet between the states, thereby varying the distance and dispersing more of such waves away from the target in one of the states than the other thereof.

In another exemplary embodiment of this aspect of the present invention, a method may include the steps of: disposing at least a portion of the source along the conduit; arranging the source to be able to translate with respect to the air outlet between at least two states; and translating the source of the waves between the states, thereby varying the distance and dispersing more of such waves away from the target in one of the states than the other thereof.

In another exemplary embodiment of this aspect of the present invention, a method may include the steps of: disposing at least a portion of the source along the conduit; arranging the source to pivot between at least two states; and then pivoting the source between such states, thereby varying the distance and dispersing more of such waves away from the target in one of the states than the other thereof.

Embodiments of the foregoing five method aspects of the present invention may include one or more of the following features.

The disposing may include the step of: defining such a conduit to be curvilinear. The disposing may include the step of: disposing at least portions of both of the members in and/or along the conduit. The disposing may include one of the steps of: disposing inside the conduit a portion of the actuator member which is a main source of electromagnetic waves; and disposing inside the conduit a portion of the heating member which is another main source of the waves.

The installing may include one of the steps of: installing multiple baffles along different portions in the conduit; and installing multiple baffles around different angles of a portion of the conduit. The coupling may include one of the steps of: fluidly coupling the second unit to the conduit; and coupling the second unit to the conduit without providing fluid communication therebetween. The coupling may include one of the steps of: coupling the second unit to the conduit at an acute angle; and coupling the second unit to the conduit at an obtuse angle. The defining may include the step of: disposing at least a portion of the mobile unit outside or inside the conduit. The moving may include one of the steps of: translating the mobile unit (or such at least one of the members) linearly; and rotating the mobile unit (or such at least one of the members) about the conduit. The forming may include the step of: forming along a preset portion of the conduit at least one protrusion, indentation or depression each of which may be arranged to releasably retain the mobile unit (or such at least one of the members).

The providing the shield may include the step of fabricating the MS (and ES) as described in the co-pending Applications. The providing the shield may include the step of: selecting one or more of the MS (and ES) in the co-pending Application based upon its operating mechanisms. The providing the magnetic shield may include one of the steps of: incorporating at least one path member and at least one magnet member therein; and incorporating at least one path member but no magnet member therein. The positioning may include at least one of the steps of: incorporating the MS (and ES) over, on, into, inside, and/or behind the conduit and/or baffle; disposing the MS (and ES) between the air outlet and such at least one of the members; and disposing the MS (and ES) adjacent to such at least one of the members.

The operating may include the steps of: defining a preset number of stops along a path of the mobile unit; and disposing the mobile unit in each of the stops, thereby defining a preset number of the distances. The operating may include the step of: arranging such a mobile unit to telescopically move along a path thereof, thereby defining any distance between a preset maximum value and a preset minimum value. The translating (or pivoting) may also include the steps of: defining a preset number of stops along a path of such at least one of the members; and translating (or pivoting) such at least one of the members in each of the stops, thereby defining a preset number of the above distances. Such translating (or pivoting) may also include the step of: arranging such at least one of such members to telescopically move along a path thereof, thereby defining any distance between a preset maximum value and a preset minimum value.

The method for the system with the mobile member and/or unit may include one of the steps of: disposing the MS but not the ES into at least a portion of the system; disposing the ES but not the MS into at least a portion of the system; and incorporating the MS and ES into at least a portion of such a system. The incorporating may include the step of: incorporating the ES and MS in the same, similar or different portions of the system.

The method may include the step of: emitting through the air outlet of the system the magnetic waves of a magnetic field strength which may be no stronger than a preset limit when measured at a preset distance from the air outlet. The method may have the step of: emitting through any portion of the system the magnetic waves of a magnetic field strength which may be no stronger than a preset limit when measured at a preset distance from the air outlet. Such a preset limit may be 0.1 mG, 0.2 mG, 0.3 mG, 0.5 mG, 0.7 mG, 1 mG, 2 mG, 3 mG, 4 mG, 5 mG, 7 mG, 10 mG, and so on, and the preset distance may be 0.1 cm, 0.2 cm, 0.5 cm, 1 cm, 2 cm, 3 cm, 5 cm, 7 cm, 10 cm, 15 cm, 20 cm, 25 cm, 30 cm, and the like.

In another aspect of the present invention, a method may further be provided for maximizing an efficiency of heat transfer from a heating member of a hair drying system to a flow of air transported from an air inlet to an air outlet through a conduit of the system by an actuator member of the system.

In one exemplary embodiment of this aspect of the present invention, a method may include the steps of: spacing the air outlet from the air inlet by a preset distance; defining in the conduit at least one tortuous air path having a curvilinear length longer than the distance; disposing at least a portion of the heating member inside the air path; and flowing the air along such a tortuous path of the conduit while heating the air by the heating member, thereby maximizing such a heat transfer efficiency. The above defining may be replaced by the step of: defining in the conduit at least one air path defining a shape of at least one of, e.g., a zigzag pattern, a reciprocating pattern which forms at least one turn, a concentrically wound pattern, a helically wound pattern, and a combination thereof.

In another exemplary embodiment of this aspect of the present invention, a method may include the steps of: providing at least one heat exchange member defining a preset axial distance; defining inside the heat exchange member at least one air path having a curvilinear length longer than the axial distance of the heat exchange member; disposing at least a portion of the heating member inside such a heat exchange member; and flowing the air through the air path of the heat exchange member while heating the air by the heating member, thereby maximizing the heat transfer efficiency. Such defining may also be replaced by the step of: defining inside the heat exchange member at least one air path having a shape of at least one of, e.g., a zigzag pattern, a reciprocating pattern including at least one turn, a concentrically wound pattern, a helically wound pattern, and a combination thereof;

In another exemplary embodiment of this aspect of the present invention, a method may include the steps of: arranging at least a portion of the conduit to be bigger or wider than neighboring portions thereof; disposing at least a portion of the heating member in the bigger portion of such a conduit; and flowing the air through the air path of the heat exchange member while heating the air by the heating member, thereby mixing the air in the bigger portion of the conduit while maximizing the heat transfer efficiency.

In another exemplary embodiment of this aspect of the present invention, a method may include the steps of: disposing at least a portion of the heating member along at least a portion of the conduit; thermally insulating the portion of the conduit; and flowing the air through the air path of the conduit while heating the air by the heating member, thereby minimizing loss of the heat in such a portion of the conduit and maximizing the heat transfer efficiency.

Embodiments of this aspect of the invention may include one or more of the following features.

The disposing such a portion of the heating member may include the steps of: incorporating the portion of the heating member around, over, on, and/or in the conduit and/or heat exchange member. The disposing the portion of the heating member may include the steps of: incorporating the portion of the heating member along or transverse to the conduit and/or heat exchange member. The disposing may have the step of: installing at least one heat distributor and/or heat diffuser on, over or adjacent to the heating member, thereby enhancing the heat transfer from the heating member to the air. Such disposing may include the step of: disposing an entire portion of the heating member in such a conduit and/or heat exchange member.

The insulating may include the step of: disposing at least one material with a very low thermal conductivity in an interior of, over an exterior of, and inside the portion of the conduit and/or the heat exchange member. The defining the path for the air may include the step of: arranging the path of the air to be curvilinear and to define a length which may be longer than the distance by a preset ratio of, e.g., 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.5, 4.0, 4.5, 5.0, 5.5, 6.0, 6.5, 7.0, and so on.

The method may further include the step of: incorporating the MS (and ES) around an exterior of, an interior of, and/or an into a portion of the conduit member and/or heat exchange member. The incorporating may also include one of the steps of: extending the MS (and ES) beyond an end of the conduit and/or heat exchange member; and disposing the MS (and ES) over, on, and/or inside only a portion of the conduit and/or the heat exchange member. Other features of such preceding method aspects may also apply to various systems of this aspect of the invention.

In another aspect of the present invention, a method may be provided for minimizing an amount of electromagnetic waves irradiated by a hair drying system capable of providing a flow of heated air through a conduit thereof.

In one exemplary embodiment of this aspect of the present invention, a method may include the steps of: moving the flow through the conduit by an actuator member emitting the waves; heating the air by a heating member also emitting the waves; and arranging the members to irradiate such waves propagating in at least partially opposite directions so that each of the members is a counter member of the other thereof, thereby canceling at least a portion of the waves emitted by one of the members by at least a portion of the waves irradiated by the other of the members. The above arranging may also be replaced by the step of: orienting at least one conductive article of one of the members along a direction at least partially similar (or identical) to a direction of at least one conductive article of the other of the members while flowing electric currents along at least partially opposite directions in the articles of the members such that each of the members is a counter member of the other thereof. The above arranging may be replaced by the step of: orienting at least one conductive article of one of the members along a direction at least partially opposite to a direction of at least one conductive article of the other of such members while flowing electric currents along at least partially similar (or identical) directions in the articles of the members so that each of the members is a counter member of the other thereof. Such arranging may also be replaced by the steps of: including at least one extra conductive article in such a heating member; disposing the extra article around at least one of an exterior, interior, and inside of at least a portion of the actuator member; and arranging the extra article and the portion of the actuator member to irradiate the waves propagating along at least partially opposite directions so that each of the members is arranged to be a counter member of the other thereof. Such arranging may further be replaced by the steps of: including at least one extra conductive article in the actuator member; disposing the extra article around at least one of an exterior, interior, and inside of at least a portion of the heating member; and arranging the extra article and the portion of the heating member to emit the waves propagating along at least partially opposite directions such that each of the members is arranged to be a counter member of the other thereof.

In another exemplary embodiment of this aspect of the present invention, a method may include the steps of: moving the flow through the conduit by an actuator member emitting first of such waves; heating the air by a heating member irradiating second of such waves; disposing at least one counter member in a preset relation to at least one of such actuator and heating members; and arranging the counter member to emit third waves propagating in a direction at least partially opposite to at least one direction of the first and second waves, thereby canceling at least a portion of at least one of the first and second waves by at least a portion of the third waves. The above arranging may be replaced by the step of: orienting at least one conductive article of at least one of such members along a direction which may be at least partially similar (or identical) to a direction of at least one conductive article of the counter member while flowing electric currents along at least partially opposite directions in such articles of the members. The above arranging may also be replaced by the step of: orienting at least one conductive article of at least one of the members along a direction at least partially opposite to a direction of at least one conductive article of the counter member while flowing electric currents in a direction at least partially similar (or identical) direction in the articles of the members.

In another exemplary embodiment of this aspect of the present invention, a method may include the steps of: moving the flow through the conduit by an actuator member emitting the waves; heating the air by a heating member emitting the waves; identifying at least one cable of the system which is arranged to not actively participate in operation of at least one of the members and to emit the waves; and arranging the cable and such at least one of the members to emit the waves propagating along at least partially opposite directions so that each of such at least one of the members and the cable is a counter member of the other thereof, thereby canceling at least a portion of at least one of such first and second waves by at least a portion of the third waves. The above arranging may be replaced by the step of: orienting the cable along a direction at least partially similar (or identical) to a direction of at least one conductive article of such at least one of the members while flowing electric currents in at least partially opposite directions in the cable and the article of such at least one of the members so that each of such at least one of the members and the cable is a counter member of the other thereof. The above arranging may be replaced by the step of: orienting the cable along a direction which may be at least partially opposite to a direction of at least one conductive article of such at least one of the members while flowing electric currents along at least partially similar (or identical) directions in such a cable and the article of such at least one of the members such that each of such at least one of the members and the cable is a counter member of the other thereof.

In another aspect of the present invention, a method may be provided for minimizing an amount of electromagnetic waves emitted by an actuator member of a hair drying system for providing a flow of heated air through a conduit thereof using one of an DC and AC.

In one exemplary embodiment of this aspect of the present invention, a method may include the steps of: moving the air flow through the conduit by an actuator member irradiating first of the waves; heating the air by a heating member emitting second of the waves; identifying a rotor and a permanent magnet of the actuator member; and generating by at least one counter member third of such waves propagating along a direction at least partially opposite to at least a portion of the first waves emitted by at least one of the rotor and permanent magnet, thereby canceling at least a portion of such first waves by the third waves.

In another exemplary embodiment of this aspect of the present invention, a method may include the steps of: moving the flow through the conduit by an actuator member emitting first of such waves; heating the air by a heating member emitting second of such waves; identifying a rotor and a stator of the actuator member; and generating by at least one counter member third of the waves propagating along a direction at least partially opposite to at least a portion of the first waves emitted by at least one of the rotor and stator, thereby canceling at least a portion of the first waves by the third waves.

Embodiments of the foregoing two aspects of the present invention may include one or more of the following features.

The method may include at least one of the steps of: disposing each of the counter members separately along the conduit member; disposing one of the counter members inside (or outside) the other of the counter members, and so on. The orienting may also include at least one of the steps of: disposing along a straight line, disposing about the straight line radially, disposing about the straight line helically; enclosing at least a portion of the straight line in a mesh-shaped pattern, and the like. The including may include at least one of the steps of: arranging the extra article to define a different conductivity from the rest of such a heating member and to not be able to generate the heat when the current flows therein; and arranging the extra article to have different electromagnetic properties from the rest of the actuator member and to not participate in normal operation of the actuator member.

The method may include the step of: extending the counter member in a preset length along its curvilinear longitudinal axis. The method may include the step of: shaping the counter member into one of, e.g., a wire, a strip, a sheet, a bundle thereof, a stack thereof, a braid thereof, a mesh thereof, a concentric article thereof, and so on. The shaping may include the steps of: forming multiple sections in the counter member, and bifurcating (or merging) at least one of the sections. Such a method may include the step of: performing the canceling (and/or generating the third of the waves) by supplying the current to the counter member from one of the actuator member, the heating member, other parts of the system, and a separate power source. The method may include the steps of: performing the canceling (and/or generating the third of the waves) by supplying current to the counter member; and delivering the current to one of the actuator member, the heating member, other parts of the system, and a ground. The method may include the step of: arranging the third waves emitted by the counter member to be weaker (or stronger) than those emitted by one of the actuator and heating members. Other features of the preceding method aspects may also apply to various systems of this aspect of the invention.

In another aspect of the present invention, a method may be provided for coupling an article to and reducing magnetic (and electric) waves irradiated by a hair drying system for taking air in by an actuator member irradiating the waves, heating the air by a heating member also emitting such waves, and discharging the heated air through a conduit and an air outlet by the actuator member.

In one exemplary embodiment of this aspect of the present invention, a method may include the steps of: defining an inlet end and an outlet end in the article; forming at least one magnetic shield for reducing propagation of the waves therethrough; disposing such a magnetic shield across at least a substantial portion of a cross-section of the article while providing fluid communication between the inlet end and outlet end; coupling the inlet end of the article with the air outlet of the system; and then discharging the heated air by the heating and actuator members through the air outlet and the inlet end of the article while reducing propagation of the waves by the magnetic shield, thereby reducing such waves emitted through the conduit and then the article. The above coupling and discharging may be replaced by the steps of: discharging the heated air by the heating and actuator members through the air outlet; coupling the inlet end of the article to the air outlet of the system; and adjusting at least one of disposition and orientation of the article with respect to the system until a magnetic field strength of the magnetic waves falls below a preset limit when measured at a preset distance from the outlet end of the article.

In another exemplary embodiment of this aspect of the present invention, a method may include the steps of: conforming at least a portion of such an article to at least a portion of an exterior of such a conduit; incorporating into the article at least one magnetic shield capable of reducing propagation of the waves therethrough; coupling the article onto the exterior of the conduit; and then discharging the heated air by such heating and actuator members through the air outlet while reducing propagation of such waves through the exterior of the conduit with the magnetic shield, thereby reducing the waves emitted through the conduit and then through the article. The above coupling and discharging may be replaced by the steps of: discharging the heated air by the heating and actuator members through the air outlet; coupling the article onto the exterior of the conduit; and adjusting at least one of disposition and orientation of the article with respect to the system until a magnetic field strength of the magnetic waves falls below a preset limit when measured at a preset distance from the article.

Embodiments of this aspect of the invention may include one or more of the following features.

The article may include at least one ES. The ES and MS may be disposed in the same, adjacent or different locations of the article. The above preset limit may be 0.1 mG, 0.2 mG, 0.3 mG, 0.5 mG, 0.7 mG, 1 mG, 2 mG, 3 mG, 4 mG, 5 mG, 7 mG, 10 mG, and so on, while the above preset distance may be 0.1 cm, 0.2 cm, 0.5 cm, 1 cm, 2 cm, 3 cm, 5 cm, 7 cm, 10 cm, 15 cm, 20 cm, 25 cm, 30 cm, and the like. Other features of the preceding method aspects may also apply to various systems of this aspect of the invention.

In another aspect of the present invention, a method may be provided for forming a hair drying system for taking in air by an actuator member, heating the air by a heating member, transporting such heated air along an air path, and then discharging such heated air through an air outlet by the actuator member while varying a configuration between its hand unit and base unit.

In one exemplary embodiment of this aspect of the invention, a method may include the steps of: movably coupling the hand unit with the base unit; forming a grip for an user of the system on the hand unit; and disposing at least one of such heating and actuator members in the base unit, thereby reducing a weight and a volume of the hand unit forming the grip thereon.

In another exemplary embodiment of such an aspect of the invention, a method may include the steps of: movably coupling the units; forming a grip for an user of the system in the hand unit; fixedly or releasably coupling the base unit with an object; fluidly coupling the hand and base units by at least one coupling unit; and disposing at least one of such heating and actuator members in at least one of the base and coupling units, thereby allowing an user to not only dispose the hand unit apart from the base and coupling units but also misalign the hand unit off from the base and coupling units.

In another exemplary embodiment of such an aspect of the invention, a method may include the steps of: movably coupling the units; forming the air outlet in the hand unit; and disposing at least one of the heating and actuator members in such a base unit, thereby preventing (or at least suppressing) formation a line of sight from the air outlet to such at least one of the heating and actuator members.

In another exemplary embodiment of such an aspect of the invention, a method may include the steps of: movably coupling the units; forming a grip in the hand unit; disposing in the base unit at least one of such heating and actuator members; and incorporating at least one magnetic shield capable of preventing (or at least minimizing) propagation of magnetic waves therethrough in preset locations of at least one of the units, thereby suppressing formation of a line of sight for the waves between the air outlet and such at least one of the heating member and actuator member.

In another aspect of the present invention, a method may be provided for forming a hair drying system having multiple units and capable of generating a flow of heated air through an air outlet.

In one exemplary embodiment of this aspect of the invention, a method may include the steps of: movably coupling at least one of such units to at least another of such units; defining the air outlet in such one of the units; and disposing in such another of the units at least one of a heating member for heating the air and an actuator member for moving the heated air through such one of the units to the air outlet, thereby reducing a weight and a volume of such one of the units with the grip thereon.

In another exemplary embodiment of such an aspect of the invention, a method may include the steps of: movably coupling at least one of such units to at least another of such units; defining the air outlet in such one of the units; coupling such another of the unit with an object; fluidly coupling such one of the units with such another of the units; and disposing in such another of the units at least one of a heating member for heating the air and an actuator member for transporting the heated air through such one of the units to the air outlet, thereby allowing an user of the system to not only dispose such one of the units apart from such another of the units but also to misalign such one of the units off from such another of the units.

In another exemplary embodiment of such an aspect of the invention, a method may include the steps of: movably coupling at least one of such units to at least another of such units; defining the air outlet in such one of the units; and disposing at least one of a heating member for heating the air and an actuator member for transporting the heated air through such one of the units in such another of the units, thereby preventing (or at least suppressing) formation a line of sight between the air outlet and such at least one of the heating and actuator members.

In another exemplary embodiment of such an aspect of the invention, a method may include the steps of: movably coupling at least one of such units to at least another of such units; defining the air outlet in such one of the units; and disposing at least one of the heating and actuator members in such another of such units; and incorporating at least one magnetic shield capable of preventing (or at least minimizing) propagation of magnetic waves therethrough in or along preset locations of at least one of such one and another of the units, thereby preventing (or at least suppressing) formation of a line of sight for the waves from the air outlet to such at least one of the heating and actuator members.

In another aspect of the present invention, a method may also be provided for providing a hair drying system capable of generating a flow of heated air through an air outlet thereof.

In one exemplary embodiment of this aspect of the invention, a method may include the steps of: providing a base unit, a coupling unit, and a hand unit defining a grip for an user and the air outlet; movably coupling the hand unit with the base unit through the coupling unit; heating air in the base unit; generating a driving force in the base unit; and moving such heated air by the driving force from the base unit toward the air outlet of the hand unit through the coupling unit, thereby generating the flow of the heated air while performing such heating and moving not in the hand unit with the air outlet.

In another exemplary embodiment of such an aspect of the invention, a method may include the steps of: providing a base unit, a coupling unit, and a hand unit defining a grip for an user and the air outlet; movably coupling the hand unit with the base unit through the coupling unit generating a driving force in the base unit; moving air by the driving force from the base unit to the hand unit through the coupling unit; heating the air in the hand unit; and further moving such heated air by the driving force through the air outlet, thereby generating the flow of heat air while performing such moving not in the hand unit with the air outlet.

In another exemplary embodiment of such an aspect of the invention, a method may include the steps of: providing a base unit, a coupling unit, and a hand unit defining a grip for an user and the air outlet; movably coupling the hand unit with the base unit through the coupling unit; generating a driving force in the base unit; moving air by such driving force from the base unit to the coupling unit; heating the air in the coupling unit; and further moving the heated air by the driving force through the air outlet, thereby generating the flow of heat air while performing such moving and heating not in the hand unit with the air outlet.

In another exemplary embodiment of such an aspect of the invention, a method may include the steps of: providing a base unit, a coupling unit, and a hand unit defining a grip for an user and the air outlet; movably coupling the hand unit with the base unit through the coupling unit; generating a torque in the base unit; transferring the torque to the hand unit through the coupling unit; generating a driving force in the hand unit; heating air in the hand unit; and moving the heated air by the driving force from the hand unit toward the air outlet, thereby generating the flow of the heated air while performing the generating the torque not in the hand unit with the air outlet.

In another aspect of the present invention, a method may also be provided for providing a hair drying system capable of generating a flow of heated air through an air outlet thereof and being used along with an object.

In one exemplary embodiment of this aspect of the invention, a method may include the steps of: providing a base unit, a coupling unit, and a hand unit defining a grip for an user and the air outlet; movably coupling the hand unit with the base unit through the coupling unit; defining at least a portion of the coupling unit in (or along) the object; heating air in the base unit; generating a driving force in the base unit; and moving the heated air by the driving force from the base unit toward the air outlet of the hand unit through the coupling unit, thereby generating the flow of the heated air while performing the heating and moving not in the hand unit with the air outlet.

In another exemplary embodiment of such an aspect of the invention, a method may include the steps of: providing a base unit, a coupling unit, and a hand unit defining a grip for an user and the air outlet; movably coupling the hand unit with the base unit through the coupling unit defining at least a portion of the coupling unit in (or along) the object; generating a driving force in the base unit; moving air by the driving force from the base unit to the hand unit through the coupling unit; heating the air in the hand unit; and further moving the heated air by such driving force through the air outlet, thereby generating the flow of heat air while performing the moving not in the hand unit with the air outlet.

In another exemplary embodiment of such an aspect of the invention, a method may include the steps of: providing a base unit, a coupling unit, and a hand unit defining a grip for an user and the air outlet; movably coupling the hand unit with the base unit through the coupling unit defining at least a portion of the coupling unit in (or along) the object; generating a driving force in the base unit; moving air by the driving force from the base unit to the coupling unit; heating the air in the coupling unit; and further moving the heated air by the driving force through the air outlet, thereby generating the flow of heat air while performing the moving and heating not in the hand unit with the air outlet.

In another exemplary embodiment of such an aspect of the invention, a method may include the steps of: providing a base unit, a coupling unit, and a hand unit defining a grip for an user and the air outlet; movably coupling the hand unit with the base unit through the coupling unit; generating a torque in the base unit; defining at least a portion of the coupling unit in (or along) the object; transferring the torque to the hand unit through the coupling unit; generating a driving force in the hand unit; heating air in the hand unit; and moving the heated air by the driving force from the hand unit toward the air outlet, thereby generating the flow of such heated air while performing such generating the torque not in the hand unit with the air outlet.

In another aspect of the present invention, a method may also be provided for providing a hair drying system capable of generating a flow of heated air through an air outlet thereof while minimizing propagation of magnetic waves irradiated by the system away therefrom.

In one exemplary embodiment of this aspect of the invention, a method may include the steps of: providing a base unit, a coupling unit, and a hand unit defining a grip for an user and the air outlet; movably coupling the hand unit with the base unit through the coupling unit; heating air in the base unit while shielding at least a portion of the magnetic waves from the heating; generating a driving force in the base unit while shielding at least a portion of the magnetic waves from the generating; and moving the heated air by the driving force from the base unit toward the air outlet of the hand unit through the coupling unit, thereby generating the flow of the heated air while performing such heating and moving not in the hand unit with the air outlet and while performing the minimizing.

In another exemplary embodiment of such an aspect of the invention, a method may include the steps of: providing a base unit, a coupling unit, and a hand unit defining a grip for an user and the air outlet; movably coupling the hand unit with the base unit through the coupling unit generating a driving force in the base unit while shielding at least a portion of the magnetic waves from such generating; moving air by the driving force from the base unit to the hand unit through the coupling unit; heating the air in the hand unit while shielding at least a portion of the waves from such heating; and then further moving such heated air by the driving force through the air outlet, thereby generating the flow of heat air while performing such moving not in the hand unit with the air outlet and while also performing the minimizing.

In another exemplary embodiment of such an aspect of the invention, a method may include the steps of: providing a base unit, a coupling unit, and a hand unit defining a grip for an user and the air outlet; movably coupling the hand unit with the base unit through the coupling unit generating a driving force in the base unit while shielding at least a portion of such magnetic waves from such generating; moving air by the driving force from the base unit to the coupling unit; heating the air in the coupling unit while shielding at least a portion of the magnetic waves from the heating; and then further moving the heated air by the driving force through the air outlet, thereby generating the flow of heat air while performing such moving and heating not in the hand unit with the air outlet and while performing such minimizing.

In another exemplary embodiment of such an aspect of the invention, a method may include the steps of providing a base unit, a coupling unit, and a hand unit defining a grip for an user and the air outlet; movably coupling the hand unit with the base unit through the coupling unit; generating a torque in the base unit while shielding at least a portion of the waves from such generating; transferring the torque to the hand unit through the coupling unit; generating a driving force in the hand unit; heating air in the hand unit while shielding at least a portion of the magnetic waves from the heating; and moving the heated air by the driving force from the hand unit toward the air outlet, thereby generating the flow of the heated air while performing the generating the torque not in the hand unit with the air outlet and while performing the minimizing.

Other features of the foregoing apparatus and/or method aspects of this invention may apply to the preceding five method aspects of this invention as well.

In another aspect of the present invention, a hair drying system may be provided by various processes for generating a flow of heated air through at least one air outlet thereof while preventing (or at least minimizing) formation of a line of sight between the air outlet and at least one source of the system which irradiates magnetic waves and electric waves of electromagnetic waves.

In one exemplary embodiment of this aspect of the invention, such a hair drying system may be made by a process comprising the steps of: forming at least one conduit for a flow of air; defining at least one air inlet and at least one air outlet in opposing ends of such a conduit; providing at least one actuator member capable of moving air through the conduit from the air inlet toward the air outlet while irradiating the waves; providing at least one heating member capable of generating heat when electric current flows therein while irradiating the waves; disposing the heating member along an interior (or exterior) of the conduit for transferring at least a portion of the heat generated thereby onto the flow of air; and arranging the conduit to prevent (or at least minimize) formation of the line of sight from the air outlet to at least one of such members while allowing the flow of air through the conduit, thereby performing the preventing (or at least minimizing). The above arranging may be replaced by the steps of: providing at least one magnetic (and electric) shield for preventing (or for at least minimizing) such magnetic (and electric) waves from propagating therethrough; disposing the magnetic (and electric) shield along the conduit; and then arranging the magnetic (and electric) shield to prevent (or to at least minimize) formation of the line of sight between the air outlet and at least one of such members while allowing the flow of air through the conduit, thereby attenuating an intensity of magnetic (and electric) field of the magnetic (and electric) waves measured at a preset distance from the air outlet below a preset limit.

In another exemplary embodiment of this aspect of the invention, a hair drying system may be made by a process comprising the steps of: forming at least one conduit for a flow of air; defining at least one air inlet and at least one air outlet in opposing ends of such a conduit; providing at least one actuator member capable of moving air through the conduit from the air inlet toward the air outlet while irradiating the waves; providing at least one heating member capable of generating heat when electric current flows therein while irradiating the waves; disposing the heating member along an interior (or exterior) of the conduit for transferring at least a portion of the heat generated thereby onto the flow of air; incorporating at least one baffle along and in an interior of the conduit; and arranging the baffle to obstruct at least a substantial part of a cross-section of the conduit while allowing the flow of air through the conduit, thereby performing the preventing (or at least minimizing). The above arranging may be replaced by the steps of: providing at least one magnetic (and electric) shield for preventing (or at least minimizing) the magnetic (and electric) waves from propagating therethrough; disposing such magnetic (and electric) shield on (or over, inside) the baffle; and arranging the baffle to obstruct at least a substantial part of a cross-section of the conduit while allowing the flow of air through the conduit, thereby attenuating a intensity of magnetic (and electric) field of the magnetic (and electric) waves which is measured at a preset distance from the air outlet below a preset limit.

In another exemplary embodiment of this aspect of the invention, a hair drying system may be made by a process comprising the steps of: forming at least one conduit for a flow of air; defining at least one air inlet and at least one air outlet in opposing ends of such a conduit; providing at least one actuator member capable of moving air through the conduit from the air inlet toward the air outlet while irradiating the waves; providing at least one heating member capable of generating heat when electric current flows therein while irradiating the waves; disposing the heating member along an interior (or exterior) of the conduit for transferring at least a portion of the heat generated thereby onto the flow of air; and bending at least a portion of the conduit to prevent (or at least minimize) formation of such a line of sight between the air outlet and at least one of the members while allowing the air flow through the conduit, thereby performing the preventing (or at least minimizing). Such bending may be replaced by the steps of: providing at least one magnetic (and electric) shield capable of preventing (or at least minimizing) the magnetic (and electric) waves from propagating therethrough; disposing the magnetic (and electric) shield on (or over, inside) the conduit; and bending at least a portion of such a conduit to prevent (or to at least minimize) formation of the line of sight for the waves between the air outlet and at least one of the members while allowing the flow of air through the conduit, thereby attenuating an intensity of magnetic (and electric) field of the magnetic (and electric) waves measured at a preset distance from the air outlet below a preset limit.

In another aspect of the present invention, a hair drying system may be provided by various processes for generating a flow of heated air through at least one air outlet thereof while varying a distance between the air outlet and at least one source of the system emitting electromagnetic waves.

In one exemplary embodiment of this aspect of the invention, such a hair drying system may be made by a process comprising the steps of: forming at least one conduit for a flow of air; defining at least one air inlet and at least one air outlet in opposing ends of such a conduit; providing at least one actuator member for moving air through the conduit from the air inlet to the air outlet while irradiating the waves; providing at least one heating member capable of generating heat when electric current flows therein while irradiating the waves; disposing the heating member along an interior (or exterior) of the conduit for transferring at least a portion of the heat generated thereby onto the flow of air; and arranging the air outlet, conduit, and/or members to move between at least two states while varying the distance between the air outlet and at least one of the members.

In another exemplary embodiment of this aspect of the invention, a hair drying system may be made by a process comprising the steps of: forming at least one conduit for a flow of air; defining at least one air inlet and at least one mobile air outlet in opposing ends of the conduit; providing at least one actuator member capable of moving air through the conduit from the air inlet to the air outlet while irradiating the waves; providing at least one heating member capable of generating heat when electric current flows therein while irradiating the waves; disposing the heating member along an interior (or exterior) of the conduit for transferring at least a portion of the heat generated thereby onto the flow of air; and arranging the air outlet to translate along the conduit between at least two states relative to at least one of the members while varying the distance therebetween.

In another exemplary embodiment of this aspect of the invention, a hair drying system may be made by a process comprising the steps of: forming at least one conduit for a flow of air; defining a mobile unit and a stationary unit in the conduit; incorporating at least one air outlet in the mobile unit; disposing at least one air inlet in the stationary unit; providing at least one actuator member capable of moving air through the conduit from the air inlet to the air outlet while irradiating the waves; providing at least one heating member for generating heat when electric current flows therein while irradiating the waves; disposing the heating member along an interior (or exterior) of the conduit for transferring at least a portion of the heat generated thereby onto the flow of air; and arranging the mobile unit to move between at least two states while varying the distance between the air outlet and at least one of the members.

In another exemplary embodiment of this aspect of the invention, a hair drying system may be made by a process comprising the steps of: forming at least one conduit for a flow of air; defining a mobile unit and a stationary unit in the conduit; disposing at least one air outlet in the stationary unit; providing at least one actuator member capable of moving air through the conduit from the air inlet to the air outlet while irradiating the waves; providing at least one heating member capable of generating heat when electric current flows therein while irradiating the waves; disposing the heating member along an interior (or exterior) of the conduit for transferring at least a portion of such heat generated thereby onto the flow of air; incorporating at least one of such members into the mobile unit; and then arranging the mobile unit to move between at least two states while varying the distance between the air outlet and at least one of the members.

In another aspect of the present invention, a hair drying system may be provided by various processes for generating a flow of heated air through at least one air outlet thereof while minimizing an amount of electromagnetic waves emitted therefrom through generating multiple electromagnetic waves capable of canceling at least portions each other.

In one exemplary embodiment of this aspect of the invention, such a hair drying system may be made by a process comprising the steps of: forming at least one conduit for a flow of air; defining at least one air inlet and at least one air outlet in opposing ends of such a conduit; providing at least one actuator member for moving air through the conduit from the air inlet to the air outlet while irradiating the waves; providing at least one heating member capable of generating heat when electric current flows therein while irradiating the waves; disposing the heating member along an interior (or exterior) of the conduit for transferring at least a portion of the heat generated thereby onto the flow of air; and arranging the members to emit the waves in at least partially opposite directions such that the waves emitted by one of the members cancel at least a portion of the waves irradiated by the other thereof, thereby performing the minimizing. The above arranging may be replaced by the step of: arranging conductors of the members to be oriented in at least partially similar (or identical) patterns and to flow the current in at least partially opposite directions, thereby canceling at least a portion of such waves emitted by one of the members by those emitted by the other thereof. The above arranging may also be replaced by the step of: arranging conductors of such members to be oriented in at least partially opposite patterns and to flow the current in at least partially similar (or identical) directions, thereby canceling at least a portion of the waves emitted by one of the members by those emitted by the other thereof.

In another exemplary embodiment of this aspect of the invention, a hair drying system may be made by a process comprising the steps of: forming at least one conduit for a flow of air; defining at least one air inlet and at least one air outlet in opposing ends of such a conduit; providing at least one actuator member capable of moving air through the conduit from the air inlet toward the air outlet while irradiating the waves; providing at least one heating member capable of generating heat when electric current flows therein while irradiating the waves; disposing the heating member along an interior (or exterior) of the conduit for transferring at least a portion of the heat generated thereby onto the flow of air; defining an extra portion in the actuator member; and arranging such a portion of the actuator member and the heating member to emit the waves in at least partially opposite directions so that the waves emitted by one of the members cancel at least a portion of those emitted by the other thereof, thereby performing the minimizing. The above defining and arranging may be replaced by the steps of: defining an extra portion in the heating member; and arranging the portion of the heating member and the actuator member to emit the waves in at least partially opposite directions so that the waves emitted by one of the members cancel at least a portion of those emitted by the other thereof, thereby performing the minimizing.

In another exemplary embodiment of this aspect of the invention, a hair drying system may be made by a process comprising the steps of: forming at least one conduit for a flow of air; defining at least one air inlet and at least one air outlet in opposing ends of such a conduit; providing at least one actuator member for moving air through the conduit from the air inlet to the air outlet while irradiating first of the waves; providing at least one heating member capable of generating heat when electric current flows therein while irradiating second of the waves; disposing the heating member along an interior (or exterior) of the conduit for transferring at least a portion of such heat generated thereby onto the flow of air; incorporating at least one counter member along a path of the waves; and then arranging the counter member to irradiate third waves propagating along an at least partially opposite direction to at least one of the first and second waves, thereby performing the canceling.

In another exemplary embodiment of this aspect of the invention, a hair drying system may be made by a process comprising the steps of: forming at least one conduit for a flow of air; defining at least one air inlet and at least one air outlet in opposing ends of such a conduit; providing at least one actuator member capable of moving air through the conduit from the air inlet toward the air outlet while irradiating first of the waves; providing at least one heating member capable of generating heat when electric current flows therein while irradiating second of such waves; disposing the heating member along an interior (or exterior) of the conduit for transferring at least a portion of such heat generated thereby onto the flow of air; identifying at least one electric cable from a circuit including at least one of the members; and arranging the cable to irradiate third waves propagating along an at least partially opposite direction to at least one of the first and second waves, thereby performing such canceling. The above identifying may also be replaced by the step of: identifying at least one electric cable from a circuit independent of the members. The above identifying may further be replaced by the step of: identifying at least one electric cable from (or to) a power supply for the system.

In another aspect of the present invention, a hair drying system may be provided by various processes for reducing magnetic (and electric) waves irradiated by a hair drying system for taking air in by an actuator member emitting the waves, heating the air by a heating member emitting the waves, and discharging the heated air through a conduit and then an air outlet by the actuator member.

In one exemplary embodiment of this aspect of the invention, such a hair drying system may be made by a process comprising the steps of: defining in the article an outlet end and an inlet end for coupling with the air outlet; providing at least one magnetic (and electric) shield for preventing (or at least minimizing) the magnetic (and electric) waves from propagating therethrough; incorporating the magnetic shield into a cross-section of such an article while allowing flow of air through the article; coupling the inlet end of the article with the air outlet of such a system; and discharging the heated air through the air outlet and through the article while reducing propagation of the waves by the shield, thereby reducing the waves emitted through the conduit and the article. The coupling and discharging may be replaced by the steps of: arranging the article to have at least one of an adjustable dimension and orientation; discharging such heated air through the air outlet; coupling the inlet end of the article with the air outlet of the system; and adjusting at least one of the dimension and the orientation of the article till a strength of a magnetic (and electric) field of the magnetic (and electric) waves decreases down to a preset limit when measured at a preset distance from the outlet end of the article.

In another exemplary embodiment of this aspect of the invention, a hair drying system may be made by a process comprising the steps of: defining in the article an outlet end and an inlet end for coupling with the air outlet; conforming at least a portion of such an article to at least a portion of an exterior of the conduit; providing at least one magnetic (and electric) shield for preventing (or at least minimizing) the magnetic (and electric) waves from propagating therethrough; including the magnetic (and electric) shield into at least a portion of the article; coupling the article onto the exterior of such a conduit; and discharging the heated air by such heating and actuator members through the air outlet while reducing propagation of the waves through the exterior of the conduit with the magnetic shield, thereby reducing the waves emitted through the exterior of the article. The coupling and discharging may be replaced by the steps of: arranging the article to have at least one of an adjustable dimension and orientation; discharging the heated air through the air outlet; coupling the article onto the exterior of the conduit; and adjusting at least one of disposition and orientation of the article with respect to the system until a magnetic field strength of the magnetic waves falls below a preset limit when measured at a preset distance from the article.

In another aspect of the present invention, a hair drying system may include multiple movable units forming at least one air path having at least one air inlet and at least one air outlet through at least one of the units.

In one exemplary embodiment of this aspect of the invention, such a system may be made by a process comprising the steps of: forming a hand unit and a base unit; defining the air outlet in the hand unit; defining the air path in the units; providing at least one heating member which may be arranged to generate heat; incorporating at least a portion of the heating member in the air path of the hand unit in order to transfer at least a portion of the heat to air flowing through the air path; providing at least one actuator member for taking air in through the air inlet, for moving the air through such an air path of the base unit, and for discharging the air through the air outlet; and movably coupling the hand unit to the base unit such that the hand unit is capable of being disposed apart and misaligned from the base unit, thereby reducing a weight and a volume of each of the units. The movably coupling may be replaced by the step of: movably coupling the hand unit with the base unit such that the hand unit is capable of being disposed apart and misaligned from the base unit, thereby rendering an user not see the heating and actuator members through the air outlet.

In another exemplary embodiment of this aspect of the invention, such a system may be made by a process comprising the steps of: forming a hand unit and a base unit; defining the air outlet in the hand unit; providing the hand unit with a grip for an user of the system; defining such an air path in the units; providing at least one heating member which is arranged to generate heat; incorporating at least a portion of the heating member in the air path of the base unit in order to transfer at least a portion of the heat to air flowing through such an air path; providing at least one actuator member for taking air in through the air inlet, for moving the air through the air path of the base unit, and for discharging the air through the air outlet; and movably coupling the hand unit with the base unit so that the hand unit may be capable of being disposed apart and misaligned from the base unit, thereby reducing a weight and a volume of the hand unit. Such movably coupling may be replaced by the step of: movably coupling the hand unit with the base unit such that the hand unit may be capable of being disposed apart and misaligned from the base unit, thereby rendering the user not see the heating and actuator members through the air outlet.

In another exemplary embodiment of this aspect of the invention, such a system may be made by a process comprising the steps of: forming a hand unit and a base unit; defining the air path in the units; providing at least one heating member which is arranged to generate heat; incorporating at least a portion of the heating member in the air path of the hand unit in order to transfer at least a portion of the heat to air flowing through the air path; providing at least one actuator member capable of taking air in through the air inlet, moving the air through the air path of the base unit, and discharging the air through the air outlet; providing at least one coupling unit having a length longer than a portion of the air path formed in the hand unit; disposing the coupling unit between the hand and base units movably, thereby allowing the hand unit to move with respect to the base unit.

In another exemplary embodiment of this aspect of the invention, such a system may be made by a process comprising the steps of: forming a hand unit and a base unit; defining the air outlet in the hand unit; providing the hand unit with a grip for an user of the system; defining such an air path in the units; providing at least one heating member which is arranged to generate heat; incorporating at least a portion of the heating member in the air path of the base unit in order to transfer at least a portion of such heat to air flowing through the air path; providing at least one actuator member capable of taking air in through the air inlet, moving the air through the air path, and discharging such air through the air outlet; providing at least one coupling unit having a length longer than a portion of the air path formed in the hand unit; and movably disposing the coupling unit between such hand and base units, thereby allowing the hand unit to move with respect to the base unit.

In another aspect of the present invention, a hair drying system may be provided for taking in air by an actuator member, heating the air by a heating member, transporting the heated air along an air path, and discharging the heated air through an air outlet by the actuator member while changing a configuration between its hand unit and its base unit.

In one exemplary embodiment of this aspect of the invention, such a system may be made by a process comprising the steps of: arranging such units to move with respect to each other; forming a grip for an user of the system on the hand unit; incorporating at least one of the heating member and actuator member into the base unit; and arranging the hand unit to have a reduced weight and volume

In another exemplary embodiment of this aspect of the invention, such a system may be made by a process also comprising the steps of: forming a grip for an user of the system on the hand unit; fixedly or releasably coupling the base unit with an object; providing fluid communication between the units through at least one coupling unit; incorporating at least one of the heating and actuator members into at least one of the base and coupling units; and movably arranging the hand unit with the coupling unit while disposing the hand unit to be not only spaced apart from but also misaligned from the base and coupling units.

In another exemplary embodiment of this aspect of the invention, such a system may be made by a process comprising the steps of: forming the air outlet in the hand unit; incorporating at least one of the heating and actuator members into the base unit; and then movably coupling the hand unit with the base unit while disposing the hand unit to prevent (or at least suppress) formation a line of sight between the air outlet and the at least one of the heating and actuator members.

In another exemplary embodiment of this aspect of the invention, such a system may be made by a process comprising the steps of: arranging the units to move with respect to each other; forming a grip for an user of the system on the hand unit; incorporating at least one of the heating member and actuator member into the base unit; and incorporating at least one magnetic shield for preventing (or at least minimizing) propagation of magnetic waves therethrough in preset locations of at least one of the units, thereby preventing (or at least suppressing) formation of a line of sight for the waves from the air outlet to the at least one of the heating member and actuator member.

In another aspect of the present invention, a hair drying system may be formed for generating a flow of heated air through an air outlet thereof and being used along with an object.

In one exemplary embodiment of this aspect of the invention, such a system may be made by a process comprising the steps of: providing a base unit, a coupling unit, and a hand unit with a grip for an user and the air outlet; movably coupling the hand unit with the base unit through the coupling unit; defining at least a portion of the coupling unit in (or along) the object; incorporating at least one heating member for heating air in the base unit; incorporating at least one actuator member for generating a driving force in the base unit; and moving the heated air by the driving force from the base unit toward the air outlet of the hand unit through the coupling unit, thereby generating the flow of the heated air while performing the heating and moving not in the hand unit with the air outlet.

In another exemplary embodiment of this aspect of the invention, such a system may be made by a process also comprising the steps of: providing a base unit, a coupling unit, and a hand unit with a grip for an user and the air outlet; movably coupling the hand unit with the base unit through such a coupling unit; defining at least a portion of the coupling unit in or along the object; incorporating at least one actuator member for generating a driving force in such a base unit; moving air by the driving force from the base unit to the hand unit through the coupling unit; incorporating at least one heating member for heating the air in the hand unit; and further moving the heated air by the driving force through the air outlet, thereby generating the flow of heat air while performing the moving not in the hand unit with the air outlet.

In another exemplary embodiment of this aspect of the invention, such a system may be made by a process also comprising the steps of: providing a base unit, a coupling unit, and a hand unit with a grip for an user and the air outlet; movably coupling the hand unit with the base unit through such a coupling unit; defining at least a portion of the coupling unit in or along the object; incorporating at least one actuator member for generating a driving force in such a base unit; moving air by the driving force from the base unit to the coupling unit; incorporating at least one heating member for heating the air in the coupling unit; and further moving the heated air by the driving force through the air outlet, thereby generating the flow of heat air while performing the moving and heating not in the hand unit with the air outlet.

In another exemplary embodiment of this aspect of the invention, such a system may be made by a process also comprising the steps of: providing a base unit, a coupling unit, and a hand unit with a grip for an user and the air outlet; movably coupling the hand unit with the base unit through such a coupling unit; incorporating at least one motor for generating a torque in the base unit; incorporating at least one impeller for generating a driving force in the hand unit; defining at least a portion of such a coupling unit in (or along) the object; incorporating the impeller in the hand unit; installing at least one axle for transferring the torque from the motor in the base unit to the impeller in the hand unit through the coupling unit; generating a driving force in the hand unit; incorporating at least one heating member for heating air in the hand unit; and moving the heated air by the driving force from the hand unit to the air outlet, thereby generating the flow of the heated air while performing the generating the torque not in the hand unit with the air outlet.

More product-by-process claims may be constructed by modifying the foregoing preambles of the apparatus and/or method claims and by appending thereonto such bodies of the apparatus and/or method claims. In addition, such process claims may include one or more of the above features of the apparatus and/or method claims of the present invention.

As used herein, the term “magnet” refers to a material or an article which may spontaneously or actively generate magnetic fields therearound by itself, where a strength of the magnetic fields may be measured by a conventional gaussmeter. Accordingly, a permanent magnet defining any arbitrary shape, size, and/or number of the N and S poles may qualify as the “magnet” within the scope of this invention as far as the permanent magnet may generate the measurable magnetic fields therearound. It is to be understood that the “magnet” may not refer to electromagnets unless otherwise specified.

Similarly, the term “magnetic” refers to a property of a material or article which may be able to spontaneously or actively generate magnetic fields therearound. Therefore, a “magnetic material” or “magnetic article” refers to a permanent magnet or an article with the permanent magnet. In contrary, a “nonmagnetic” refers to a property of a material or article which may not spontaneously or actively generate such magnetic fields. Thus, a “paramagnetic,”“diamagnetic,” and “ferrimagnetic” material or article generally belongs to such a “nonmagnetic” material. It is to be understood that a ferromagnetic material or article may be or may not be “magnetic” depending upon its magnetic state and that such a “nonmagnetic” ferromagnetic material or article may be converted to be “magnetic” by properly aligning its magnetic domains. It is also to be understood that the term “magnetic” refers to the above meaning when related to an article. In contrary, the term “magnetic” may connote different meaning when used in conjunction with verbs, more particularly, the verb “couple” as follows.

Contrary to the co-pending Applications, the term “couple” refers to “physically couple” within the scope of this invention and, thus, is to be differentiated from magnetically and/or electrically couple multiple articles. In addition, the term “movably couple” multiple articles refers to couple multiple articles with each other while changing alignments of longitudinal axes of such articles, changing distances between at least two of such articles, and so on.

A “target” refers to any person, living organism or object which is to be protected from various EM waves as will be defined in detail below. In one example, the “target” may be an user of a device such as a hair drying system, e.g., for drying or otherwise treating his, her or another person's hair or for other purposes. In another example, the “target” may be a subject who may be treated by such an user with the device. In yet another example, the “target” may be a person sitting or standing within a preset distance from or around the device. In yet another example, the “target” may be such a device itself as well. In any of these example except the last one, the “target” is subject to magnetic as well as electric waves irradiated by various wave sources of the device through, e.g., an air outlet of the device, a side and/or a rear of the device in which such sources may be incorporated.

As used herein, the term “extrinsic electromagnetic waves” refer to those waves propagating in space toward the above target, while the term “device electromagnetic waves” mean those waves which are generated by the above device and propagate toward the above target. Therefore, when the target is the user or person, such “extrinsic EM waves” are those originating from a source away from the target and propagating toward such a target as well as those generated by the above device which may be disposed around or within the preset distance from the target. However, when such a target is the device, such “extrinsic EM waves” include those originating from a source away from the target and propagating toward the target as well as those generated by other devices which may be disposed around and/or within the preset distance from the target device.

The terms “magnetic fields” and “magnetic waves” within the scope of this invention refer to those which are associated with various electromagnetic waves. Therefore, such “magnetic fields” are accompanied by matching electric fields, while such “magnetic waves” are also accompanied by matching electric waves. Only exceptions are the static magnetic fields which are not accompanied by the electric fields, where examples of such static magnetic fields are those generated by the Earth, permanent magnet of the magnet member, and the like. It is appreciated for simplicity of illustration that the “magnetic waves” or “MWs” may collectively include the “magnetic fields” or “MFs” therein and that the “electric waves” or “EWs” may collectively include the “electric fields” or “EFs” therein within the scope of the present invention.

As used herein, the term “terminate” means preventing propagation of the magnetic fields and waves. Therefore, “terminating” the magnetic fields and waves by a magnetic pole means absorbing such magnetic fields and waves into the magnetic pole and then preventing such magnetic fields and waves from propagating away from a permanent magnet and/or electromagnet which may include the magnetic pole.

Within the scope of the present invention, the term “wire” collectively refers to a wire, filament, fiber, rod, strand, and/or any other similar elongated shapes of articles each of which may be straight and/or curved (i.e., curvilinear), and each of which may also be arranged in a loop, a coil, a roll, and the like. The term “strip” collectively refers to a strip, bar, pad, tape, and any other planar articles with large aspect ratios (i.e., ratios of lengths to widths or heights) each of which may be straight and/or curved, each of which may be arranged in a two- or three-dimensional configuration, each of which may also be arranged in a loop, a coil, a roll, and so on. In addition, the term “sheet” collectively refers to a sheet, a slab, a foil, a film, a plate, a layer, and any other planar articles which may be relatively wider than the “strip,” each of which may be planar (i.e., two-dimensional) and/or curved (i.e., three-dimensional), each of which may also be arranged in a segment, a roll, and the like. The terms “braid” and “braided article” collectively refer to any elongated article which is braided in such a manner that the “braid” or “braided article” consists of at least two “wires” or “strips” in a cross-section normal to a longitudinal axis of the “braid” or “braided article,” where examples of such articles may include, but not be limited to, a thread, a yarn, any other articles made by conventional “braid” techniques, and the like. The term “mesh” also collectively refers to a mesh, a net, a screen, a quilt, a fabric, a garment, any other articles in a networking, woven, and/or interwoven structure. It is to be understood that at least a portion of each of such articles formed according to the foregoing terms in this paragraph may be arranged to be solid, hollow or porous such as, e.g., a foam, a sponge, and so on. It is also to be understood that each of such articles formed according to the foregoing terms of this paragraph may be arranged to include (or define) at least one hole, gap or opening.

Similarly and as used herein, the term “mixture” collectively refers to a liquid, a solution, a sol, a gel, an emulsion, a suspension, a slurry, and/or a powder, each of which may include therein multiple particles, particulates, grains, granules, filings, fragments, and/or pellets each of which may also have shapes of spheres, ellipsoids, cylinders, flakes, “wires,” “strips,” and the like, and each of which may be in a range of millimeters, microns or nanometers. When appropriate, such a “mixture” may include at least one solvent, at least one chemically, electrically, and/or magnetically inert filler for the purpose of providing mechanical strength and/or integrity thereto, and so on.

As used herein, the term “distance” is to be differentiated from the term “length” in the sense that the “distance” between two points of an object is to be measured along a straight path regardless of a detailed configuration of the object, whereas the “length” or “curvilinear length” is to be measured along an actual curvilinear configuration of such an object. Accordingly, the “distance” between two points disposed on opposing ends of an equator of a spherical object is a diameter of such a sphere, whereas the “length” between the points corresponds to one half of the equator of the same sphere. Similarly, the “distance” between an inlet and an outlet of an U-shaped conduit is considerably smaller or less than the “length” of the conduit from the inlet to the outlet. Such terms “distance” and “length” are also applicable to refer to a dimension between two different objects.

As used herein, the term “line of sight” between two objects represents a straight line which connects such objects. The “line of sight” between these objects is then referred to be “prevented” or “blocked” when another object is to be disposed along such a line. Similarly, the term “line of sight for magnetic or electric waves” between two objects is defined as a straight line which connects the objects. Such electromagnetic waves, however, may penetrate various objects, unless such objects may exhibit certain magnetic and/or electric properties. Accordingly, the “line of sight for magnetic or electric waves” is deemed to be “prevented,” “blocked” or “suppressed” when a third object is to be disposed along such a line and such a third object exhibits certain magnetic or electric properties for completely or at least partially preventing, blocking or suppressing such magnetic or electric waves from penetrating the third object, respectively.

As used herein, a “magnetic shield” or “MS” includes at least one path member for absorbing magnetic waves propagating thereonto. Such a “magnetic shield” may optionally include at least one magnet member, which connotes that such a “magnetic shield” for various hair drying systems of the present invention may not include any magnet member when desirable. Further details of the path and magnet members have been provided in greater detail in the co-pending Applications.

The terms “proximal” and “distal” are generally used to refer to relative locations of various members and units of the system with respect to an air inlet and an air outlet of the conduit member so that “proximal” means closer to the air inlet and that “distal” means closer to the air outlet.

As used herein, a typical hair drying system may include at least one conduit member, at least one actuator member, and at least one heating member, where such a conduit member may include at least one conduit (or air path) defined between at least one air inlet and at least one air outlet. Such a system may also include an optional counter member. Each of the members may also include multiple units which may have different physical configurations, may be disposed in different orientations, may operate in different mechanisms or may move between different states, and the like.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWING

FIGS. 1A to 1I are cross-sectional views of exemplary hair drying systems each with at least one actuator member and at least one heating member according to the present invention;

FIGS. 2A to 2H are schematic views of exemplary conduits according to the present invention;

FIGS. 3A to 3X are schematic views of exemplary baffles according to the present invention;

FIGS. 4A to 4F are cross-sectional views of exemplary conduits having at least one mobile unit according to the present invention;

FIGS. 5A to 5T are cross-sectional views of exemplary body members including at least one mobile unit and/or section according to the present invention;

FIGS. 6A to 6L are cross-sectional views of exemplary actuator members disposed in various positions according to the present invention;

FIGS. 7A to 7H are cross-sectional views of exemplary hair drying systems each with at least one hand unit and at least one base unit according to the present invention; and

FIGS. 8A to 8D are cross-sectional views of exemplary hair drying systems each incorporated with a stationary object according to the present invention.

### DETAILED DESCRIPTION OF THE PREFERRED EMBODIMENTS

The present invention generally relates to electromagnetically-shielded hair drying systems for drying or dehumidifying hair. More particularly, the present invention relates to hair drying systems for preventing or at least minimizing electromagnetic waves emitted by actuator and heating members of the system from propagating to a target using various modalities. The system may incorporate at least one magnetic shield and/or electric shield between such members and target so as to prevent at least portions of such waves from reaching the target. Such a system may include at least one mobile unit which may move one of such members toward and away from an air outlet thereof, thereby varying distances from the members to the target and dispersing more of such waves away from the target. Such a system may also be arranged to generate counter electromagnetic waves which may cancel at least portions of the waves emitted by the actuator and heating members. A separate article with or without such shields may also be provided to couple with the air outlet and/or to be disposed on an exterior of the system for the above purposes. In addition, the system may include at least one hand unit and at least one base unit, where the air outlet may be defined in the hand unit and where at least one of the actuator and heating members may be incorporated into the base unit. Moreover, the hand and base units may be fluidly coupled to each other by at least one conduit member with at least one conduit (or air path) which may also be optionally incorporated into a stationary article.

The present invention also relates to various methods of preventing or minimizing such waves irradiated by such members of the system from propagating toward the target. More particularly, the methods may include various steps of blocking a line of sight from the air outlet and at least one wave source of the system, dispersing more of the waves by increasing the distance between the air outlet and the wave source, canceling at least portions of the waves emitted by such sources, generating counter waves which may cancel at least portions of such waves emitted by such sources, and the like. The present invention further relates to various methods of minimizing such waves propagating through the air outlet by incorporating the air outlet and at least one wave source into different units and then spacing such units apart from each other, incorporating at least a portion of the conduit (or air path) into a stationary article and coupling such units with the incorporated portion of the conduit (or air path), and so on.

The present invention further relates to various processes for making such a system, forming various conduits (or air paths) with or without any baffles or bends, forming mobile members and/or units thereof, providing various magnetic and electric shields for such members and/or units of such a system, fabricating assemblies of such actuator and heating members capable of canceling at least portions of the waves emitted thereby, making various counter members capable of canceling at least portions of the waves irradiated by such actuator and heating members, fabricating separate articles capable of blocking and/or dispersing at least portions of such waves from the target, and the like. In addition, the present invention relates to various processes for providing at least one hand unit and at least one base unit movably coupling with each other, fixedly or releasably incorporating the actuator and/or heating members into the base unit, reducing a weight and/or volume of the hand unit, and the like.

Various aspects and/or embodiments of various systems, methods, and/or processes of this invention will now be described more particularly with reference to the accompanying drawings and text, where such aspects and/or embodiments thereof only represent different forms. Such systems, methods, and/or processes of this invention, however, may also be embodied in many other different forms and, accordingly, should not be limited to such aspects and/or embodiments which are set forth herein. Rather, various exemplary aspects and/or embodiments described herein are provided so that this disclosure will be thorough and complete, and fully convey the scope of the present invention to one of ordinary skill in the relevant art.

Unless otherwise specified, it is to be understood that various members, units, elements, and parts of various systems of the present invention are not typically drawn to scales and/or proportions for ease of illustration. It is also to be understood that such members, units, elements, and/or parts of various systems of this invention designated by the same numerals may typically represent the same, similar, and/or functionally equivalent members, units, elements, and/or parts thereof, respectively.

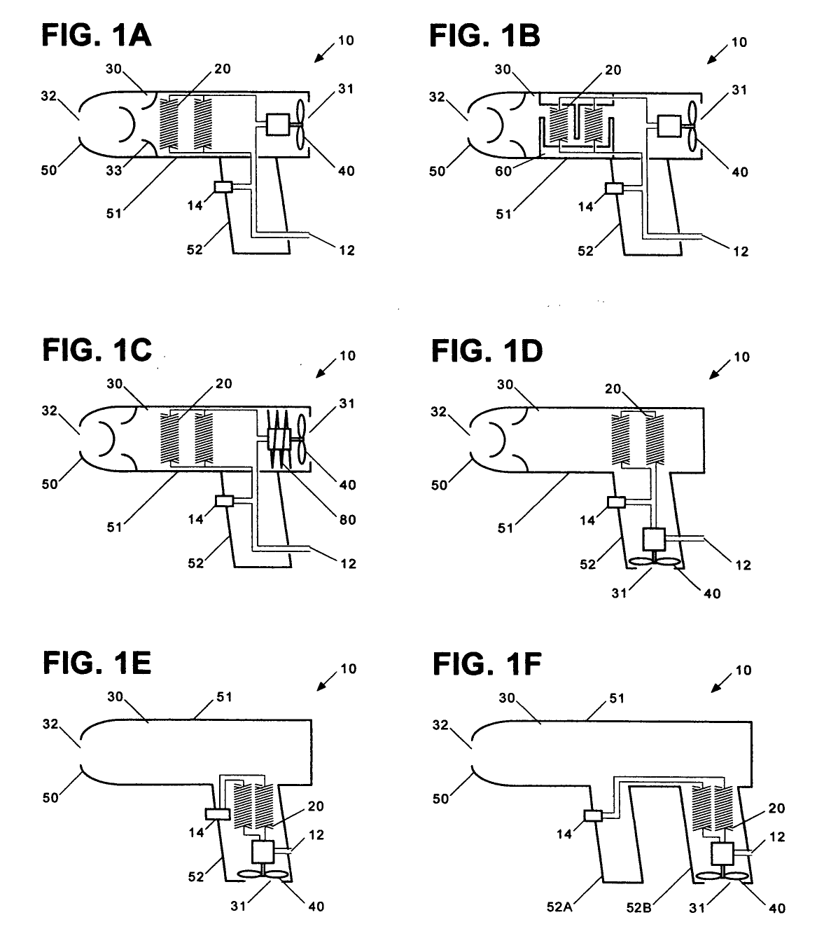

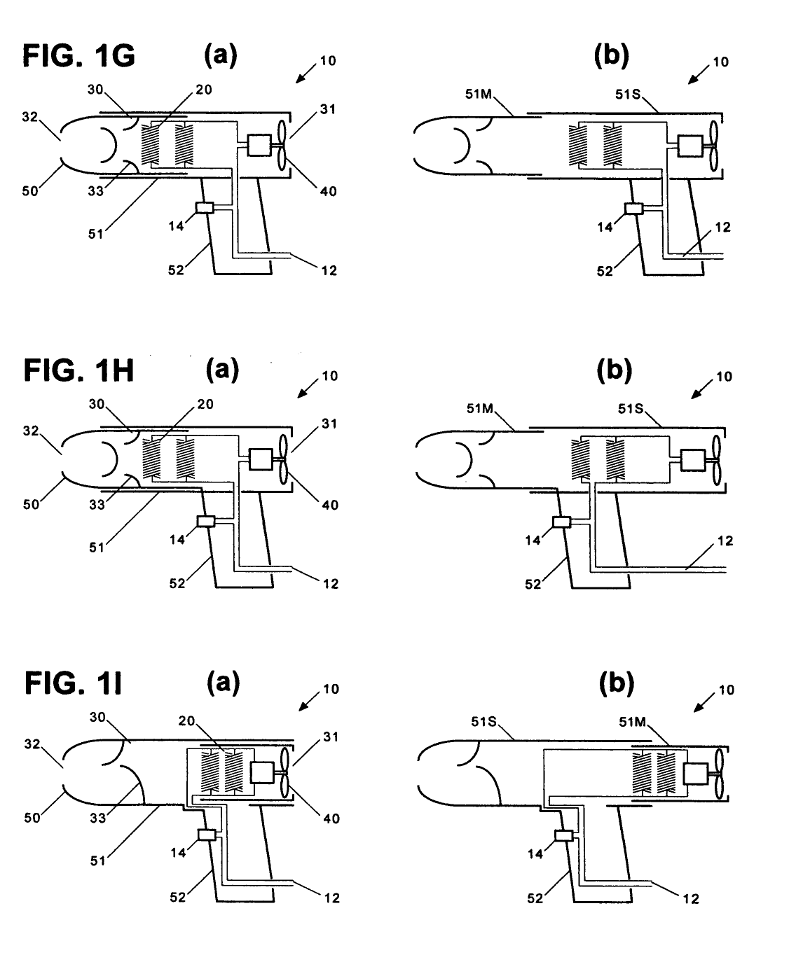

In one aspect of the present invention, hair drying systems may be constructed to prevent (or to at least minimize) magnetic waves (to be abbreviated as “MWs” hereinafter) and/or electric waves (to be abbreviated as “EWs” hereinafter) of electromagnetic waves (to be abbreviated as “EM waves” hereinafter) irradiated from various sources thereof. FIGS. 1A to 1I describe cross-sectional views of exemplary hair drying systems each including at least one actuator member and at least one heating member according to the present invention.

In one exemplary embodiment of this aspect of the invention and as depicted in FIG. 1A, a hair drying system 10 typically includes at least one heating member 20, at least one conduit member 30, at least one actuator member 40, and at least one body member 50. The body member 50 defines a first elongated unit 51 and a second unit 52. The first unit 51 forms two openings in its opposing ends, and the second unit 52 couples with a middle portion of the first unit 51 transversely or at a preset angle. A power cable 12 runs through the second unit 52, couples with a switch 14 which is also provided in the same unit 52, and then runs into the first unit 51. The heating member 20 typically includes one or more heating elements which are made of resistive wires wound into coils such as, e.g., solenoids or toroids. The heating member 20 is connected to the cable 12 and also disposed in the second unit 52. In general, any conventional resistive materials may be used to form the heating element 20. The conduit member 30 is disposed in the second unit 52 and includes an elongated conduit terminating in an air inlet 31 and an air outlet 32. The conduit member 30 of the example is arranged to conform to an interior of the first unit 51 such that its conduit is typically parallel to the first unit 51, and its air inlet 31 and air outlet 32 align with such openings of the first unit 51. The conduit member 30 also includes one or more baffles 33 which are disposed in preset locations and arrangement along its conduit. The actuator member 40 is disposed in the conduit and adjacent to the air inlet 31 and arranged to move air through the conduit member 30.

Still referring to the system 10 of FIG. 1A, the baffles 33 are arcuately shaped and disposed in an orientation for reducing hydraulic resistance when air flows from the air inlet 31 to the air outlet 32. Accordingly, such baffles 33 are convex downwardly along a direction from the air inlet 31 to the air outlet 32. In addition, such baffles 33 are preferably shaped and/or sized enough to obstruct an entire or at least a substantial portion of a cross-section of the conduit when projected upon such a cross-section. In this example, the conduit member 30 consists of a distal center baffle obstructing a center portion of the cross-section and one or more proximal side baffles obstructing peripheral portions of the cross-section. In addition, the center and side baffles are arranged to overlap at least portions of each other and, accordingly, the baffles 33 obstruct the entire cross-section of the conduit. Because the baffles 33 are disposed in different locations along a longitudinal axis of the conduit, however, the air may flow through the conduit distally, i.e., from the air inlet 31 to the air outlet 32.

Such a baffle arrangement described in the preceding paragraph may offer an advantage of preventing formation of a line of sight between the air outlet 32 and wave sources of the system 10 such as its heating and actuator members 20, 40. In other words, an user will not be able to see any portion of such members 20, 40 as he or she looks into an interior of the conduit through the air outlet 32. When incorporated with various magnetic and/or electric shields (i.e., MS's and/or ES's ) as have been described in the co-pending Applications, such baffles 33 ensure to not only prevent formation of the line of sight between the air outlet 32 and waves sources 20, 40 to but also prevent formation of a line of sight for such magnetic and/or electric waves (i.e., MWs and/or EWs), thereby preventing or at least minimizing propagation of such MWs and/or EWs toward the target.

In operation, the conduit member 30 is formed by providing the air inlet and air outlet 31, 32 and disposing such 31, 32 on opposing ends of the conduit of a preset length. The heating member 20 is then disposed inside the conduit, and the actuator member 40 is incorporated proximal (or distal) to the heating member 20 in an arrangement for taking in air through the air inlet 31. Based on the location of the wave sources such as the heating and actuator members 20, 40, a preset number of baffles 33 may be incorporated along the conduit, typically distal to such sources 20, 40. It is preferred that the baffles 33 be shaped, sized, and oriented enough to prevent (or at least suppress) formation of the physical line of sight as well as the line of sight for the MWs and/or EWs generated by such sources 20, 40. One or more MS's and/or ES's may be incorporated over, under, and/or inside the baffles 33 and/or may be disposed in preset locations of the conduit for preventing or minimizing propagation of the MWs and/or EWs therethrough. The conduit member 30 with such baffles 33 and wave sources 20, 40 is inserted into the first unit 51 which in turn couples with the second unit 52 at a preset angle, thereby forming the body member 50. The cable 12 is also disposed inside the body member 50 so as to supply electric current from a power source (not shown in the figure) to the wave sources 20, 40, and the switch 14 is installed in a circuit to turn on and off such wave sources 20, 40. After the hair drying system 10 is assembled, the switch is 14 closed, and the current is supplied to the heating and actuator members 20,40. The actuator member 40 then takes the air into the conduit and moves such air distally, thereby creating a flow of air. As the air passes through the heating member 20, such air absorbs thermal energy or heat generated by the heating member 20 and forms a flow of heated air. The heated air then moves distally and is finally discharged through the air outlet 32. During operation, the heating and actuator members 20, 40 emit such MWs and/or EWs. Due to such MS's and/or ES's incorporated into the conduit member 30, however, the hair drying system 10 may prevent or at least suppress the MWs and/or EWs from penetrating through the MS's and/or ES's and toward the target.

It is appreciated that overlapping the above baffles 33 may not necessarily prevent formation of such lines of sight. Depending upon their exact locations, the wave sources 30, 40 may be able to find the line of sight through the overlapping baffles. Conversely, the above lines of sight may also be completely prevented without having to completely obstruct the cross-section of the conduit by such baffles 33. When the conduit member 30 includes multiple baffles 33, a different combination or set of baffles 33 may be recruited to prevent the formation of different lines of sight. Therefore, the shapes and/or sizes of such baffles 33 and an extent of overlapping therebetween may be determined based upon the exact location of the wave sources 30, 40, their shapes and/or sizes, the number of baffles 33 to be incorporated and/or recruited, and the like.

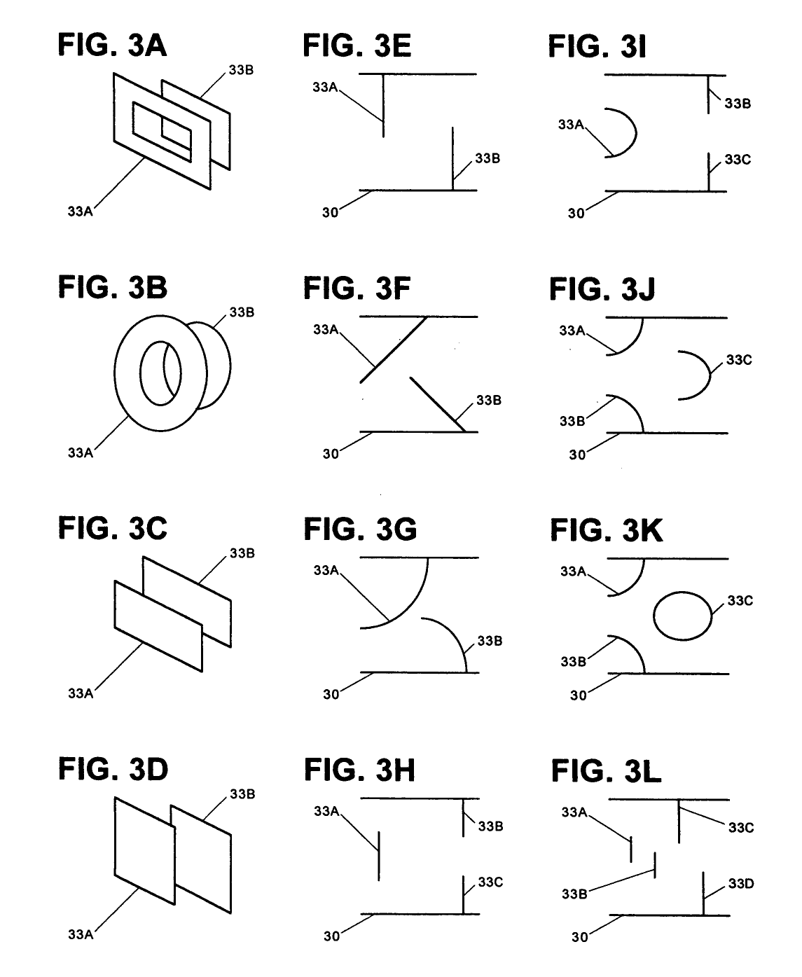

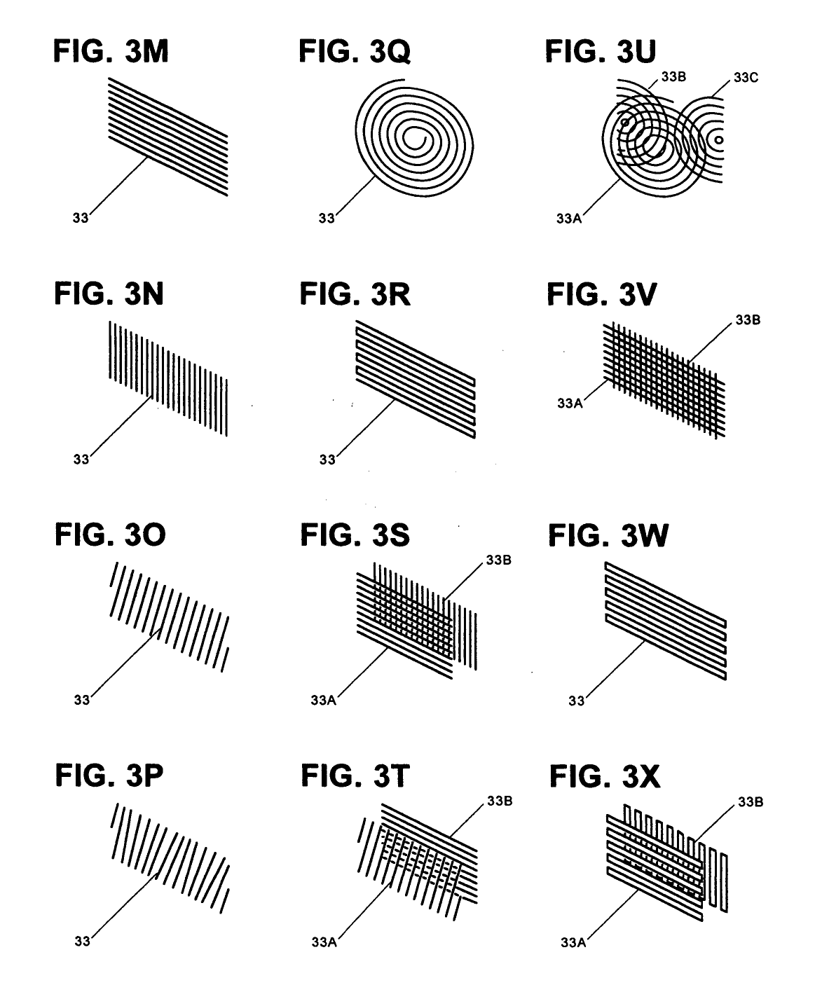

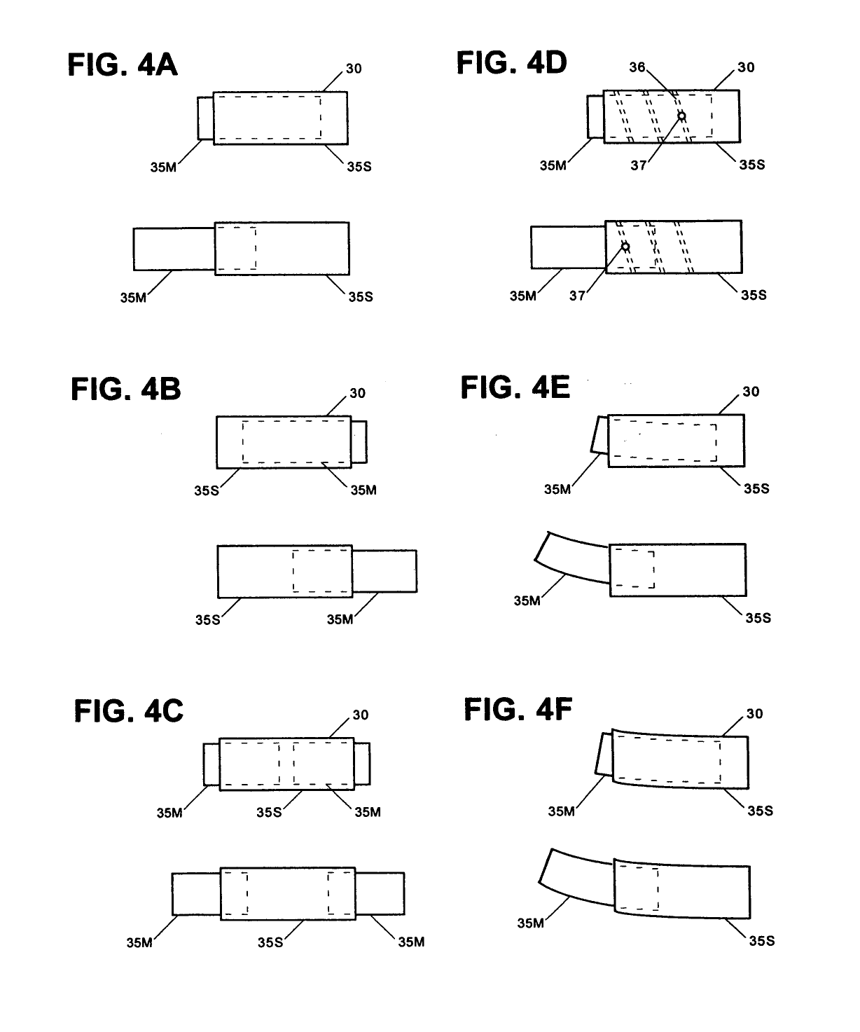

It is also appreciated that such lines of sight may also be prevented or minimized by bending at least a portion of the conduit about one or more bending points or bends. For example, any portion of the conduit may be bent about the bend, e.g., at a preset acute or obtuse angle excluding 0° and 180°, and the physical line of sight between the air outlet 32 and wave sources 20, 40 may be prevented or minimized. By incorporating the above MS and/or ES, the line of sight for the MWs and/or EWs may be prevented or suppressed. The location of the bend, number of bends, and their bending angles may also be selected depending upon other factors such as, e.g., shapes, sizes, and/or locations of such waves sources 20, 40. Further details of such baffles and/or bends are to be provided in conjunction with FIGS. 3A to 3X and FIGS. 4A to 4H, respectively.

In another exemplary embodiment of this aspect of the invention and as depicted in FIG. 1B, a hair drying system 10 also includes at least one heating member 20, at least one conduit member 30, at least one actuator member 40, and at least one body member 50, where the heating, actuator, and body members 20, 40, 50 are similar or identical to those of FIG. 1A. Unlike its counterpart of FIG. 1A, the conduit member 30 further includes a heat exchange member 60 between its air inlet 31 and outlet 32 in a series arrangement so that a proximal portion of the conduit, heat exchange member, and distal portion of the conduit are connected in series. Such a heat exchange member 60 defines at least one air path therein which is arranged in such a way that a total “length” of the air path of such a member 60 is longer than a “distance” of such a member 60 measured along a longitudinal axis of the conduit. In this example, the heat exchange member 60 defines a single air path arranged in a zigzag pattern or in a U-shape. At least a (or entire) portion of the heating member 20 is disposed along the air path so as to transfer its heat onto the air flowing through the heat exchange member 60. Incorporating such a heat exchange member 60 along the conduit offers the advantage of increasing an effective length of such a conduit through which the heating element 20 and air may exchange heat, while maintaining an overall length of the conduit within a manageable value. Such a system 10 may also incorporate at least one MS and/or ES in at least one strategic location thereof in order to prevent or at least minimize propagation of the MWs and/or EWs through the air outlet 32 and/or through other portions of such a system 10, e.g., through sides of the conduit. Other configurational and/or operational characteristics of the system 10 of FIG. 1B are similar or identical to those of FIG. 1A.

In another exemplary embodiment of this aspect of the invention and as depicted in FIG. 1C, a hair drying system 10 similarly includes at least one heating member 20, at least one conduit member 30, at least one actuator member 40, and at least one body member 50, all of which may be similar or identical to those of FIG. 1A. However, the system 10 further includes at least one counter member 80 which is disposed around an exterior, interior or inside of at least a portion of one or more wave sources 20, 40 of the system 10. A main function of the counter member 80 is to irradiate EM waves which may cancel at least a portion of the EM waves irradiated by either or both of the wave sources 20, 40. In this example, the counter member 80 consists of a conductive wire which forms a shape of a helical coil wound around the exterior of the actuator member 40. Accordingly, the counter member 80 will be effective to cancel or weaken the EM waves emitted by the actuator member 40 but not be able to cancel a greater portion of the EM waves from the heating member 20.

It is appreciated that the counter member 80 may be incorporated in a variety of arrangements to cancel the EM waves from the sources 20, 40. In general, main factors to consider in designing the counter member 80 are orientation of conductors of the member 80 and a direction of current flowing through the member 80. In one embodiment, the counter member 80 may be oriented (e.g., extended, wound, and the like) in the same pattern as at least one wave source but the electric current flows in the counter member 80 and wave source in opposite directions such that the counter member 80 and the wave source may emit the EM waves which propagate forwardly while fluctuating along opposite directions both of which are also normal to the forward direction of propagation, thereby canceling at least portions of the first of such EM waves by at least portions of the second of the EM waves. For example, the heating member 20 includes the resistive coil wound in a clockwise direction, while the counter member 80 includes another coil having a larger radius of winding, wound in the clockwise direction, and disposed around such a heating member 30. When the current flows, e.g., from left to right in the heating member 20 but from right to left in the counter member 80, at least portions of such EM waves emitted by the heating and counter members 20, 80 may be able to cancel each other. For simplicity of illustration, these mutually canceling EM waves will be referred to “propagate in opposite directions,” while the conductors of the counter member 80 and wave source will be referred to be “oriented in the same pattern” hereinafter. Conversely, the counter member 80 may be oriented in a pattern opposite to that of at least one wave source but the current flows in the counter member 80 and wave source in the same directions such that the counter member 80 and the wave source may again emit such EM waves which propagate forwardly while fluctuating in opposite directions both of which are perpendicular to the forward direction of propagation, thereby canceling at least portions of the first of such EM waves by at least portions of the second of such EM waves. For example, such a heating member 20 includes the resistive coil wound along a clockwise direction, while the counter member 80 includes another coil having a larger radius of winding, wound along a counterclockwise direction, and disposed around the heating member 30. When the current flows, e.g., from left to right through both of the heating and counter members 20, 80, at least portions of the EM waves emitted by such members 20, 80 may cancel each other. For simplicity of illustration, such mutually canceling EM waves will be again referred to “propagate in opposite directions,” and the conductors of the counter member 80 and wave source will be referred to be “oriented in the opposite patterns” hereinafter. In addition, one of such EM waves which may be able to cancel at least portions of the other of such EM waves will be occasionally referred to as “counter EM waves” hereinafter.

Depending upon configuration and disposition of various conductors, such wave sources 20, 40 may irradiate the EM waves originating from a point source, not a planar source. Accordingly, it is expected that generating the counter EM waves which may match the direction of the propagation of the EM waves from the point source may be fairly complicated. In such a case, the counter member 80 is preferably constructed and disposed in order to match the direction of the EM waves emitted by such heating and actuator members 20, 40 as much as possible. Accordingly, the conductors of the counter member 80 may be disposed in a direction which may be at least partially same or opposite to the direction of the conductors of the wave sources 20, 40 so that the counter waves may propagate along a direction which is at least partially opposite to the direction of the EM waves from the sources 20, 40. It is appreciated that the heating and/or actuator members 20,40 may include an extra portion of an electric conductor which may be disposed around the same or different members 20, 40 so as to generate the counter waves, thereby serving as the counter member 80. In this embodiment, such an extra portion of the conductor (or extra conductor) may exhibit electrical properties different from the rest of the members 20, 40. For example, the extra conductor of the heating member 20 may not necessarily have to generate the same or similar amount of heat as the same current flows therein. Similarly, the extra conductor of the actuator member 40 may neither necessarily have to generate the same or similar magnetic fields therearound as the same current flows therein. It is also appreciated that electrical cables or cords of the system 10 which are not parts of and/or which may be involved with normal operation of the heating and actuator members 20, 40 may serve as the counter member 80 as well. For example, the cable may be disposed around at least one of the wave sources 20, 40 so as to generate the counter waves. Other configurational and/or operational characteristics of the system 10 of FIG. 1C are similar or identical to those of FIGS. 1A and 1B.

In another exemplary embodiment of this aspect of the invention and as depicted in FIG. 1D, a hair drying system 10 similarly includes at least one heating member 20, at least one conduit member 30, at least one actuator member 40, and at least one body member 50, where the heating and body members 20, 50 are generally similar or identical to those of FIG. 1A. The actuator member 40 of such an embodiment is disposed in the second transverse unit 52 of the body member 50, while the conduit member 30 defines the air inlet 31 in a bottom of the second unit 52, while extending its conduit from the air outlet 31 in a distal end of the first unit 51 to such an air inlet 32 of the second unit 52. Such an embodiment is advantageous in that the actuator member 40 which may irradiate more EM waves than the heating member 20 may be removed from the elongated first unit 51 to a more remote second unit 52. In a related embodiment and as described in FIG. 1E, not only the actuator member 40 but also the heating member 20 is disposed in the second transverse unit 52 such that all major wave sources 20, 40 may also be removed from the elongated first unit 51 to the remote second unit 52. It is appreciated that these embodiments may require at least one MS and/or ES in order to prevent or at least minimize the MWs and/or EWs emitted by the wave sources 20, 40 from penetrating the second unit 52 toward a hand of the user. In another related embodiment and as described in FIG. 1F, such a body member 50 defines two second transverse units such as a distal second unit 52A and a proximal second unit 52B, where the proximal second unit 52B may include both wave sources 20, 40 and where the distal second unit 52A may include the switch 14 therein and, therefore, may be used as a grip unit. Similar to those of FIGS. 1D and 1E, at least one MS and/or ES may have to be incorporated into the proximal and/or distal second units 52B, 52A for protecting the hand of the user. Other configurational and/or operational characteristics of the systems 10 of FIGS. 1D to 1F are similar or identical to those of FIGS. 1A to 1C.

In another exemplary embodiment of this aspect of the invention and as depicted in FIG. 1G, a hair drying system 10 also includes at least one heating member 20, at least one conduit member 30, at least one actuator member 40, and at least one body member 50, in which the heating, conduit, and actuator members 20, 30, 40 are similar or identical to those of FIG. 1A. Similar to that of FIG. 1A, the body member 50 includes a first elongated unit 51 and a second unit 52 which is transversely coupled to the first unit 51. Unlike its counterpart, the first unit 51 further includes a stationary section 51S and a mobile section 51M which may be arranged to translate, rotate, and/or otherwise more with respect to the stationary section 51S between its off-state and on-state. The conduit member 30 is distributed into both sections 51M, 51S of such a first unit 51. For example, the air inlet 31 is defined in a proximal end of the stationary section 51S, the conduit is defined along the mobile and stationary section 51M, 51, and the air outlet 32 is formed in a distal end of the mobile section 51M. The heating and actuator members 20, 40 are fixedly disposed in the stationary section 51S. As the mobile section 51M moves between its off- and on-states, the air outlet 32 also moves closer to [see panel (a)] and away from the air inlet 31 [see panel (b)], thereby varying a distance therebetween. The system 10 with such an mobile arrangement offers the benefit of increasing the distance between the air outlet 32 and wave sources of the EM waves 20, 40 in the on-state, thereby dispersing more of such EM waves from the target and, therefore, decreasing an amount of the MWs and EWs propagating to the target.

In operation, the mobile section 51M of the first unit 51 may be provided by defining the conduit and forming the air outlet 32 in its distal end. The stationary section 51S of the first unit 51 is formed by defining another conduit which is shaped and sized to releasably receive the proximal end of the mobile unit 51M. The heating member 20 is disposed inside the stationary unit 51S, and the actuator member 40 is incorporated proximal (or distal) to the heating member 20 in an arrangement to take in air through the air inlet 31. Based upon such locations of the heating and actuator members 20, 40, a preset number of baffles 33 may be incorporated along the conduit, typically distal to the sources 20, 40. The MS and/or ES may further be installed over, under, and/or inside the baffles 33 and/or may be disposed in preset locations of the conduit. The cable 12 is also disposed inside the body member 50 so as to supply electric current from a power source (not shown in the figure) to the wave sources 20, 40, and the switch 14 is installed as described above. Thereafter, the second unit 52 is coupled to the first unit 51, and the mobile section 51M is also movably inserted into the stationary section 51S. When assembled, the system 10 is generally in its off-state as described in the panel (a). When the user intends to use the system 10, he or she may first move the mobile section 51M to its on-state as described in the panel (b). Alternatively, the mobile section 51M may automatically move to its on-state when the switch is 14 closed. As the current is supplied to the heating and actuator members 20, 40, the actuator member 40 takes the air into the conduit and moves air distally, thereby creating a flow of air. As the air passes through the heating member 20, it absorbs thermal energy or heat generated by the heating member 20 and forms a flow of heated air. Such heated air moves further distally and is finally discharged through the air outlet 32. During operation, the heating and actuator members 20, 40 emit such MWs and/or EWs. However, because of the increased distance between the air outlet 32 and such sources 20, 40 in the on-state, the MWs and/or EWs tend to be dispersed and, accordingly, a less amount of such waves may be emitted through the air outlet 32. In addition, such MS and/or ES incorporated into various members and/or units of the system 10 may also prevent or at least minimize such waves from penetrating through the MS and/or ES and toward the target. Other configurational and/or operational characteristics of the system 10 of FIG. 1G are similar or identical to those of FIGS. 1A to 1F.

In another exemplary embodiment of this aspect of the invention and as depicted in FIG. 1H, a hair drying system 10 similarly includes at least one heating member 20, conduit member 30, actuator member 40, and body member 50, all of which are similar or identical to those shown in FIG. 1G. For example, the body member 50 includes the first elongated unit 51 and second transverse unit 52, and the first unit 51 includes the stationary section 51S and mobile section 51M which moves between its off-state and on-state. Accordingly, the system 10 in its off-state [see panel (a)] has a configuration similar or identical to that of FIG. 1G. The second unit 52 of the system 10, however, couples with the mobile section 51M and translates distally toward its on-state. Therefore, as the mobile section 51M moves from its off-state to its on-state, the air outlet 32 also moves away from the air inlet 31, thereby increasing a distance therebetween. Because the second unit 52 moves with the mobile section 51M, the same distance may be maintained between the air outlet 32 and second unit 52. The system 10 of this embodiment offers the same advantage of increasing the distance between the air outlet 32 and wave sources of the EM waves 20, 40 in the on-state, thereby dispersing more of such EM waves from the target and decreasing the amount of the MWs and EWs propagating toward the target. Other configurational and/or operational characteristics of the system 10 of FIG. 1H are similar or identical to those of FIGS. 1A to 1G.

In another exemplary embodiment of this aspect of the invention and as depicted in FIG. 1I, a hair drying system 10 includes at least one heating member 20, conduit member 30, actuator member 40, and body member 50, all of which are similar or identical to those of FIG. 1G. Unlike its counterpart of FIG. 1G, the first unit 51 defines a distal stationary section 51S and a proximal mobile section 51M, and the second unit 51 is coupled to the stationary section 51S. In addition, the heating and actuator members 20, 40 are disposed in the mobile section 51M and moves along therewith between the off-state [see panel (a)] and on-state [see panel (b)]. Accordingly, the system of this embodiment offers the similar benefit as has been described in conjunction with FIGS. 1G and 1H. Other configurational and/or operational characteristics of the system 10 of FIG. 1I are similar or identical to those of FIGS. 1A to 1H.

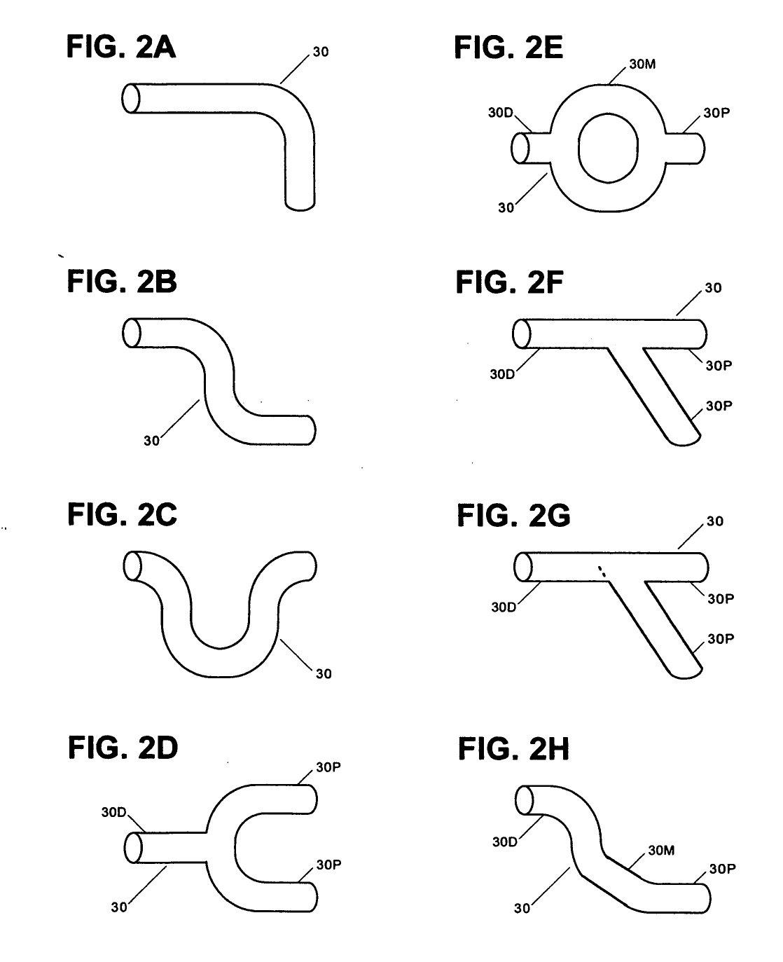

In another aspect of the present invention, the conduit member may be fabricated to include at least one conduit therealong, at least one air inlet in one end of the conduit, and at least one air outlet in the other end thereof. FIGS. 2A to 2H are schematic views of exemplary conduits according to the present invention. In general, the conduit member is disposed inside the body member which will be described in greater detail below. However, at least a portion of such a conduit member, in particular, its conduit, may be exposed and form at least a portion of the body member. When desirable, such a conduit member may constitute at least a portion or an entire portion of the first and/or second units of the body member. Accordingly, each of the following figures may be deemed as schematic views of the conduit and/or body members. It is appreciated that each of the following figures represents only a portion of various conduit and/or body members and that various air inlets and outlets of the conduit members are omitted therefrom.

In one exemplary embodiment of this aspect of the invention and as exemplified in FIGS. 2A to 2C, a conduit member includes a single curvilinear conduit which terminates at two opposing ends. In one example and as described in FIGS. 1A to 1C and 1G to 1I, the conduit member includes a straight conduit terminating at the air inlet 31 and air outlet 32, in which the conduit may define a cross-section of various shapes. It is noted that the conduits of those figures have a planar structure and that such conduits may snugly fit into the elongated first unit 51 of the body member 50. In another example and as depicted in FIG. 2A, a conduit may define a curved structure with a bend around which a proximal portion and a distal portion of the conduit is bent at a preset angle. Such a conduit also forms a planar structure and may be suitable for the system including the air inlet 31 in the second transverse unit 52 of the body member 50. In another example and as depicted in FIG. 2C, a conduit may be bent around more than two bends, while defining another planar structure. The conduit of the figure has an U- or V-shape.

In another exemplary embodiment of this aspect of the invention and as exemplified in FIGS. 2D to 2G, a conduit member includes at least one junction in which two or more air paths may merge into a less number of air paths or in which a single air path may bifurcate into multiple air paths. In general, such a conduit member also defines the same number of ends as that of the air paths. In one example of FIG. 2D, a conduit has a pair of proximal (or distal) air paths 30P and a single distal (or proximal) air path 30D, where the proximal (or distal) air paths 30P merge (or bifurcate) into the distal (or proximal) air path 30D at a junction. Such proximal air paths 30P may define similar or identical shapes and/or sizes and may be disposed parallel to each other, thereby defining a shape of a capital letter “Y.” In another example of FIG. 2E, another conduit includes a single proximal air path 30P and a single distal air path 30D, where the proximal air path 30P bifurcates into a pair of middle air paths 30M which then merge into the distal air path 30D. Therefore, such a conduit may form an internal opening around the winding middle air paths 30M. In another example of FIG. 2F, a conduit is similar to that of FIG. 2D by defining a pair of proximal air paths 30P and a single distal air path 30D. However, one of the proximal air path may be coupled to the other thereof at a junction transversely or at a preset angle. In another example of FIG. 2H, a conduit is generally similar to that of FIG. 2F, except that at least a portion of the transverse proximal conduit 30P protrudes into a lumen of the conduit, thereby guiding the flow of air therethrough. It is appreciated that all of such conduits exemplified in these figures may be formed to be at least substantially planar.

In another exemplary embodiment of this aspect of the invention, a conduit member may define a non-planar structure, e.g., by forming at least two air paths which do not lie on a single plane. In the example of FIG. 2H, a conduit may include a proximal air path 30P, a middle air path 30M, and a distal air path 30D. The proximal air path 30P extends horizontally and couples with the middle air path 30M which is perpendicular to the proximal path 30P and extends into the paper. The distal air path 30D is also horizontal and couples with an opposing end of the middle air path 30M, thereby defining a non-planar structure.

In all of the above embodiments, at least one air inlet and/or outlet may be defined in each end of the air path. Accordingly, the conduit may define multiple air inlets and/or outlets therealong. When desirable, one of such conduits may couple with another thereof to form the conduit member defining a complicated network. The same conduit may also be repeated to form a complex conduit member.

Configurational and/or operational variations and/or modifications of the above embodiments of the exemplary systems and various modules thereof described in FIGS. 2A through 2H also fall within the scope of this invention.

Firstly, it is appreciated that detailed shapes, sizes, and/or dispositions of the conduit members are at least partially dependent upon various factors such as, e.g., shapes, sizes, and/or dispositions of the heating and/or actuator members, a desired direction of air flow, a desired air flow rate, and so on. In particular, such conduit members are preferably shaped and/or sized to obtain a maximum heat transfer efficiency of transferring the heat generated by the heating element to the flow of air through the conduit. Accordingly, detailed shapes, sizes, and/or dispositions of the conduit may be tailored for maximizing the efficiency of heat transfer. When the hair drying system includes the heat exchange member, the configuration of the conduit member may also have to be tailored accordingly.

In general, the conduit may extend in any length and may also include any number of air paths as long as the length and/or space of the body member allows. As described above, the conduit may define one or more straight and/or curved air paths. Depending upon the shape of the body member, the conduit may define the cross-section of any shapes and/or sizes, and may be bent at almost any angles to almost any curvature as long as the body member allows. The conduit may also define the cross-section which may also vary its shape, size, orientation, curvature, and/or number of air paths thereacross along the longitudinal axis of the conduit and/or body members.

As described above, such a conduit of the conduit member may include multiple sections or air paths each of which is capable of providing a path for air. Such air paths may merge into each other or at least one of such air paths may bifurcate into two or more air paths. The conduit with multiple air paths may be formed as an unitary article or, in the alterative, each air path may be assembled into the conduit.

A direction of air flow through a specific portion of such a conduit may be determined by many factors such as, e.g., the positions of the air inlet and outlet, the number of air paths included therein, and the like. Accordingly, the air may flow in a direction which may not coincide with a direction from the air inlet to the air outlet (to be referred to as the “forward” direction hereinafter) in such a portion of the conduit. When a portion of the conduit includes only one air path, the air flows in the forward direction. However, when such a portion includes two or three air paths arranged in a zigzag pattern or a reciprocating pattern, the air may flow in a retrograde direction in at least one of such air paths or may also flow in a radial or helical direction depending upon the curvature of such air paths. It is also appreciated that the conduit itself may be disposed transverse to the forward direction. Accordingly, the actual configuration of the conduit may not be a critical factor as long as the actuator member may transport the air from the air inlet to the air outlet at the desired flow rate. Such a conduit member may include at least one mobile unit which may move between at least two states with respect to at least one stationary unit thereof, details of which will be provided in conjunction with FIGS. 4A to 4F.

The conduit may also be arranged to define a tortuous shape so that a total curvilinear length of at least a portion its air path(s) is longer than a distance between opposing ends of such a portion. Such a configuration is beneficial in increasing an area of contact between the heating element and air flowing through the conduit, thereby increasing the efficiency of heat transfer therebetween.

In general, the conduit of the conduit member is disposed inside one or more units of the body member. Similarly, the air inlet and outlet of the conduit member may also be disposed inside the body member. As described above, however, at least a portion of the conduit of the conduit member may be exposed and form the exterior of the system, thereby serving as the body member. In addition, the air inlet and/or outlet may be exposed and serve as the openings therefor.

It is appreciated that the conduit having at least one bend may be utilized to prevent or at least minimize the formation of the physical line of sight between the air outlet and the wave sources of the system and may prevent or at least minimize the line of sight for the MWs and/or EWs when properly equipped with at least one MS and/or ES. To this end, the bending angle as well as disposition of the bend may be selected. The MS and/or ES may also be disposed in other locations in and around the conduit to prevent the MWs and/or EWs from propagating toward the hands or other body parts of the user.

As described herein, the intensity of the MWs and EWs decreases inversely proportional to a square of the distance from the wave sources. Thus, one way of attenuating the intensity of such waves is to provide a desired distance between the air outlet and wave sources of the system, and the length of the conduit may be determined accordingly. For example, the length of the conduit may be selected to ensure that the intensity of the magnetic fields measured at a preset distance from the air outlet is less than a preset limit. Examples of the preset limit may be set as an absolute value such as 0.1 mG, 0.2 mG, 3 mG, 0.5 mG, 0.7 mG, 1 mG, 2 mG, 3 mG, 4 mG, 5 mG, 7 mG, 10 mG, and so on, while the examples of the preset distance may be 0.1 cm, 0.2 cm, 0.5 cm, 1 cm, 2 cm, 3 cm, 5 cm, 7 cm, 10 cm, 15 cm, 20 cm, 25 cm, 30 cm, and so on. In the alternative, the length of the conduit may be selected to ensure that the intensity of the magnetic fields may be attenuated by a preset ratio when compared between a preset proximal position and a preset distal position. Examples of the proximal position may be an exterior of the wave source, a location spaced apart from the wave source by a preset distance, and so on, whereas examples of the distal position may be the air outlet, a location spaced apart from the air outlet by another preset distance, and the like. In addition, examples of the preset ratio which is a relative value may be 0.95, 0.9, 0.85, 0.8, 0.75, 0.7, 0.65, 0.6, 0.55, 0.5, 0.45, 0.4, 0.35, 0.3, 0.25, 0.2, 0.15, 0.1, 0.05, and the like.

In another aspect of the present invention, baffles having various shapes and/or sizes may be incorporated into various locations in, along or around the conduit member and/or body member of the hair drying systems. FIGS. 3A to 3L describe schematic views of exemplary baffles according to the present invention. Such systems typically include multiple baffles defining identical, similar or different shapes and/or sizes and also disposed along the same, adjacent or different locations with respect to longitudinal axes of their conduits and/or their diameters or other characteristic dimensions thereof. In addition, each of such baffles may be directly coupled to each other (detailed coupling modes and/or couplers are not shown in the figures) or, in the alterative, may couple with the conduit and/or body members, thereby maintaining its position with respect to the other baffle. For simplicity of illustration, an assembly of multiple baffles will be referred to as a “baffle assembly” or simply as an “assembly.” As described above, the main function of such a baffle assembly is to obstruct an entire portion of a cross-section of the conduit while allowing a flow of air through the conduit in order to prevent (or at least minimize) formation of the line of sight between the air outlet of the conduit member and one or more wave sources such as the heating and actuator members.

In one exemplary embodiment of this aspect of the invention, a baffle assembly may consist of two or more baffles one of which is configured to obstruct a peripheral portion of the cross-section of the conduit member and the other of which is configured to obstruct an inner portion of the cross-section thereof. In one example of FIG. 3A, a baffle assembly may include a pair of baffles 33A, 33B, one of which is a peripheral or outer baffle 33A and the other of which is a center or inner baffle 33B. Each baffle 33A, 33B defines a polygonal shape, where the outer baffle 33A forms an annular shape while defining an inner opening which also has a polygon shape, where such a polygon corresponds to a rectangle or square in this example. In addition, such baffles 33A, 33B are disposed in different locations along the longitudinal axis of the conduit and, therefore, the baffles 33A, 33B usually do not contact each other. It is appreciated that such baffles 33A, 33B are shaped and/or sized to overlap each other when projected onto the cross-section of the conduit. For example, the outer baffle 33A is arranged to fit into an interior of the conduit, while the inner baffle 33B is arranged to align with the opening of the outer baffle 33A and to completely cover the opening if disposed thereonto. Therefore, such an assembly is able to prevent the formation of the line of sight between the air outlet and one or more wave sources of the system. As described hereinabove, the wave sources may still be able to form the line of sight through overlapping baffles 33A, 33B, particularly when such sources lie off the longitudinal axis of the conduit. Accordingly, the shapes and/or sizes of the baffles 33A, 33B, angles in which such baffles 33A, 33B are disposed against the conduit, distances between the baffles 33A, 33B may be adjusted so as to prevent or suppress the formation of such a line of sight. For example, the line of sight may be better prevented when the baffles 33A, 33B overlap greater portions of each other, when such baffles 33A, 33B are disposed closer to each other, and the like, when other things being equal.

It is appreciated that the above assembly may be employed for only a partial obstruction of the cross-section of the conduit by various means. In one example, the inner baffle 33B may be smaller than the opening of the outer baffle 33A, thereby leaving a gap to form such a line of sight. In another example, the inner baffle 33B may be smaller than, as large as or bigger than the opening of the outer baffle 33B but disposed off from the opening, thereby forming the gap. In another example, the outer baffle 33A may be spaced apart from a conduit wall, thereby defining a gap therebetween.

In a related example of FIG. 3B, a baffle assembly is similar to that of FIG. 3A so that it includes an outer baffle 33A forming a center opening and an inner baffle 33B. However, the outer baffle 33A has a shape of a circle with a round opening therein, and the inner baffle 33B also defines a shape of another circle. Other configurational and/or operational characteristics of the baffles of FIG. 3B may be similar or identical to those of FIG. 3A.

In another exemplary embodiment of this aspect of the invention, a baffle assembly consists of two or more baffles at least one of which is configured to obstruct one side of such a cross-section of the conduit member and the other of which is configured to obstruct another side of such a cross-section thereof. In one example of FIG. 3A, a baffle assembly may include a pair of baffles 33A, 33B, one of which is coupled to a bottom of the conduit and extends upwardly therefrom, while the other of which is coupled to a top of the conduit and extends downward therefrom. Such baffles 33A, 33B are shaped and/or sized to overlap each other when projected onto the cross-section of the conduit or, in other words, a sum of heights of such baffles 33A, 33B is greater than a height of the conduit. Therefore, such an assembly is able to prevent the formation of the line of sight between the air outlet and the wave sources of the system. In a related example of FIG. 3D, a baffle assembly is generally similar to that shown in FIG. 3C, except that one baffle 33A is coupled to a left wall of the conduit and extends to the right, while the other baffle 33B is coupled to a right wall of the conduit and extends to the left, thereby preventing the formation of the line of sight. Other configurational and/or operational characteristics of the baffles of FIGS. 3C and 3D are similar or identical to those of FIGS. 3A and 3B.

In another exemplary embodiment of this aspect of the invention, a baffle assembly consists of two or more curvilinear baffles which may be coupled to different portions of the conduit member at a variety of angles. FIGS. 3E to 3G show cross-sectional views of such baffle assemblies according to the present invention. In one example of FIG. 3E, a baffle assembly may include two baffles 33A, 33B coupling at right angles with a top and a bottom of the conduit and spaced apart by a preset distance, while overlapping portions of each other. Such an example may correspond to that shown in FIG. 3C. In another example of FIG. 3F, a baffle assembly may include two baffles 33A, 33B which are similarly disposed along the conduit but coupled thereto at obtuse angles from right to left. Accordingly, such a baffle assembly may exert less hydraulic resistance than that of FIG. 3E when the air flows from right to left. In another example of FIG. 3G, a baffle assembly may include two baffles 33A, 33B which are similarly disposed along the conduit and similarly coupled thereto. However, these baffles 33A, 33B are contoured toward a center of the conduit, thereby offering less hydraulic resistance than those of FIGS. 3E and 3F. Other configurational and/or operational characteristics of the baffles of FIGS. 3E to 3G are similar or identical to those of FIGS. 3A to 3D.

In another exemplary embodiment of this aspect of the invention, a baffle assembly consists of three or more curvilinear baffles which may be coupled to different portions of the conduit member at a variety of angles and may have various curvatures. FIGS. 3H to 3L show cross-sectional views of such baffle assemblies according to this invention. In one example of FIG. 3H, a baffle assembly may include one distal baffle 33A and a pair of proximal baffles 33B, 33C, where the former is disposed in a center portion of the conduit, while the latter are disposed around a peripheral portion thereof. The inner distal baffle 33A is also shaped and sized to be larger than a gap between the outer peripheral baffles 33B, 33C, thereby preventing the formation of the line of sight between the air outlet and wave sources. In related examples of FIGS. 3I and 3J, each baffle assembly is typically similar to that of FIG. 3H, except that the inner baffle 33A is streamlined (FIG. 3I) or that all baffles 33A-33C are streamlined (FIG. 3J) in order to decrease the resistance to flow. It is appreciated that the baffle assembly of FIG. 3J includes a pair of proximal baffles 33A, 33B and a single distal baffle 33C. In another example of FIG. 3K, a baffle assembly is similar to that of FIG. 3J and includes one inner baffle 33A and a pair of outer baffles 33B. At least one 33C of such baffles, however, is arranged to have a solid structure instead of the sheet-like structure of other baffles 33A, 33B. In addition, such a solid structure of the baffle 33A forms a streamlined contour to decrease its resistance to air flow. Such inner baffles of FIGS. 3I to 3K are also arranged to overlap portions of the outer baffles to suppress the formation of the line of sight from the wave sources through the air outlet. In another example of FIG. 3L, a baffle assembly includes four or more baffles, at least two of which may be the inner baffles 33A, 33B and at least two others of which may then be the outer baffles 33C, 33D. It is appreciated in all of such examples that the inner baffles may maintain their positions by directly coupling with the conduit or by indirectly coupling with the conduit through the outer baffles. Other configurational and/or operational characteristics of the baffles of FIGS. 3H to 3L are similar or identical to those of FIGS. 3A to 3G.

In another aspect of the present invention, baffles having various shapes and/or sizes may be installed into various locations in, along or around the conduit and/or body members of the hair drying systems to only partially obstruct cross-sections of the conduit and/or body members. FIGS. 3M to 3X are schematic views of exemplary baffles according to the present invention. Such systems typically include at least one baffle which defines at least one opening or gap therethrough. When the system employs multiple baffles, such baffles may have identical, similar or different shapes and/or sizes and may also be disposed along the same, adjacent or different locations with respect to longitudinal axes of their conduits and/or their diameters or other characteristic dimensions thereof. In addition, each of such baffles may directly couple with each other (detailed coupling modes and/or couplers not shown in the figures) or, alternatively, may couple with the conduit and/or body members, thereby maintaining its position with respect to the other baffle. Because of the openings in the baffles, the main function of various baffle assemblies of the following figures is to obstruct only a portion of a cross-section of the conduit while allowing a flow of air through the conduit in order to minimize formation of the line of sight between the air outlet and one or more wave sources

In one exemplary embodiment of this aspect of the invention, a baffle may form an assembly of multiple elements which are aligned according to a preset pattern and interval. In one example of FIG. 3M, a baffle 33 consists of multiple wires aligned horizontally and spaced apart by an uniform interval. Because the baffle 33 forms an elongated gap between each adjacent pair of wires, it may minimize but not be able to prevent the formation of the line of sight from the wave sources to the air outlet. In another example of FIG. 3N, a baffle 33 is similar to that of FIG. 3M, except that its wires are aligned vertically and spaced apart from each other by an uniform interval. In another example of FIG. 3O, a baffle 33 is similar to that of FIGS. 3M, except that its wires are aligned at a preset angle and spaced apart from each other by an uniform interval. In another example of FIG. 3P, a baffle 33 has multiple elements of wires which, however, may be disposed at different angles and spaced apart from each other by varying intervals. Other configurational and/or operational characteristics of such baffles of FIGS. 3N to 3P are similar or identical to those of FIG. 3M, while other configurational and/or operational characteristics of the baffles of FIGS. 3M to 3P are also similar or identical to those of FIGS. 3A to 3L.

In another exemplary embodiment of this aspect of the invention, a baffle may include a single element which is bent or wound in a preset pattern. In one example of FIG. 3Q, a baffle 33 includes a single strand of wire which is helically wound into a shape of a planar coil and covers an area of a circle. In another example of FIG. 3R, a baffle 33 includes another single strand of wire which is bent at right angles and also arranged to reciprocate in an alternating pattern in order to cover an area of a square or a rectangle. Other configurational and/or operational characteristics of the baffles of FIGS. 3Q and 3R are similar or identical to those of FIGS. 3A to 3P.

In another exemplary embodiment of this aspect of the invention, a baffle assembly includes at least two baffles each of which may define at least one opening therethrough. In one example of FIG. 3S, a baffle assembly includes a distal baffle 33A and a proximal baffle 33B, where the former is the baffle of FIG. 3M, while the latter corresponds to the baffle of FIG. 3N. Such baffles 33A, 33B may be spaced apart by a preset distance as well. In another example of FIG. 3T, a baffle assembly includes a distal baffle 33A and a proximal baffle 33B, where the former is the baffle of FIG. 3O and the latter is the baffle of FIG. 3M and where such baffles 33A, 33B are similarly spaced apart from each other. In yet another example of FIG. 3U, a baffle assembly includes a distal baffle 33A and a pair of proximal baffles 33B, 33C, where the former corresponds to the baffle of FIG. 3Q and where each of the latter is a portion (e.g., one half) of the baffle of FIG. 3Q cut along a vertical center line. Such baffles 33A-33C are disposed apart from each other by a preset distance. In another example of FIG. 3V, a baffle assembly includes the baffles of FIGS. 3M and 3N which are disposed one over the other and contact each other. Other configurational and/or operational characteristics of such baffles of FIGS. 3S to 3V are similar or identical to those of FIGS. 3A to 3R.

In another exemplary embodiment of this aspect of the invention, a baffle assembly includes at least one non-wire element which may define shapes of strips, sheets, and so on. In one example of FIG. 3W, a baffle 33 may include multiple strips aligned horizontally and spaced apart by an uniform interval. Because the baffle 33 forms an elongated gap between each adjacent pair of strips, it may minimize but not be able to prevent the formation of the line of sight from the wave sources to the air outlet. In another example of FIG. 3X, a baffle assembly includes at least one distal baffle 33A and at least one proximal baffle 33B, where the former corresponds to the one of FIG. 3W, while the latter includes multiple strips which may be aligned vertically and spaced apart by another uniform interval. The baffles comprised of one or more wires and defining other shapes may also be constructed by replacing one or more of such wires by one or more of the strips each of which may define the same, similar or different shapes and/or sizes and each of which may be disposed at an uniform interval or at varying distances. Other configurational and/or operational characteristics of such baffles of FIGS. 3W and 3X are similar or identical to those of FIGS. 3A to 3V.

Configurational and/or operational variations and/or modifications of the above embodiments of the exemplary systems and various modules thereof described in FIGS. 3A through 3X also fall within the scope of this invention.

In general, the baffle may define any shapes and/or sizes and may be provided in almost any thicknesses as long as such a baffle may allow the flow of air through the conduit when incorporated thereinto. Similarly, the baffle assembly may also include any number of such baffles as long as such a baffle assembly allows the air to flow through the conduit when incorporated thereinto. The baffle may define the planar (or two-dimensional) shape or three-dimensional shape. In addition, the baffle may define any contour thereon to minimize the hydraulic resistance to the flow of air. Moreover, the baffle may be made as a solid or porous article, and may be made of and/or include at least one rigid or flexible material.

It is appreciated that the baffles depicted in the above figures may be interpreted in more than one perspective. For example, the proximal baffles 33B, 33C of FIG. 3H may be two separate baffles coupled to the top and bottom of the conduit or, alternatively, may correspond to different sections of a single annular baffle. It is also appreciated that the actuator member may be disposed in any side of the conduit such that the air may flow in any horizontal direction and that any baffle may be a proximal or distal one.

As described above, the baffle may be disposed at any preset angle with respect to the wall of the conduit and/or longitudinal axis thereof. Such a baffle may be arranged to define a curvature in order to minimize the hydraulic resistance to the flow of air. The baffle may be fixedly coupled to the wall or, alternatively, may be movably or releasably coupled thereto such that the user may adjust the shape and/or size of the baffle protruding into the lumen of the conduit, thereby varying the resistance to flow, direction of air flow, and the like.

When the conduit member includes multiple baffles, at least two of such may define the same, similar or different shapes, sizes, curvatures, orientations, and the like. The baffles may be disposed along the same, adjacent or different locations of the conduit. At least two of the baffles may also be disposed symmetrically or asymmetrically with respect to the longitudinal axis of the conduit member (i.e., longitudinally), to the diameter thereof (i.e., radially or circumferentially), and so on. At least two of such baffles may be disposed on the same side or opposite sides of the conduit. It is appreciated that, regardless of the number of baffles and their shapes and/or sizes, each baffle may preferably be tailored obstruct different portions of the cross-section of the conduit when projected thereupon. When desirable, the conduit member may employ both of the baffle(s) and bend(s) to block the cross-section of the conduit. Although the prime function of the baffles is to obstruct such a cross-section, only one baffle and/or bend may be formed along the conduit to obstruct only a portion thereof. Such baffles may be formed as an unitary article with the conduit or, in the alternative, such baffles may be formed separately from the conduit and coupled thereto fixedly, releasably or movably. The air outlet may be arranged to serve as the baffle as well.

As described above, at least one of the baffles may define openings thereacross, where the openings may be elongated horizontally or vertically, may be formed as gaps between the intersecting elements of the baffle, and the like. In particular, when the baffle includes multiple, elements, such may be disposed in an uniform interval or in intervals which vary along a horizontal, vertical, and/or radial directions.

It is appreciated that one criterion for designing the baffle assembly is its hydraulic resistance to the flow of air, for such resistance depends not only upon the shape and/or size of the individual baffle but also upon the arrangement of multiple baffles thereof. In general, the resistance increases as the baffles overlap greater portions thereof. Even for the same set of baffles, the resistance may increase as the baffles are disposed closer to each other. Accordingly, configuration and disposition of multiple baffles may be selected by not only considering effective prevention of the formation of the line of sight but also taking account for the hydraulic resistance exerted thereby.

In another aspect of the present invention, the conduit member may be arranged to include at least one mobile unit and at least one stationary unit so that the mobile unit may move between at least two states with respect to the stationary unit, thereby varying the distance between the air outlet and at least one wave source of such a system. FIGS. 4A to 4F are cross-sectional views of exemplary conduits having at least one mobile unit according to the present invention. It is appreciated in these figures that the air inlet and air outlet are omitted therefrom for simplicity of illustration and that the air inlet and air outlet may be provided in each opposing end of the conduit in any combinations. It is also appreciated in these figures that each exemplary conduits defines a single air path therealong. These embodiments, however, may readily be applied to the conduit which may define multiple air paths and junctions therein. For simplicity of illustration, each conduit member in the following figures is deemed to move between an off-state and an on-state, where the system is not in use in the off-state and in use in the on-state. A top panel of each of the following figures shows the conduit member disposed in its off-state, while a bottom panel thereof represents the conduit member moved to its on-state.

In one exemplary embodiment of this aspect of the invention, a conduit member may include at least one mobile unit and at least one stationary unit, where the mobile unit may move between an on-state and an off-state. In one example of FIG. 4A, a conduit member 30 may have a distal mobile unit 35M and a proximal stationary unit 35S, where a proximal end of the mobile unit 35M may be movably disposed inside a distal end of the stationary unit 35S, translate into the stationary unit 35S in the off-state (see the top panel), and translate out thereof in the on-state (see the bottom panel). By installing the air outlet in the distal mobile unit 35M and by incorporating the air inlet and wave sources into the proximal stationary unit 35S, the conduit member may increase the distance between the air outlet and wave sources by moving the mobile unit 35M to its on-state, thereby dispersing the EM waves emitted by the wave sources farther away from such an air outlet and decreasing the amount of such waves propagating toward the air outlet. In a related example of FIG. 4B, a conduit member 30 may be similar to that of FIG. 4A but its distal unit 35S is stationary and its proximal unit 35M is mobile. In addition, a distal end of the mobile unit 35M is movably disposed inside a proximal end of the stationary unit 35S, translate into the stationary unit 35S in the off-state (see the top panel), and then translate out thereof in the on-state (see the bottom panel). By disposing the air outlet in the distal stationary unit 35S and by incorporating the air inlet and wave sources into the proximal mobile unit 35S, the conduit member 30 similarly increases the distance between the air outlet and wave sources in its on-state, thereby dispersing the EM waves from the wave sources farther away from the air outlet and decreasing the amount of the waves propagating through the air outlet. In an example of FIG. 4C, a conduit member 30 is a combination of those of FIGS. 4A and 4B and may include a distal mobile unit 35M, a proximal mobile unit 35M, and a middle stationary unit 35S into and out of which both proximal and distal mobile units 35M may translate while varying the distance between the air outlet in the distal mobile unit 35M and the wave sources in the proximal mobile unit 35M.

In another exemplary embodiment of this aspect of the invention, a conduit member may have at least one mobile unit and at least one stationary unit, where the mobile unit may move with respect to the stationary unit while being guided by a track-guide assembly. For example and as described in FIG. 4D, a conduit member 30 is typically similar to that of FIG. 4A. However, a proximal stationary unit 35S defines a helical track 36 therealong which is carved into an inner surface thereof, while a distal mobile unit 35M includes a guide 37 protruding above an outer surface of the unit 35M. The track 36 of the stationary unit 35S is also arranged to movably retain the guide 37 of the mobile unit 35M so that any movement of the mobile unit 35M is guided by the track 36. Such a mobile unit 35M may move in a few arrangements. For example, the mobile unit 35M rotates and moves with its guide 37 proximally or distally depending upon a direction of rotation of the mobile unit 35M and another direction of a pitch of the track 36. In another example, the guide 37 is arranged only to translate and the stationary unit 35S is arranged to rotate but to not change its position. As the stationary unit 35S rotates, the guide 37 is abutted thereby and translates proximally or distally similar to the previous example. Therefore, the system may disperse the EM waves emitted by the wave sources farther away from the air outlet and decrease the amount of such waves propagating through the air outlet by moving the mobile unit 35M to its on-state.

In another exemplary embodiment of this aspect of the invention, a conduit member may have at least one mobile unit and at least one stationary unit where the mobile unit may move along a curved path. In one example of FIG. 4E, a conduit member 30 is similar to that of FIG. 4A, but its distal mobile unit 35M has an upward curvature such that the mobile unit 35M may change its position between its off- and on-states not only in a horizontal direction but also in a vertical direction. In order to attain the curved movement path, the conduit member 30 may need the track-guide assembly described above. In another example of FIG. 4F, a conduit member 30 is typically similar to that of FIG. 4E but both of the distal mobile unit 35M and the proximal stationary unit 35S have matching curvature. Accordingly, the body of the stationary unit 35S may guide the mobile unit 35M to move along the horizontal and vertical directions between its off- and on-states.

Configurational and/or operational variations and/or modifications of the above embodiments of the exemplary systems and various modules thereof described in FIGS. 3A through 3X also fall within the scope of this invention.

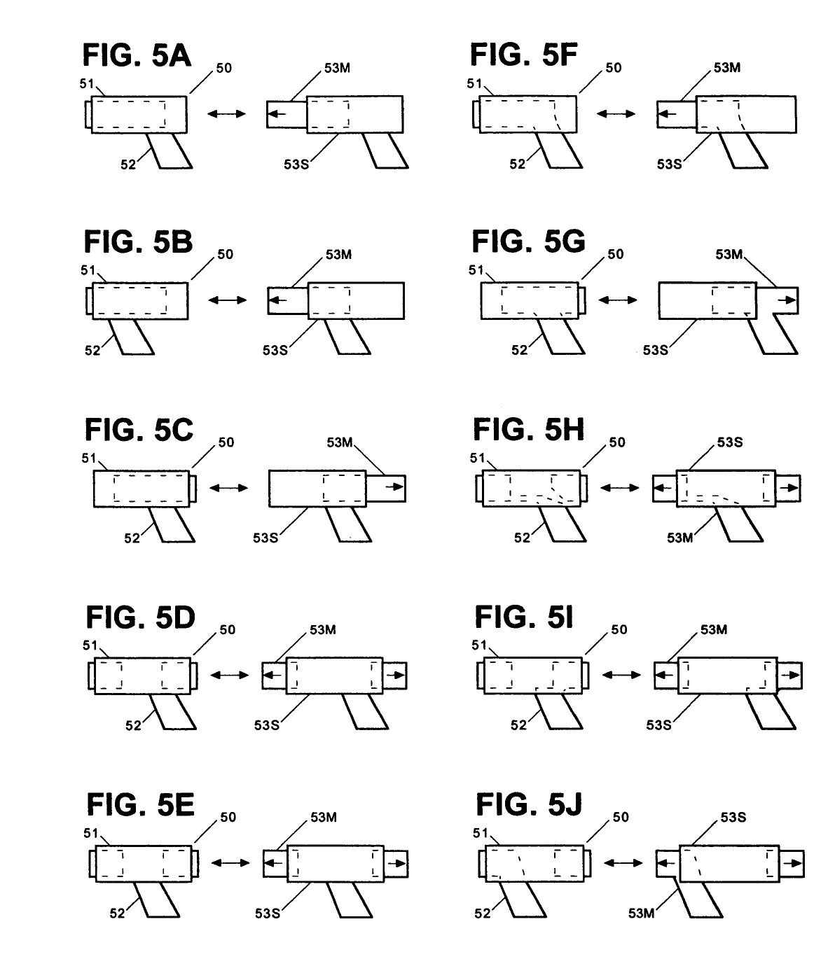

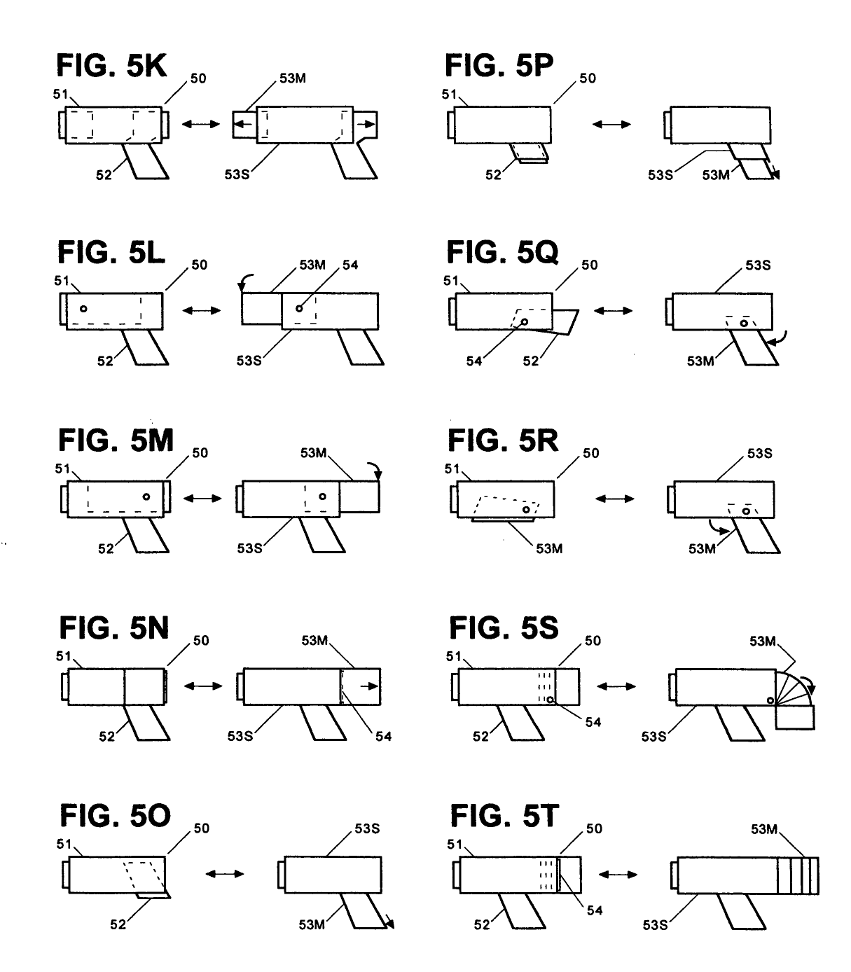

In another aspect of the present invention, the body member may be arranged to have at least one first unit and at least one second unit, where at least one of such units may include at least one mobile section and at least one stationary section so that the mobile section moves between at least two states with respect to the stationary section, thereby varying the distance between the air outlet and at least one wave source of the system. FIGS. 5A to 5T are cross-sectional views of exemplary body members including at least one mobile unit and/or section according to the present invention. It is appreciated in these figures that the conduit members are omitted therefrom for simplicity of illustration and that the air inlet, air outlet, and conduit may be provided in each opposing end of the body member in any combinations. For simplicity of illustration, each body member in the following figures is deemed to move between an off-state (not in use) and an on-state (in use). A left panel of each figure shows the body member in its off-state, whereas a bottom panel thereof represents the body member moved to its on-state. An exemplary body member selected for these figures includes at least one first unit and at least one second unit, where the first unit is generally elongated to include at least a substantial portion of the conduit member therein, and the second unit couples with the first unit at a preset angle and is generally used as a grip portion of the system.

In one exemplary embodiment of such an aspect of the invention, the first unit includes at least one mobile section which moves between at least one off-state and at least one on-state similar to the mobile unit of the conduit member as described above. In one example of FIG. 5A, a body member 50 includes the first and second units 51, 52, where the first unit 51 includes a distal mobile section 53M and a proximal stationary section 53S, while the second unit 52 is fixedly or releasably coupled to a proximal portion of the stationary section 52S. Accordingly, as the mobile section 53M moves from its off- to on-state, the body member 50 increases the distance between opposing ends of the first unit 51, while forming the grip portion 52 in a proximal portion of the body member 50. In a related example of FIG. 5B, a body member 50 is similar to that of FIG. 5A, except that the second unit 52 couples with the distal portion of the first unit 51. Accordingly, when the mobile section 53M moves to its on-state, the distance between the opposing ends of the first unit 51 increases, and the grip portion 52 may be positioned in a center portion of the body member 50. In another example of FIG. 5C, a body member 50 is also similar to that of FIG. 5A, except that a mobile section 53M is disposed in the distal portion of the first unit 51 such that the grip portion 52 is positioned in a center portion of the body member 50 as such a mobile section 53M moves to its on-state. In another example of FIG. 5D, a body member 50 is a combination of those of FIGS. 5A and 5C such that a distal mobile section 53M and a proximal mobile section 53M are movably disposed inside (or outside) a middle section of the first unit 51. Therefore, the distance between the opposing ends of the first unit 51 may increase when each of the distal and proximal mobile units 53M moves to its on-state. In another example of FIG. 5E, a body member 50 is similar to that of FIG. 5D, except that the second unit 52 may be positioned in the middle portion of the member 50 in both of the off- and on-states.

In another exemplary embodiment of this aspect of the invention, the first unit includes at least one mobile section to which the second unit is coupled. Accordingly, the second unit moves with the mobile section of the first unit, thereby changing a relative position of the grip portion of the member between its off- and on-states. In one example of FIG. 5F, a body member 50 defines a configuration similar to that of FIG. 5A in its off-state. Because the second unit 52 is coupled to the mobile section 53M of the first unit 51, the grip portion 52 moves to the middle portion of the body member 50 as the mobile section 53M moves to its on-state, thereby defining the configuration similar to that of FIG. 5B. In another example of FIG. 5G, a body member 50 defines a configuration similar to that of FIG. 5C in its off-state. Because the second unit 52 is coupled to the proximal mobile section 53M of the first unit 51, the grip portion 52 remains in the proximal portion of the body member 50 when the mobile section 53M is in its on-state, thereby defining the configuration similar to that of FIG. 5A. In another example of FIG. 5H, a body member 50 forms a configuration similar to that of FIG. 5D in its off-state. Because the second unit 52 is coupled to the distal mobile section 53M of the first unit 51, however, such a grip portion 52 moves to the middle portion of the body member 50 when both mobile sections 53M move to their on-states, thereby defining the configuration similar to that of FIG. 5E. In another example of FIG. 5I, a body member 50 is similar to that of FIG. 5H, except that the second unit 52 is instead coupled to the proximal mobile section 53M. Accordingly, as the mobile sections 53M move to their on-states, the grip portion 52 also remains in the proximal portion of the body member as is the case with FIG. 5D. In another example of FIG. 5J, a body member 50 is similar to that of FIG. 5H, except that the second unit 52 is disposed under and couples with the distal mobile section 53M. Accordingly, the grip portion 52 may move to the distal portion of the body member 50 when the mobile sections 53M move to their on-states. In another example of FIG. 5K, a body member 50 is also similar to that of FIG. 5I, except that the second unit 52 is disposed under and couples with the very proximal portion of the proximal mobile section 53M. Accordingly, the grip portion 52 extends proximally and beyond the proximal end of the middle section of the first unit when the mobile sections 53M move to their on-states.

In another exemplary embodiment of this aspect of the invention, a first unit includes at least one mobile section which rotates or pivots between the off- and on-states, contrary to those mobile sections which may translate along a curvilinear paths between such states. In one example of FIG. 5L, a body member 50 is generally similar to that of FIG. 5A in that including a first unit 51 and second unit 52, where the first unit 51 includes a distal mobile section 53M and a proximal stationary section 53S. In addition, such a mobile section 53M is pivotally coupled to the stationary section 53S in order to pivot between its off- and on-states about a center of rotation 54 which is shown as a small circle and disposed in the distal portion of the stationary section 53S. Therefore, as the mobile section 53M pivots from its off- to on-state along a clockwise or counterclockwise direction, the body member 50 increases a distance between opposing ends of the first unit 51, while forming the grip portion 52 in a proximal portion of the body member 50. In another example of FIG. 5M, a body member 50 is similar to that of FIG. 5L, except that such a first unit 51 includes a distal stationary section 53S and a proximal mobile section 53M which pivots between its off- and on-states about the center of rotation 54 along a counterclockwise or clockwise direction. Because the second unit 52 couples with such a proximal portion of the distal stationary section 53S, the grip portion may be positioned in the middle of the body member 50 in the on-state. In another example of FIG. 5N, a body member 50 includes the first unit 51 and second unit 52, where the first unit 51 includes a stationary section 53S and a mobile section 53M pivotally coupling with and disposed on a side of the stationary section 53S in its off-state. Therefore, the mobile section 53M is disposed off the lumen of the stationary section 53S in its off-state, and then moves to its on-state by pivoting about the rotation axis 54 which is defined vertically and aligns with the lumen of the stationary unit 53S, thereby increasing the distance between opposing ends of such a first unit 51 while disposing the grip portion 52 in a center portion of the body member 50. It is noted that the rotation axis 54 of this example may extend vertically, whereas such axes of FIGS. 5L and 5M extend into and out of the paper. The above mobile sections of other body members of FIGS. 5A to 5L may also be replaced by any of these mobile sections pivoting between their off- and on-states.

In another exemplary embodiment of this aspect of the invention, a second unit may include at least one stationary section and at least one mobile section which may also translate, rotate, pivot or otherwise move similar to the mobile sections of the first unit. In one example of FIG. 50, the first unit 51 may include any of the above mobile and/or stationary sections, while the second unit 52 includes a mobile section 53M which is movably coupled to a proximal portion of the first unit 51. In an off-state thereof, at least a substantial portion of the second unit 52 is releasably disposed inside the first unit 51, thereby rendering the first unit 51 constitute at least a substantial portion of an exterior of the body member 50. Therefore, as the mobile section 53M of the second unit 52 moves out of the first unit 51 from its off- to on-state, the body member 50 may increase the distance between the distal end of the first unit 51 and the second unit, while gradually forming the grip portion 52. When the wave sources may be disposed in the second unit 52, this embodiment offers an additional benefit of positioning the wave sources away from the first unit 51, thereby preventing (or at least minimizing) such EM waves from propagating along the conduit to the air outlet. In another example of FIG. 5P, a body member 50 is similar to that of FIG. 5O, except that the second unit 52 includes a proximal stationary section 53S and a distal mobile section 53M. The stationary section 53S is fixedly coupled to the first unit 51, and the mobile section 53M is movably disposed inside (or outside) the stationary section 53S and moves toward and away from such a stationary section 53S between its off- and on-states, respectively. In another example of FIG. 5Q, a body member 50 includes the first unit 51 and second unit 52 an entire portion of which is pivotally coupled to the first unit 51 about a center of rotation 54 defined in a distal portion of the first unit 51. Such a second unit 52 is disposed closer to or inside the first unit 51 in its off-state, and pivots away therefrom or exposes itself to its on-state. In a related example of FIG. 5R, a body member 50 is similar to that of FIG. 5Q, except that the second unit 52 pivots between its off- and on-states in opposite directions.

In another exemplary embodiment of such an aspect of the invention, a body member includes at least one mobile section aligning with the first unit when not in use and misaligning therewith during use. It is appreciated that body members of this embodiment is to be distinguished from that of FIG. 5N of which the mobile section may align with the first unit during use and misalign therewith when not in use. In one example of FIG. 5S, a first unit 51 includes a stationary section 53S and a mobile section 53M which may pivot about a center of rotation between its off- and on-state, where such sections 53S, 53M couple with each other by a bellow or other articles defining an air path therethrough. In its off-state, the mobile section 53M couples and aligns with a proximal end of the stationary section 53S by its distal end. During its movement toward its on-state, the mobile section 53M gradually pivots and misaligns itself away from the stationary section 53S downwardly, thereby removing itself from such a lumen of the stationary unit 53S. Accordingly, the first unit 51 in its fully on-state forms a curvature which is generally similar to that of the conduit of FIG. 2A, where the bellow of the mobile section 53S corresponds to the bend of the conduit of FIG. 2A. In another example of FIG. 5T, a first unit 51 may be similar to that of FIG. 5S, except that such a mobile section 53M pivots and misaligns itself from the lumen of the conduit horizontally and sideways.

Configurational and/or operational variations and/or modifications of the above embodiments of the exemplary systems and various modules thereof described in FIGS. 5A through 5T also fall within the scope of this invention.

It is appreciated that the main function of the body member may be to retain therein the conduit, actuator, and/or heating members or, alternatively, to indirectly support such conduit, actuator, and/or heating members through the conduit member retained therein. At least a portion of the body member may also serve as a portion of the conduit member.

By incorporating at least one mobile unit to the conduit (or body) member, the system offers an advantage of allowing the user to shorten an overall length of the system when not in use (by moving the conduit or body member to its off-state) and to disperse more EM waves away from the air outlet when in use (by moving such a member to its on-state). The mobile unit may generally move between its off- and on-states by translating, rotating, and/or pivoting along the straight and/or curved path. As described above, such movement may be telescopic, i.e., such a mobile unit may be releasably kept in any distance from the stationary unit within a preset range of movement. In the alternative, the mobile or stationary unit may define a preset number of stops shaped as protrusions, indentations, grooves, and the like. The other of such units may then define a matching structure so that the mobile unit may be releasably kept in each of such stops. When desirable, any of the above movements may also be guided by the suitable track-guide assembly. The mobile unit may move between the states manually, i.e., the user moves the mobile unit between the stops or telescopically. In the alternative, the system may include actuating mechanisms for moving the mobile unit automatically such as, e.g., by activating a trigger. In either example, the system may also include a recoil unit which may store energy as the mobile unit moves from one to the other of such states, and then release the stored energy to return the mobile unit back to its initial state. When desirable, the mobile unit may be arranged to change not only its position but also its orientation between the states. In addition, one of such conduit and body members may be arranged to be a mobile member which move between the off- and on-states with respect to the other of such members which may then serve as a stationary member.

Such conduit and body members of the system may be arranged to be interchangeable and to serve for each other. For example, at least a portion of the conduit member may be disposed inside at least a portion of the body member. Alternatively, at least a portion of the body member may serve as at least a portion of the conduit member. Such conduit and body members may be disposed relative to each other in various arrangements. For example, the conduit and body members may be arranged to terminate together in one or both of the proximal and distal ends of the system. In such a case, the air inlet or outlet may define the proximal or distal end of both members, respectively. In another example, the conduit member may extend beyond the body member in the proximal (or distal) end of the system such that one or both of the air inlet and outlet protrude out of one or both ends of the body member. In a reverse example, such a body member may extend beyond the conduit member in the proximal (or distal) end of the system as well.

Disposition of the air inlet may also be determined considering the location of the air outlet. For example, the air inlet may be incorporated into at least one of the other of the units and/or sections of the body member in which the air outlet is not disposed. In another example, the air inlet may instead be defined in only one of the grip portion and non-grip portions, where the grip portion is generally the transverse second unit but may also be the elongated first unit. In yet another example, at least one air inlet may be defined in both of the grip and non-grip portions.

Such a body member may include the first and second units, where the first unit is generally elongated, while the second unit is transversely coupled to the first unit and used as the grip portion for the user. The body member may also include other auxiliary portions such as a cover, adaptor, and the like, which may be used to affect flow pattern of the flow of air in, through, and/or out of the body member. The first unit may consist of a single stationary or mobile section or, alternatively, may also include one or more stationary sections and/or one or more mobile sections. Each section of the first unit may define a straight or curved contour and which may also couple with each other fixedly, releasably or movably. The first unit may have one or more air inlet and one or more air outlet in either or both of such sections. Alternatively, the first unit may define one or more air outlet but no air inlet when the air inlet may be formed in the second unit. Similarly, the second unit may consist of a single stationary or mobile section or, alternatively, may also include one or more stationary sections and/or one or more mobile sections. Each section of the second unit may define a straight or curved contour and which may couple with each other fixedly, releasably or movably. The second unit may not have any air inlet nor air outlet one, when both are disposed in the first unit or, alternatively, may not have any air outlet but may define one or more air inlet. When desirable, the air inlet may be formed in both of the first and second units. The body member may consist only of the first unit at least a portion of which may then be used as the grip portion.

The body member, its units, and/or sections may extend in any lengths along a curvilinear path as exemplified in FIGS. 5A to 5T. The body member, its units, and/or sections may also have a cross-section of any shapes and/or sizes, subject to the shapes and/or sizes of the conduit member in case the body member, its units, and/or sections should retain at least a portion of the conduit member. At least two units and/or sections of the body member may be arranged to merge into one or more units and/or sections and, conversely, at least one unit and/or section of the body member may bifurcate into two or more units and/or sections. Similar to the conduit member, the body member may include one or more of the above baffles and/or may be bent around one or more bends.

Each of such conduit and body members may be arranged to include at least one mobile unit or section. In the alternative, only the conduit member may have at least one mobile unit or section, while the body member itself is a stationary member. In such an example, the air outlet or at least one wave source may be incorporated into the mobile unit or section of such a conduit member which may move toward and away from the preset portion of the system between its off- and on-states, respectively. Accordingly, the distance between the air outlet and the wave source may vary between the states. Alternatively, only the body member may include at least one mobile unit or section, while the conduit member itself may rather be a stationary member. In this example, the air outlet or at least one wave source may be incorporated into the mobile unit or section of the body member which moves toward and away from the preset portion of the system. Accordingly, the distance between the air outlet and wave source may be varied between such states.

The mobile member, unit, and/or section may generally move along one or more paths between the off- and on-states. Such movement of the member, unit, and/or section may be translation along the linear and/or curved paths, may be rotation about the center of rotation which may be defined in a preset position of the mobile or stationary member, may be pivoting about the center of rotation, and so on. As described above, the movement may be incremental and defined at a finite number of stops in which such a member, unit, and/or section may be releasably retained by suitable mechanisms or, alternatively, may be telescopic and continuous within a preset range. Such movement may be guided by various track-guide assemblies, where such tracks may be formed along one of the stationary and mobile members, units, and/or sections, and where such guides may be formed in the other thereof. The mobile member, unit, and/or section may be arranged to change its position along its paths during such movement and, when desirable, may also change its orientation with respect to the stationary member, unit, and/or section. The body member may also include a recoil unit which may store energy when the mobile member, unit, and/or section moves from one to the other of such states, and release the stored energy to return the mobile unit back to its initial state.

As described herein, the intensity of the MWs and EWs decreases inversely proportional to a square of the distance from the wave sources. Thus, one way of attenuating the intensity of such waves is to provide a desired distance between the air outlet and wave sources of the system, and the length of the body member in its on-state may be determined accordingly. For example, the length of the body member, its units, and/or sections may be selected in order to ensure that the intensity of such magnetic fields measured at a preset distance from the air outlet may be less than a preset limit. Examples of the preset limit may be set as an absolute value such as 0.1 mG, 0.2 mG, 0.3 mG, 0.5 mG, 0.7 mG, 1 mG, 2 mG, 3 mG, 4 mG, 5 mG, 7 mG, 10 mG, and so on, while the examples of such a preset distance may be 0.1 cm, 0.2 cm, 0.5 cm, 1 cm, 2 cm, 3 cm, 5 cm, 7 cm, 10 cm, 15 cm, 20 cm, 25 cm, 30 cm, and so on. In the alternative, the length of the body member, its units, and/or sections may also be selected in order to ensure that the intensity of the magnetic fields may be attenuated by a preset ratio when compared between a preset proximal position and a preset distal position, where examples of the proximal position may be an exterior of the wave source, a location spaced apart from the wave source by a preset distance, and so on, while examples of the distal position may be the air outlet, a location spaced apart from the air outlet by another preset distance, and the like. In addition, examples of the preset ratio which is a relative value may be 0.95, 0.9, 0.85, 0.8, 0.75, 0.7, 0.65, 0.6, 0.55, 0.5, 0.45, 0.4, 0.35, 0.3, 0.25, 0.2, 0.15, 0.1, 0.05, and the like.

In general, the hair drying system of this invention is designed to vary the above distance from the air outlet to the wave sources while at least substantially maintaining an area of the cross-section of such an air outlet. In other words, the system preferably includes at least one mobile member, unit, and/or section thereof which may move between the off- and on-states and vary such a distance by moving the mobile member, unit, and/or section to its on-state without having to attach any article onto any portion of the system. As will be described below, the system may include an article which may be releasably disposed onto the air outlet and define a new air outlet (or outlet end) in its distal end, thereby increasing such a distance between the new air outlet (or outlet end) and the wave source. The cross-sectional area of the new air outlet (or outlet end) may be identical, similar or different from that of the original air outlet. Such an article may also be designed to prevent or at least minimize the formation of the line of sight between its outlet end and the wave source. When desirable, the article may be incorporated with the MS and/or ES in order to prevent or at least minimize the formation of the line of sight for the MWs and/or EWs, respectively.

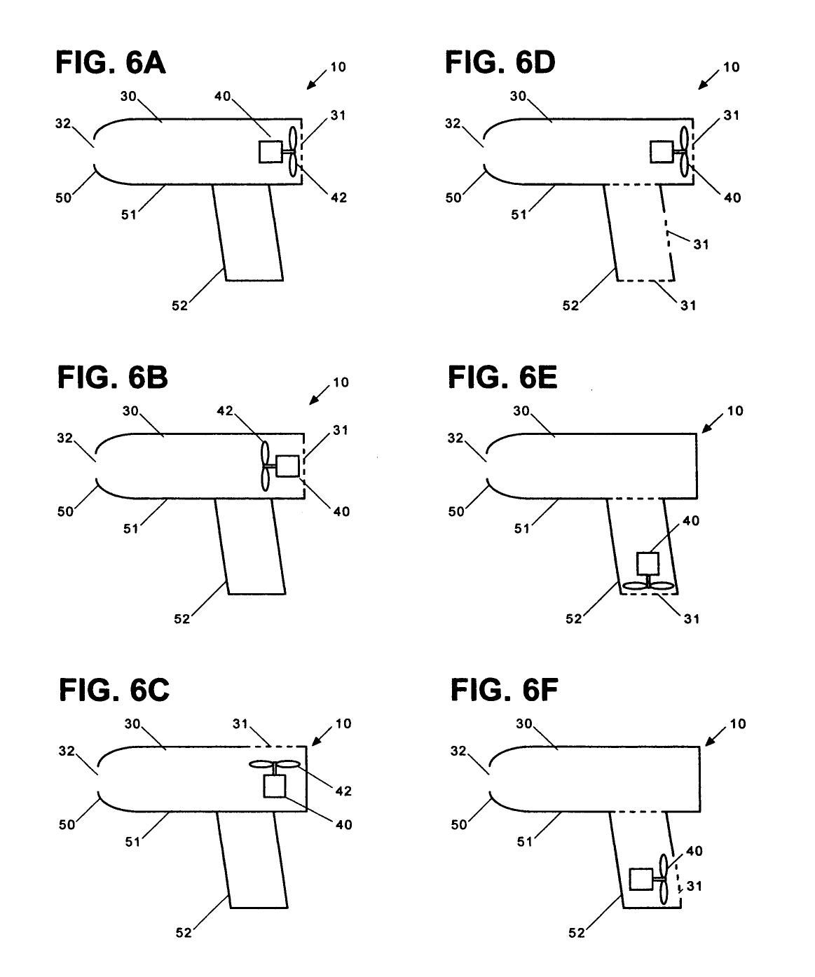

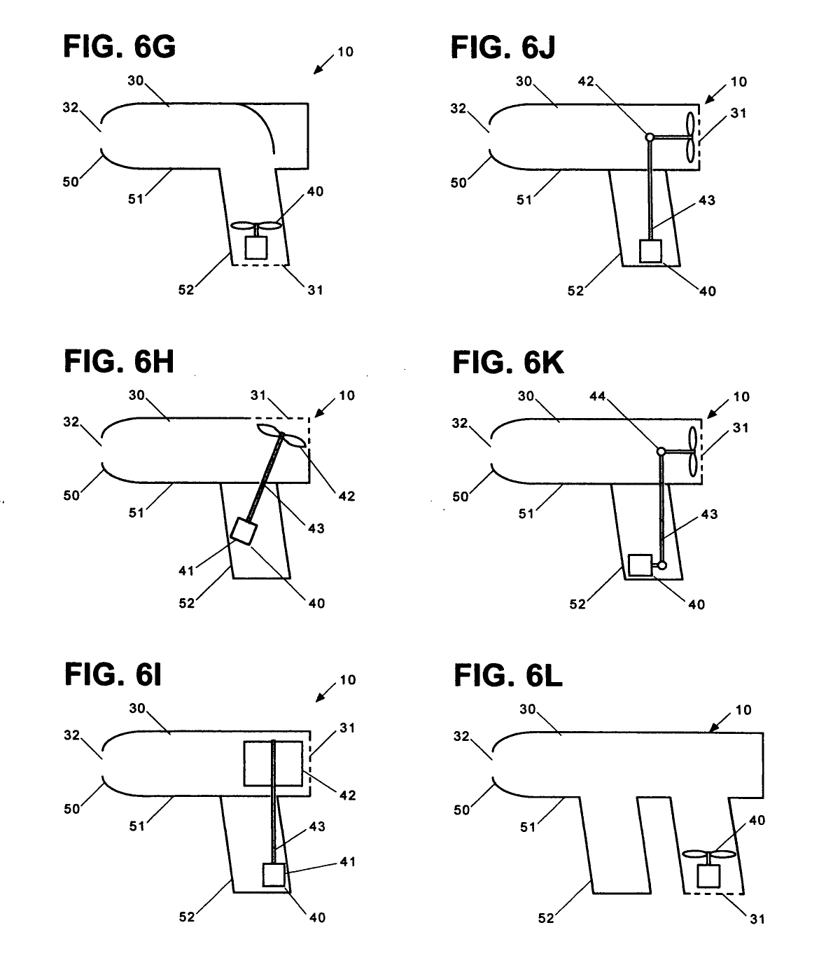

In another aspect of the present invention, hair drying systems may have at least one actuator member which is capable of taking air in through the air inlet, transporting air through the conduit, and discharging air through the air outlet. The actuator member may be disposed in the first and/or second units and disposition of the actuator member may depend upon various factors such as, e.g., a space available in each unit, distance from the air outlet, position of the air inlet, and the like. It is appreciated that at least a portion of the body member may serve as the conduit member and, therefore, that such an actuator member may be disposed in various units and/or sections of the conduit member as well. FIGS. 6A to 6L are cross-sectional views of exemplary actuator members which may be disposed in various positions according to the present invention.

In one exemplary embodiment of this aspect of the present invention, an actuator member may be incorporated into a proximal portion of the first unit of the body (or conduit) member and the air inlet may be defined in various portions of the system. In one example of FIG. 6A, an actuator member 40 includes an impeller 42 and is disposed in the proximal end of the first unit 51 of the body member 50 with its impeller 42 facing a proximal upstream. The air inlet 31 is formed vertically on the proximal end of the first unit 50 in order to allow the actuator member 40 to take in ambient air. In another example of FIG. 6B, an actuator member 40 is similarly disposed in the proximal end of the first unit 51, while its impeller 42 is facing a distal downstream. As long as the actuator member 40 itself may not obstruct the lumen of the body member 50 (or conduit of the conduit member 30), an orientation of the actuator member 40 with respect to the lumen (or conduit) is a matter of selection for one of ordinary skill in the art. In another example of FIG. 6C, an actuator member 40 is similar to that of FIG. 6A, but is disposed vertically with its impeller 42 facing upward. Therefore, the air inlet 31 may also be defined on a top portion of the body member 50 to accommodate such a disposition. In another example of FIG. 6D, an actuator member 40 is similar to that of FIG. 6A, except that multiple air inets 31 may be defined in two or more positions across the first and/or second units 51, 52 of the body (or conduit) member 50. It is appreciated that, when the body member 50 includes the conduit member 30, both of the actuator and conduit members 40, 30 may have to form openings to accommodate the air inlets, where shapes and sizes of such openings provided in different members 30, 40 may be identical to, similar to or different from each other. Such openings in those members 30, 40 may not have to be positioned in the same or adjacent locations of the system either so that such openings of the different members 30, 40 may overlay each other or may be misaligned not to overlap any portions thereof.

In another exemplary embodiment of this aspect of the present invention, an actuator member may be incorporated into various portions of the second unit of the body (or conduit) member and the air inlet may then be defined in various portions of the system. In one example of FIG. 6E, an actuator member 40 includes a similar impeller 42 and is disposed in a bottom portion of such a second unit 52 of the body member 50 with its impeller 42 facing downward. The air inlet 31 is defined horizontally across the bottom portion of such a second unit 50 in order to allow the actuator member 40 to take in ambient air therethrough. It is appreciated that the ambient air may have to flow through the second unit 52 and into the first unit 51 toward the air outlet 32. Accordingly, a coupling portion between the first and second units 51, 52 preferably defines at least one opening through which the air may flow from the second unit toward the first unit. In another example of FIG. 6F, an actuator member 40 may similarly be disposed at the bottom portion of the second unit 52, except that its impeller 42 is facing a proximal direction, and the air inlet 31 is defined vertically in such a bottom portion. In another example of FIG. 6G, an actuator member 40 is similar to that of FIG. 6E but disposed vertically. The air inlet 31 is therefore formed in the bottom of the second unit 52 to take in air and to move such vertically and upwardly. In order to facilitate distal movement of air along the first unit 51, the first unit 51 may also include one or more baffles with proper curvatures to guide air distally. Other configurational and/or operational characteristics of the actuator members of FIGS. 6E to 6G are similar or identical to those of FIG. 6A to 6D.

In another exemplary embodiment of such an aspect of the present invention, a driving unit or motor of an actuator member may be disposed in the second unit, whereas an impeller of the actuator member may be disposed in the first unit. In one example of FIG. 6H, an actuator member 40 includes a driving unit or motor 41 (represented by a square) and at least one impeller 42 mechanically coupled to the driving unit 41 and rotating about an axle 43 which couples the impeller to the driving unit. The air inlets 31 are provided in a top portion and a proximal end of the first unit 51, while the impeller 42 is disposed at a preset angle in order to take in air through such air inlets 31. In order to accommodate this disposition, such a driving unit 41 is disposed at a bottom portion of the second unit 52 of the body member 50 at a similar angle and delivers its torque to the impeller 42 through the axle 43 which may be disposed at the preset angle. In another example of FIG. 6I, an actuator member 40 may similarly include a driving unit 41, an axle 43, and an impeller 42. Contrary to the previous impellers which are designed to transport air from their front to rear, this impeller 42 is arranged to transport air sideways. Therefore, the impeller 42 may be disposed to face the air inlet 31 through its sides, thereby allowing upright and vertical disposition of the driving unit 41 as well as the axle 43. In another example of FIG. 6J, an actuator member 40 includes a conventional joint 44 which may be able to convert a direction of torque generated by its driving unit 41 by about 90°. Therefore, such a driving unit 41 disposed in the second unit 52 rotates a vertical portion of the axle 43, and the joint 44 converts the vertical torque of the vertical portion of the axle 43 into horizontal torque by a horizontal portion of the axle 43, thereby taking in air through the air inlet 41 of the first unit 51 by the driver unit 41 disposed in the second unit 52. In another example of FIG. 6K, an actuator member 40 is similar to that of FIG. 6J but has a pair of joints 44 such that the driver unit 41 may be disposed horizontally. Such an embodiment may offer the benefit of aligning a bottom (or top) of the driver unit 41 with the air outlet 32, thereby disposing sides of the driver unit 41 which emits the greatest portion of the EM waves away from the air outlet 42. In another example of FIG. 6L, a body member 50 has multiple second units 52 and an actuator member 40 may be disposed in the proximal second unit 52, thereby maximizing a distance from the air outlet 32 thereto. Disposing the actuator member according to any of the above examples offers a benefit of removing the driving unit 41 of the actuator member 40 from the first unit 51 and/or conduit. Other configurational and/or operational characteristics of the actuator members of FIGS. 6H to 6L are similar or identical to those of FIG. 6A to 6G.

Configurational and/or operational variations and/or modifications of the above embodiments of the exemplary systems and various modules thereof described in FIGS. 6A through 6L also fall within the scope of this invention.

The above actuator member and/or at least one unit or part thereof may be disposed in the first and/or second units (or sections) of the body (or conduit) member, may be included in the stationary and/or mobile units (or sections) of the first and/or second units of the body (or conduit) member, and so on. It is appreciated that the driver unit or motor is a portion which emits the greatest portion of the EM waves emitted by the actuator member. Accordingly, when various units or parts of the actuator member may be disposed separately, the driver unit may preferably be disposed in the second unit of the body member, misaligned from the conduit, enclosed by the MS and/or ES, and so on.

Various units and/or parts of the actuator member may be provided in the grip portion such as the second unit of the body member. In the alternative, such of the actuator member may be included in the non-grip portion such as the first unit of the body member. When the body member may include a separate handle, it may be incorporated into the first and/or second units of the body member.

Any conventional motors may be employed as the above actuator member. For example, any AC motors with rotors and stators or any DC motors with rotors and permanent magnets may be used depending upon the current supplied by a power supply for the system. Such motors may be fixedly coupled to any of the above units and/or sections of the conduit and/or body members. Alternatively, at least one unit and/or part of the motor may be movably incorporated in at least a portion of the body or conduit member and may move between its off- and on-states independent of the body or conduit member. In another alternative, at least one unit and/or part of the motor may be fixedly coupled to at least one mobile unit and/or section of the conduit or body member and may move its position and/or orientation along with such a mobile unit and/or section.

As described above, the actuator member generally irradiates more EM waves through its side than its front or rear, for a significant portion of such EM waves originates from the stator thereof. It is, accordingly, prudent that adequate MS and/or ES may be incorporated into various portions of the system to prevent (or at least minimize) the MWs and/or EWs irradiated by the actuator member from propagating through its front, sides, and rear. In one embodiment, the MS and/or ES may be disposed on, over or around the front, sides, and/or rear of the actuator member so as to directly shield against the MWs and/or EWs. When desirable, the MS and/or ES may be disposed inside the actuator member as well. In another embodiment, such MS and/or ES may be disposed in other portions of the system to indirectly shield against the MWs and/or EWs. For example, such shields may be disposed along at least a portion of the conduit and/or body members in order to prevent (ot at least minimize) formation of the line of sight between the actuator member (or its driver unit) and air outlet. When desirable, the MS and/or ES may be arranged to reflect the MWs and/or EWs away from the air outlet as well. Such MWs and/or EWs may also be minimized or attenuated by using the counter member details of which will be provided below.

In another aspect of the present invention, various heating members may be incorporated into the system for generating heat and then transferring the heat to air flowing through the conduit of the conduit member or flowing through the lumen of the body member. In general, such a heating member may include at least one heating element which may be any of conventional heating wires and coils or any of those electromagnetically shielded heat generating systems as have been disclosed in the co-pending Applications, where the shapes, sizes, orientation and/or disposition of such heat generating systems may be slightly tailored in order to fit into the conduit, body, and/or heat exchange members of the system of the present invention. Therefore, such heat generating systems may be formed into the heating member of the system of this invention by having the shape and/or size determined by the various units and/or sections of the conduit and/or body members, by defining various layers and/or regions therealong or thereacross, by including various layers and/or regions of the heating element, MS, ES, and/or filler, and by defining one or more of the shapes of a wire, a strip, a sheet, a bundle thereof, a braid thereof, a mesh thereof, a coil thereof, a concentric configuration thereof, and so on.

The heating member of the hair drying system may also include one or more of the above heat generating systems arranged in various configurations. Within the scope of this invention, any of the above heat generating systems will be referred to as “heat element” hereinafter. It is appreciated that such a heat element is preferably disposed along a path in which the air may flow such that the heat generated by the heat element may be transferred to the air by conduction, convection or radiation.

It is appreciated that various heat elements are expected to not irradiate any significant amount of the MFs and/or EWs once they are provided according to the teachings described in the co-pending Applications. Accordingly, such heat elements may be formed into almost any shapes which will suit various conduit and/or body members of the hair drying system. However, such electromagnetically-shielded heat elements may raise the cost of the hair drying system until new technologies will have been developed to drop the manufacturing cost of electromagnetically shielded heat elements. Thus, various modalities are to be provided to effectively prevent or at least minimize the amount of the MWs and/or EWs irradiated by the heating members of the system.

In one example, the heating member may include one or more heat elements which are formed as a shape of a conventional solenoid which defines opposing ends and also includes multiple coils or loops of wire wound radially about its curvilinear longitudinal axis between such ends. The solenoid heat elements of the heating member may be disposed in an orientation for minimizing propagation of the MWs and/or EWs generated thereby toward the air outlet, toward a hand of the user through the grip portion, and so on, for such MFs of the solenoid are generally concentrated inside the coil of such a solenoid.

In another example, the heating member may include one or more heat elements which may be formed in a shape of a toroid which refers to a solenoid wound into a coil. Accordingly, such a toroid has a curvilinear axis, defines a periphery having opposing ends around the curvilinear axis, forms an outer lumen inside the periphery, forms the periphery by multiple coils or loops of wire wound radially about the axis, and defines an internal lumen inside the coils or loops. It is appreciated that the toroid heat element for the heating member of the present invention should be fabricated differently from its conventional counterparts.

In one respect, opposing ends of the toroid heat element are preferably disposed very close to each other and face each other. Similar to the solenoid, the toroid contains highly concentrated MFs inside its coil. Accordingly, a misaligned end of the toroid may serve as a major source of such MWs and EWs. When such ends of the toroid may be opposed to each other, at least a substantial portion of the MWs and EWs emitting from one end of the toroid tend to propagate into the other end thereof, thereby remaining inside the toroid and circulating along the internal lumen of the toroid. In addition, the less distance the opposing ends of the toroid are spaced apart from each other, the lesser amount of the MWs and EWs may leak out from the toroid. Accordingly, it is highly preferred that such opposing ends of the toroid be disposed close to each other and that such ends be flush with each other or, if not perfectly parallel to each other, oppose each other at the least angle. In this respect, conventional heating wire wound in a helical pattern may tend to irradiate the concentrated MWs and EWs through its opposing ends and to serve as the major sources of such wires. Accordingly, such a pattern is to be avoided.

In another respect, each of the coils or loops of wire of the toroid heat element may preferably have an identical dimension and be disposed at uniform intervals. In addition, the coils or loops of wire may preferably be wound to form a circular periphery in order to not form any irregularities therealong and to minimize irradiation of the MWs and/or EWs through such irregularities as well. In this respect, conventional patterns of winding the wire into the coils or loops defining the outer lumen with a cross-section of a rectangle, a square or other polygonal shapes may be avoided in the toroid heat element of the heating member of this invention.

In another respect and when the heating member requires the toroid having a peripheral length greater than a periphery of the conduit or body member, it is preferable to employ two or more of the above toroids of this invention than to employ a longer coils or loops or wire and wind it into the helical pattern (i.e., a helical toroid). As described hereinabove, the helical toroid tends to irradiate a massive amount of the MWs and EWs through its misaligned ends. Therefore, opposing ends of such a helical toroid may be brought together to face each other, and the amount of the MWs and EWs leaking out of the toroid may be minimized than keeping such ends loose and misaligned, when the helical winding pattern has to be employed. However, it is far preferable to splice the long coils or loops of wire into multiple groups, to define the same number of such circular, uniformly spaced toroids of this invention while keeping opposing ends of each toroid to be flush with each other, and then to electrically couple multiple toroids in a series or parallel arrangement. With this arrangement, each toroid will irradiate the very minimal amount of the MWs and EWs, and the toroid heat element composed of such toroids will emit the minimum amount of such waves as well. When desirable, adjacent toroids may be arranged to flow current in opposite directions in order to cancel any of the MWs and EWs leaking out of such toroids, when the coils or loops of wire of the toroids are wound in the same direction. Alternatively, the coils or loops of wire of adjacent toroids may be wound along opposite directions and the current may be arranged to flow along the same direction in order to achieve the same results.

The toroid heat element of this invention may also define other configurations which may keep the MWs and/or EWs in check. When the heating member includes two or more toroids, e.g., they may be stacked horizontally and/or vertically in such a way that the MWs and/or EWs leaking from adjacent toroids may cancel each other. In another example, the toroid may be formed not from a single strand of wire but from a pair of strands in which the current flows in opposite directions, thereby irradiation of the MWs and/or EWs may be minimized. In another example, the heating member may have multiple toroids so that at least a portion of one toroid may be disposed inside (or outside) at least a portion of another toroid. Such toroids may be arranged to have the coils or loops of wire wound in the same direction or opposite directions and the current may flow therethrough in opposite or same direction, thereby minimizing the MWs and/or EWs emitting toward the air outlet.

The heating member may be fabricated by disposing one or multiple heat elements with various shapes and/or sizes in various configurations as have been described in the co-pending Applications. For example, the heating member may be formed by layering or stacking multiple heat elements of the same or different shapes and/or sizes vertically or horizontally, while adjusting the direction of current flow and/or orientation of conductors in each element to optionally minimize irradiation of such waves. In another example, the heating member may also be formed by defining one heat element as an outer element and by disposing at least a portion of another heat element with the same or different shape and/or size inside the outer element. The direction of current flow and/or orientation of conductors in each element may also be adjusted to minimize irradiation of such waves as well. In any of the above examples, the heating member may include an extra electric conductor which may be disposed in or around the heat element, generate counter EM waves, and cancel at least portions of the MWs and/or EWs emitted by the heat element by the counter EM waves, where details of generating such counter waves will be provided in greater detail in conjunction with the counter member.

Regardless of detailed configuration of the heat elements of the heating member and number of such heat elements contained in such a member, the heat elements may also be disposed based on a preset arrangement in order to maximize the heat transfer from the heat elements to the flow of air. It is appreciated that at least a substantial portion of the heating member and/or its heat elements may be disposed along the conduit and/or body member through which the air flows and that an efficiency of heat transfer from the heating member and/or elements to air may be determined by various factors such as, e.g., configurations of the conduit and/or body members, length and/or disposition pattern of the heating member and/or heat elements, flow rate of air, contact area between the heating member or heat element and air, residence time and/or contact time for air through the heating member and/or heat element, and so on. In one embodiment where the heating element is formed as one or multiple toroids, the heating member may be oriented to allow the air to flow through the external lumens of the toroids and/or exterior of the peripheries thereof, where the direction of electric current may typically be irrelevant. In this case, each air stream may contact and receive heat from a specific loop of each toroid. In another example, the heating member may be disposed side by side in a series arrangement with respect to the air flow so that each air stream mat contact and receive heat from multiple loops of each toroid. In general, the heating member may be disposed in any orientation as long as such may increase the area of contact between the air and the heat elements thereof and as long as such may not adversely affect the shielding against the MWs and/or EWs.

The heating member may include at least one heat diffuser or distributor which may be capable of absorbing the heat from the heating member and then releasing the heat to the air for improving the heat transfer efficiency. The diffuser and/or distributor may contact the heating member and receive the heat through thermal conduction and/or may receive the heat from the heating member through the radiative heat transfer. Therefore, such a diffuser and/or distributor may offer a greater contact area with the air, thereby increasing the heat transfer efficiency. The heating member may also include at least one support to retain the heat elements in preset locations and/or orientations along the conduit and/or body members. Such a support may also be utilized as the diffuser or distributor.

The heat elements of the heating member may be shaped and sized for increasing the period of contact with air. In one example, the heat elements may be distributed over a greater portion of the conduit or body member to contact the air for a longer period. To this end, the heat elements may be spaced sparsely or, alternatively, may be arranged to have a longer length while generating less heat per length.

When the heating member generates such heat at least substantially through radiation, the MS and/or ES of the system may be arranged to selectively shield the EM waves generated by the heating member, i.e., allowing the waves of a preset frequency range to pass therethrough while preventing (or at least minimizing) propagation of other waves outside of the preset range therethrough. Various frequency-selective MS and/or ES have been described in the co-pending Applications.

In another aspect of the present invention, the hair drying system may include at least one heat exchange member along the conduit or body member in order to improve an efficiency of heat transfer between the heating member and air which flows through the heating member. As described above, the heat transfer efficiency may increase as a contact area between the heating member and air may increase, as the air may remain in contact with the heating member for a longer period of time, and the like. Accordingly, the heat exchange member may preferably be shaped and sized in order to improve such a contact area and time of contact (or “residence time” of the air inside such a member).

The heat exchange member may be disposed along the conduit or body member such that the air taken in by the actuator member through the air inlet may flow through the heat exchange member before the air is discharged through the air outlet. More specifically, the heat exchange member may be disposed between the air inlet and actuator member, between the actuator member and air outlet, and the like. At least a portion of the actuator member may be included inside such a heat exchange member or the air outlet may define at least a portion of a distal end of the heat exchange member. In view of various units of the body member, such a heat exchange member may be disposed only in the first or second unit or, alternatively, may encompass at least portions of both of the first and second units. The heat exchange member may be arranged to form a separate article and incorporated into a preset portion of the conduit or body member fixedly or releasably. The heat exchange member may alternatively have one or more baffles which may be incorporated into a preset portion of the conduit or body member to define additional air paths therein. In the alternative, the heat exchange member may occupy a preset portion of the system and be disposed between a distal portion and a proximal portion of the conduit or body member fixedly or releasably. Any of these heat exchange members may also be arranged to form an unitary article with at least a portion of the conduit or body member. In addition, any of these heat exchange member may be incorporated around, on or over an interior or an exterior of the conduit or body member.

In order to improve the heat transfer from the heating member to the air flowing therethrough, the heat exchange member may include a portion or an entire portion of the heating member therein or at least a portion of the heat change member may instead be enclosed by the heating member. It is to be understood in the former embodiment that an exterior of the heat exchange member may be made of and/or include at least one thermally insulative material in order to minimize heat loss across such a heat exchange member. When the air is arranged to exchange heat through the interior and exterior of the heat exchange member, such an insulative material may not necessarily be needed. In the latter embodiment, however, the exterior of such a heat exchange member may be made of and/or include at least one thermally conductive material in order to maximize heat transfer across the wall of such a heat exchange member. Another advantage by attaining higher heat transfer efficiencies is that such a system may need to generate less amount of heat by the heating member which in turn reduces the amount of the EM waves emitted by such a heating member, reduces the overall size of the system, and the like.

As described above, various heat exchange members may preferably be arranged to increase the contact area between the air and interior and/or exterior thereof, the contact area between the air and heating element, the time of contact (or residence time) of air inside heat exchange member, and so on. To this end, the heat exchange member is preferably arranged to define its own curvilinear air paths therein, where a length of the air paths is at least substantially longer than a length of the heat exchange member (or a distance between two opposing ends of the heat exchange member defined along the longitudinal axis of the conduit or body member). For example, a total length of the air paths defined in the heat exchange member may preferably be greater than the above distance by a preset ratio such as, e.g., 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.5, 4.0, 4.5, 5.0, 5.5, 6.0, 6.5, 7.0, and so on, where the longer the ratio, the longer period of time the air may flow inside the heat exchange member. Such air paths inside the heat exchange member may then be arranged in various configurations as will be provided below.

Therefore, the heat exchange member may be arranged to define one or more air paths which may define various tortuous shapes such as, e.g., an air path arranged in a zigzag pattern, an air path in a reciprocating pattern with one or more bends (or turns), another air path concentrically or helically wound about the interior of such a heat exchange member, and a combination pattern thereof, where each of such patterns may be planar (or two-dimensional) or three-dimensional and where at least a portion of the heating member and/or heat elements. The air taken in by the actuator member through the air inlet enters the heat exchange member through its inlet end, exits the heat exchange member through its outlet end, and then is discharged from the conduit or body member through the air outlet.

In one example, the heat exchange member may include multiple curvilinear baffles which are disposed on opposing interior walls of the heat exchange member in an alternating pattern in order to define the curvilinear air path with the zigzag pattern. The inlet and outlet ends of the heat exchange member are defined in opposing ends of the air path such that the air may enter the air path through the inlet end, travel the interior of the heat exchange member along alternating directions through each baffle, and then exit the heat exchange member through its outlet end.

Depending upon detailed configuration of the baffles and coupling modes thereof, air may flow through the heat exchange member along various directions. When the horizontal baffles couple with the proximal (or front) and distal (or rear) walls of the heat exchange member in an alternating mode, multiple horizontal air paths may be stacked vertically and the air may flow from top to bottom (or from bottom to top) according to the locations of the inlet and outlet ends. Accordingly, the air flows in the direction of the longitudinal axis of the conduit or body member between a pair of baffles and then in an opposite direction between a next pair of baffles alternatingly. When the same horizontal baffles couple with the side walls of the heat exchange member alternatingly, multiple horizontal air paths may be stacked vertically and the air may again flow from top (or bottom) to bottom (or top). However, the air flows in the direction which is transverse to the longitudinal axis of the conduit or body member. When the vertical baffles may couple with the proximal and distal walls of the heat exchange member in an alternating mode, multiple vertical air paths may be stacked horizontally (or side by side) and the air flows from left to right (or vice versa) based on the location of the inlet and outlet ends. Therefore, the air flows in the direction of such a longitudinal axis between a pair of baffles and in an opposite direction between a next pair of baffles alternatingly. When the vertical baffles couple with the sides of the heat exchange member alternatingly, multiple vertical air paths may be stacked horizontally but the air flows in the direction transverse to such an axis.

In addition to the foregoing examples, the baffles may couple with the distal wall, proximal wall or sides of the heat exchange member at an acute or obtuse angle and define air paths transverse to the longitudinal axis of the conduit or body member at the similar angle. In another example of the heat exchange member including multiple baffles, two or more baffles may have different shapes, sizes or curvatures, may couple with various portions of the heat exchange member at different angles, and so on. In addition, such a heat exchange member may include multiple zones in each of which multiple baffles are arranged as described above and in at least two of which such baffles couple with the same or different portions of the heat exchange member along the same or different directions.

In another example, the air paths may be comprised of multiple straight portions or may instead include one or more curved portions. For example, when the above air paths may be defined by such baffles and planar walls of the heat exchange member, such air paths may be planar as well. When the baffles or walls of the heat exchange member are curved, however, at least a portion of such air paths may be curved. Similarly, the air paths may be defined angularly with respect to the longitudinal axis of the conduit or body member with curvilinear baffles and/or walls. Angular or curved air paths may also be formed without employing any baffles at all or without using any curved baffles, e.g., by injecting the air against the walls at a preset angle and forming an air flow swirling around the interior of the heat exchange member along a curvilinear trajectory.

In another example, the heat exchange member may be embodied as a mixing portion along the conduit or body member, where the mixing portion may define a cross-sectional area greater than its neighboring portions which lie immediately close to the mixing portion. The main function of the mixing portion is to form a space in which the air may circulate for an extended period of time along a preset air path or streamline determined by various fluid mechanical variables.

Once such air paths are defined in the heat exchange member, the heat element of the heating member may be incorporated in various orientations with respect to the air paths. For example, when the heat exchange member has the baffles, the heat element may be disposed along at least a portion of the air paths. In the alternative, the heat element may instead be disposed across at least a portion of one or more air paths. When the heat exchange member may not include any baffles therein, such a heat element may be disposed along at least a portion of various streamlines of the air defined in the heat exchange member or, in the alternative, across at least a portion of such streamlines. Therefore, at least a portion of the heat element may be parallel, perpendicular or transverse to the air path of the heat exchange member and/or longitudinal axis of the conduit or body member.

The heat exchange member may include at least one heat diffuser or distributor which may be capable of absorbing the heat from the heating member and releasing the heat to the air for improving the heat transfer efficiency. The diffuser or distributor may contact the heating member and receive the heat through thermal conduction and/or may receive the heat from the heating member through the radiative heat transfer. Thus, the diffuser or distributor may offer a greater contact area with the air, thereby increasing the heat transfer efficiency inside the heat exchange member. The heat exchange member may also include at least one support for retaining the heat element in preset locations and/or orientations along the conduit and/or body members. The support may also be utilized as the diffuser or distributor.

Various MS's and/or ES's also be disposed over, on, around or into an interior and/or exterior of the heat exchange member. When the MS and/or ES are exposed over the heat exchange member, the MS and/or ES may enclose only a portion of such a member, enclose an entire portion thereof, and the like. In addition, the MS and/or ES may extend beyond the distal and/or proximal ends of the heat exchange member. Because the heat exchange member may operate at a high temperature, the MS and/or ES may be made of and/or include at least partially refractory materials or may be protected by such materials.

When the heating member generates such heat at least substantially through radiation, the MS and/or ES of the heat exchange member may be arranged to selectively shield the EM waves emitted by the heating member, i.e., allowing the waves of a preset frequency range to pass therethrough but preventing or at least minimizing propagation of other waves outside of the preset range therethrough. Various frequency-selective MS and/or ES have been described in the co-pending Applications.

In another aspect of the present invention, the hair drying system may incorporate at least one counter member into various portions thereof in order to generate various counter EM waves capable of canceling at least portions of the EM waves emitted by various wave sources of the system such as, e.g., the actuator member, heating member, and cables or wires of the rest of the system. As far as the counter member may generate such EM waves which propagate in a direction which is at least partially opposite to directions of the EM waves irradiated by the wave sources of such a system, the counter member may be formed by one or more of various members of the system or, alternative, may be provided as a separate member. It is appreciated in the following embodiments that a main function of the counter member is to cancel at least portions of the EM waves of the wave sources but not to interfere with normal operation of the wave sources. Accordingly, intensity of the counter EM waves may have to be selected enough to minimize the EM waves of the wave sources propagating toward the air outlet and/or target but not so strong enough to interfere the operations of such wave sources. It is also appreciated that the counter member, regardless of its types, includes at least one electric conductor capable of irradiating the counter EM waves of a preset intensity.

In one embodiment, one of the wave sources of the system may be used as a counter member for another wave source. For example, at least one wire of the stator of the actuator member may be arranged to extend around or across the interior and/or exterior of the heating member along a preset direction or orientation and emit the counter EM waves which may cancel the EM waves irradiated by the actuator member. In a reverse example, at least one wire of the heating element may be arranged to extend around or across the interior and/or exterior of the actuator member along a preset direction or orientation and emit the counter EM waves which may cancel the EM waves emitted by the heating member. It is to be understood that such a wire generating the counter EM waves may be arranged to have the same electric and/or magnetic properties as the rest of such a member or may instead have different electric and/or magnetic properties. For example, the heat element of the heating member may include an extra portion which may not have the requisite resistivity and may not generate such heat as the current flows therein. By disposing such an extra portion around or across the actuator member, the heating member may generate the counter EM waves while not increasing temperature around or across the actuator member. In another example, other wires of the system may serve as the counter member for the actuator and/or heating members. Such wires may be any of the power cables to various members of the system, cables used for controlling operations of such members of the system, and the like.

In another embodiment, a separate counter member may be provided to generate such counter EM waves. As described above, such a counter member may include at least one electric conductor which may extend over a preset length along its curvilinear longitudinal axis, define a cross-section of any shapes and/or sizes, form one or more of various shapes such as, e.g., a wire, a strip, a sheet, a bundle thereof, a stack thereof, a braid thereof, a mesh thereof, a concentric article thereof, and the like, where each of such shapes may include at least one conductive material or conductor. Such a counter member may be oriented as a curvilinear line extending longitudinally and/or radially, winding concentrically or helically, forming a mesh-shaped pattern, forming one of an inner article and an outer article of various concentric configurations, and so on. The counter member may also include multiple sections which may bifurcate or merge each other. In general, disposition of the counter member may depend upon which parts of the system or which direction along the system is to be protected, e.g., whether to protect the line of sight between the air outlet and wave sources, whether to protect the user from the EM waves irradiating through the sides of the system, and the like. Accordingly, such a counter member may be disposed and oriented in a location and/or direction such that the counter EM waves may match the planes of propagation of the MWs and EWs of the EM waves emitted by such wave sources. In addition, the counter member may be disposed alongside, over, and/or under such waves sources. Alternatively, the counter member may be arranged to enclose or to be enclosed by the wave sources.

When the actuator member is a DC motor including a rotor and at least one permanent magnet, the counter member may be provided as a conductor disposed over the magnet at a preset distance. When the actuator member is an AC motor including a stator and a rotor, the counter member may be provided as a conductor disposed over the stator at a preset distance. Whether the counter member is to irradiate the counter waves against the EM waves emitted by the actuator member or the heating member, the intensity of the counter waves may generally be weaker than that of the EM waves from the actuator and/or heating members so as to ensure normal operation of such wave sources. When desirable, however, the counter waves may be arranged to have the intensities equivalent to or even greater than those of the EM waves irradiated by the wave sources. For example, the intensity of the counter waves may be stronger than one but not both of such EM waves emitted by the actuator and heating members. In another example, the intensity of the counter waves may be stronger than each EM wave from the actuator and heating members but not stronger than a sum of such waves. In yet another example, the intensity of the counter waves may be stronger than the sum of the EM waves emitted by the actuator and heating members. In addition, the counter member may be arrange to vary the intensities of the counter waves as well depending on the settings of the heating and/or actuator members chosen by the user or determined automatically by a controller. Moreover, the system may include a controller capable of monitoring the intensities of the EM waves emitted by the actuator and heating members and then adaptively control the intensity of the counter waves accordingly. It is to be understood that the intensities of the EM waves are a strong function of the distance between the wave source and a measurement location. Accordingly, the above criteria for the intensities of such counter waves may be based on those measured in a vicinity of the actuator, heating, and/or counter members, measured at the air outlet or side of the system, measured at the target, and the like.

The counter member may draw the electric current in various configurations. For example, the counter member may draw the current from the actuator or heating member, may draw such current from the actuator (or heating) member then supply such current to the heating (or actuator) member, may draw the current from a power source and then supply the current to the heating and/or actuator members in any sequence, or may even draw the current from another power source which may not supply the current to the actuator and heating member directly or indirectly. It is appreciated that the system may also include a phase converter which may change the phase angle of the AC current by about 180°. Such a converter may then change the phase angle of the input current and supply such current to the counter member which may emit the counter waves canceling at least portions of the EM waves from the wave sources.

In another aspect of the present invention, the hair drying system may include at least one MS and/or at least one ES for preventing (or at least minimizing) the MWs and/or EWs emitted by the wave sources from propagating through the air outlet and/or sides of the system. Such MS and ES may be any of the sources which have been described in the co-pending Applications. For example, the MS may shield the target from the MWs emitted by the wave sources through one or more of mechanisms described in the co-pending Applications. The MS may include at least one path member and at least one magnet member, may include the path member but no magnet member, or may include the magnet member but no path member, where details of both of such members have been disclosed in the co-pending Applications. When such a system includes multiple MS's, the path members of at least two of the MS's may be arranged to include the same, similar or different paths of the magnetic waves, to include the same, similar or different materials each of which may define the same, similar or different magnetic permeabilities, respectively, and the like. Similarly, when the system includes multiple MS's, the magnet members of at least two of the MS's may also be arranged to include the same, similar or different number of permanent magnets therein, to define the same, similar or different number and/or arrangement of magnetic poles, and so on. The ES may shield a target from EWs through one or more of mechanisms which have been described in the co-pending Applications. When the heating member may be disposed closer to the air outlet while the actuator member may be disposed closer to the air inlet, the MS may be disposed between the air outlet and heating member or between the heating and actuator members. The system may also include at least one MS (and ES) between the air outlet and heating member and at least one MS (and ES) disposed between the heating and actuator members. When the heating member may be disposed closer to the air inlet and the actuator member may be disposed closer to the air outlet, the MS may be placed between the air outlet and actuator member or between the actuator and heating members. The system may also include at least one MS (and ES) between the air outlet and actuator member and at least another MS (and ES) disposed between the actuator and heating members.

The system may incorporate therein at least one MS but not ES, at least one ES but not MS, at least one MS and at least one ES on, over, around, and/or into at least a portion of the conduit, body, heating, and actuator members. In particular, the MS and ES may be disposed in the same, adjacent or different locations of the system.

When the conduit and/or body members include the aforementioned baffle and/or bend, the MS and ES may be disposed anywhere, e.g., on, over, around, and/or inside the baffles, bends, conduits, around outlet, periphery of the first unit, second unit, and the like. The MS (and ES) may be disposed over at least a (or entire) portion of the baffle. The MS (and ES) may be disposed along the bend or away therefrom. The system may have at least two baffles at least one of which may include the MS (and ES) and at least another of which may not include the MS (and ES). The system with the mobile member (or section) may not include any of the MS and ES, may include the MS but not ES, may have the ES but not MS, or both of the MS and ES. In addition, the system may be arranged to emit through the air outlet the MWs having a magnetic field strength no stronger than a preset limit when measured at a preset distance from the air outlet, where the preset limit may be 0.1 mG, 0.2 mG, 0.3 mG, 0.5 mG, 0.7 mG, 1 mG, 2 mG, 3 mG, 4 mG, 5 mG, 7 mG, 10 mG, and the like, while the preset distance may be 0.1 cm, 0.2 cm, 0.5 cm, 1 cm, 2 cm, 3 cm, 5 cm, 7 cm, 10 cm, 15 cm, 20 cm, 25 cm, 30 cm, and the like. In addition, depending upon the setting for air flow rate and heat and/or temperature of the heated air, the system may be arranged to vary the distance between its air inlet and outlet, adjust a capacity of shielding by adjusting positions of the MS and/or ES, adjusting a degree of overlapping therebetween, adjusting the distance between such shields, and so on.

In another aspect of the present invention, the hair drying system may also include at least one article which may be arranged to releasably couple with or to be retrofit into the air outlet and/or distal portion of the conduit and/or body members. Such an article may define an inlet end and an outlet end such that its inlet end couples with the air outlet of the system and that the heated air is supplied from the air outlet into the article through its inlet end and then discharged out of the article through its outlet end, thereby rendering its outlet end serve as a new air outlet of the system. The main purpose of the article is to increase the distance between the new air outlet and wave source of the system, thereby dispersing more EM waves emitted by the wave source away from the new air outlet while minimizing heat less thereacross. Another purpose of the article is to prevent (or at least minimize) any residual MWs and/or EWs irradiated by the wave sources from propagating through the new air outlet through incorporating at least one MS and/or ES into at least a portion of the article. Such an article may also be provided in various configurations.

For example, such an article may include at least one baffle which may be similar or identical to that described above. Therefore, such an article may be arranged to prevent or at least minimize the formation of the line of sight between its outlet end and the wave sources of the system. The article may also include the MS and/or ES whether or not the conduit or body member may include the similar or different MS and/or ES. When the conduit or body member includes only the MS (or ES) but not the ES (or MS), the article may complement such a configuration by including the ES (or MS). The article may include multiple MS's and/or baffles at least two of which may be disposed in different portions of the body. Similarly, the article may include the MS and ES disposed in the same, adjacent or different locations of the article. Such an article may also be arranged to keep the intensity of the MWs emitted from the wave sources below a preset limit when measured at a preset distance from its outlet end, where such a preset limit may be 0.1 mG, 0.2 mG, 0.3 mG, 0.5 mG, 0.7 mG, 1 mG, 2 mG, 3 mG, 4 mG, 5 mG, 7 mG, 10 mG, and the like, while the preset distance may be 0.1 cm, 0.2 cm, 0.5 cm, 1 cm, 2 cm, 3 cm, 5 cm, 7 cm, 10 cm, 15 cm, 20 cm, 25 cm, 30 cm, and the like.

In another aspect of the present invention, such a hair drying system may include at least one power conversion member which is arranged to convert an AC voltage and current into a DC voltage and current. Such a power conversion member typically includes a conventional rectifier to filter only a portion of the AC voltage and current of the same polarity and may optionally include a conventional capacitor or other electronic element capable of smoothening the pulse-shaped voltage and current to the voltage and current of at least substantially flat voltage and current. It is appreciated that such a power conversion member supplies the DC or pseudo-DC current to the heating member and reduces the MWs and EWs irradiated thereby. However, the actuator member includes a rotor which emits the MWs and EWs regardless of whether such a member is supplied with the AC or DC, for such a rotor rotates and varies propagation direction of the MFs and EFs, thereby irradiating such MWs and EWs. Thus, the power conversion member may have a limited effect on reducing the amounts of the MWs and EWs from the actuator member.

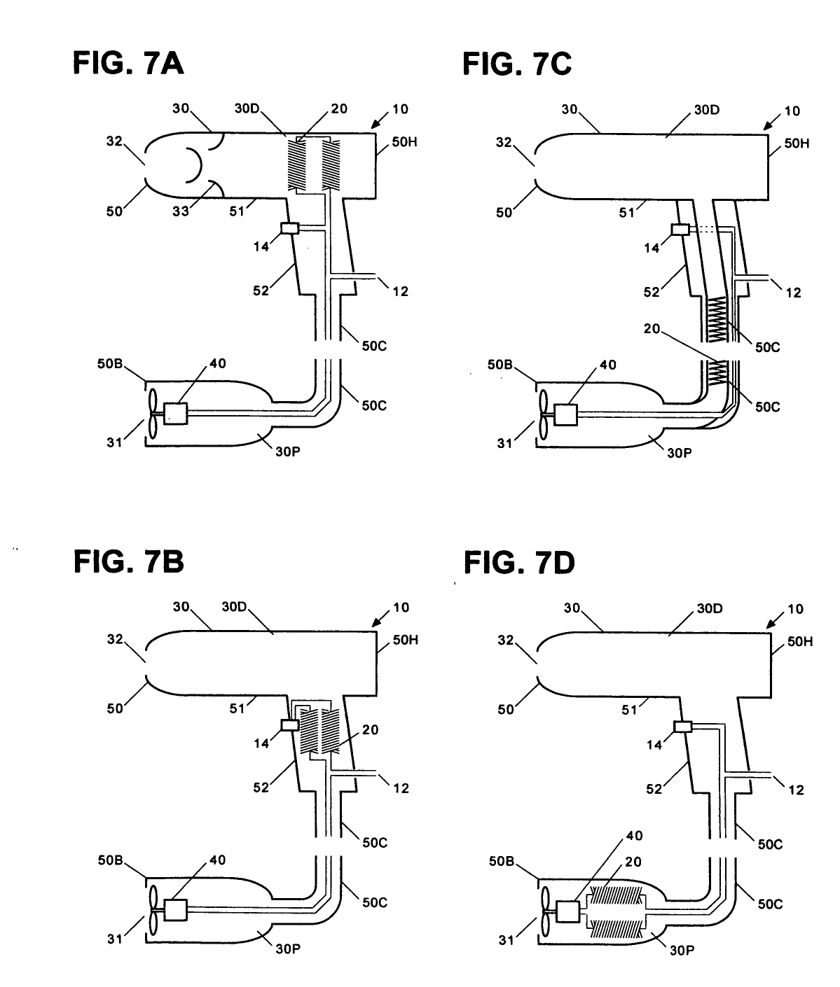

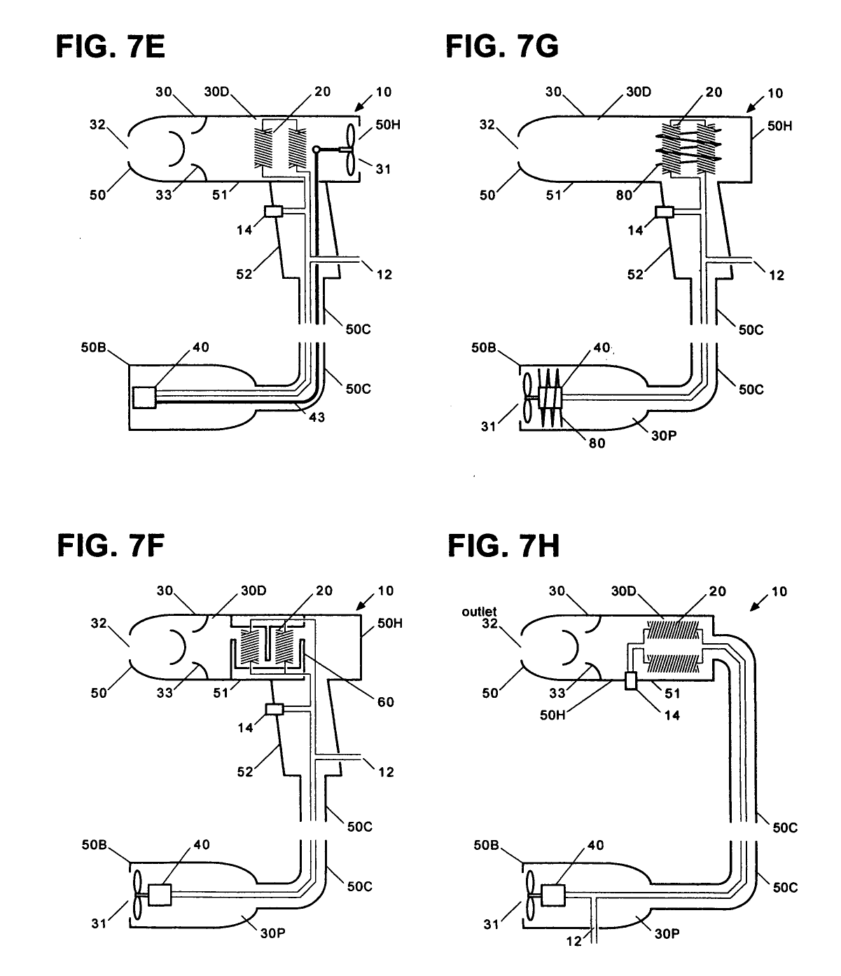

In another aspect of the present invention, a hair drying system may also have a body member which may in turn include at least one base unit and at least one hand unit which may movably couple with the base unit in order to move (e.g., translate, reciprocate, rotate, pivot, and the like) with respect to the base unit. The system also has at least one actuator member and at least one heating member, where the actuator member may take air into a conduit (or air path) through an air inlet, transporting air through the air path, and then discharge air through an air outlet and wherein the heating member may be incorporated in a preset relation to the air path, generate heat, and then transfer at least a portion of such heat to the air flowing through the air path. The hand unit of the body member may define the air outlet therein and generally form a grip for an user thereon, while the base unit may couple with a separate object. The system may then incorporate one or both of the actuator and heating members into the base unit for various purposes such as, e.g., making the hand unit lighter and/or smaller than the base unit or than a hand unit including such members, allowing an user to more readily wield the hand unit, minimizing intensities of the MWs and EWs emitted by the actuator and/or heating members and propagating through the air outlet or other parts of the system, suppressing formation of the lines of sight between the air outlet and the actuator and/or heating members, suppressing noise generated by the actuator member, and the like. Further advantages of the hair drying system of such an aspect of the invention will be described in greater detail in conjunction with FIGS. 7A to 7H which are cross-sectional views of exemplary hair drying systems each including at least one hand unit, at least one base unit, and at least one optional coupling unit according to the present invention.

In one exemplary embodiment of this aspect of the invention, a hair drying system may include a body member with a hand unit, a coupling unit, and a base unit, where an actuator member may be disposed in the base unit. As shown in FIG. 7A, a hair drying system 10 include a heating member 20 and an actuator member 40 which are similar to those of the above figures. The system 10 also has a body member 50 which defines a hand unit 50H, a coupling unit 50C, and a base unit 50B, where the hand unit 50H in turn defines an elongated first unit 51 and a transverse second unit 52 both of which are similar to those of the above figures. The heating member 20 is disposed in the first unit 51 of the hand unit 50H, the actuator member 40 is disposed in the base unit 50B, while an on-off switch 14 is disposed in the second unit 52 of the hand unit 50H. The conduit member 30 is generally distributed in both of the hand and base units 50H, 50B. More specifically, an air inlet 31 is formed in one end of the base unit 50B, and a proximal air path (or conduit) 30P is defined from the air inlet 31 to another end of the base unit 50B. Similarly, an air outlet 32 is defined in one end of the first unit 51 of the hand unit 50H, while a distal air path (or conduit) 30 is formed from the air outlet 32 to another end of the hand unit 50H. The coupling unit 50C is then disposed between the hand and base units 50H, 50B in order to fluidly couple or connect the distal and proximal air 30D, 30P, thereby forming the air path from the air inlet 31 to the air outlet 32. A power cable 12 is also incorporated into the system 10 through, e.g., the second unit 52 of the hand unit 50H, runs to the heating member 20 through the distal air path 30D, and also runs to the actuator member 40 through the coupling unit 50C and proximal air path 30P.

The hand unit 50H is generally similar to those exemplified in the foregoing figures so that such a unit 50H may include the first and second units 51, 52, define the air paths through at least portions of the first and second units 51, 52, form the air outlet 32 in one end of the first unit 51, include one or more baffles 33 along the distal air path 30D when desirable, provide a grip portion in the second unit 52 for the user of the system, and incorporate the switch 14 in the grip portion. The hand unit 50H of this figure is generally similar to the body members of FIGS. 1D and 1E. Because the heating member 20 is disposed in the first unit 51 of the hand unit 50H, at least a portion of the first unit 51 adjacent to the heating member 20 may preferably be made of and/or include materials which may endure against the heat generated by the heating member 20. When desirable, insulative materials may be disposed around the heating member 20 and insulate walls of the first unit 51 from such heat.

The coupling unit 50C may preferably be made of and/or include certain materials and/or may have certain configurations in order to exhibit certain mechanical properties. In one example, at least a portion of the coupling unit 50C may be arranged to be flexible or deformable such that the hand unit 50H may be disposed in almost any position and/or any orientation with respect to the base unit 50B as long as a length of the coupling unit 50C may allow. In another example, such a coupling unit 50C may include multiple rigid sections (not shown in the figure) which are movably coupled to each other so that the hand unit 50H may similarly be disposed in any position and/or orientation with respect to the base unit 50B. In another example, at least a portion of the coupling unit 50C may be arranged to be made of and/or include a deformable material or, alternatively, may define a configuration capable of allowing the hand unit 50H to move its position and/or orientation with respect to the base unit 50B and to maintain or hold its position and/or orientation. When desirable, an external support (not shown in the figure) may be disposed around the coupling unit 50C to maintain the position and/or orientation of the hand unit 50H. It is appreciated that the heating member 20 is disposed in a position distal to the coupling unit 50C and that a major function of the coupling unit 50C is to fluidly connect the proximal air path 50P to the distal one 50D or, in other words, to form an inbetween air path for the air taken in by the actuator member. Because such air is typically in room temperature, the coupling unit 50C may be made of and/or include materials which may exhibit at least a minimal mechanical strength but may not necessarily be thermally resistant.

The coupling unit 50C may define therein a single lumen through which the air may flow from the base unit 50B to the hand unit 50H and the cable 12 may run from a power source (not shown in the figure) to the actuator member 40. Alternatively, the coupling unit 50C may define two different lumens one of which is for the air and the other of which is for the cable 12. The coupling unit 50C may also be arranged to fixedly couple with the hand and/or base units 50H, 50B. In the alternative, one or both ends of the coupling unit 50C may include couplers (not shown in the figure) capable of releasably coupling with matching ends of the hand and base units 50H, 50B.

The main function of the base unit 50B is to incorporate therein at least a portion of one or both of the heating and actuator members 20, 40 and to be disposed away from the hand unit 50H defining the air outlet 32 therein, thereby reducing an amount of the MWs and EWs irradiated by such sources 20,40 as well as minimizing an intensity of the MWs and/or EWs propagating through the air outlet 32. When the base unit 50B includes the actuator member 40 as described in this figure, the base unit 50B also defines the air inlet 31 on one or more of its sides. In order to be disposed by itself, such a base unit 50B may preferably be arranged to fixedly or releasably couple with another object which may be stationary or mobile and examples of which may include, but not be limited to, a chair with or without a back rest, a stool, a vanity, a drawer, a mirror, a cabinet, a shelf, a wall, a door, a ceiling, a floor, and any other furniture and/or parts of structures. To this end, the base unit 50B may include one or more couplers (not shown in the figure) which may be mechanically or magnetically coupled to the object. In the alternative, such a base unit 50B may be arranged to define a flat bottom surface which may be able to provide stability when the base unit 50B is placed thereon or may also be arranged to include legs which may be able to support itself. When desirable, the base unit 50B may include one or more wheels or canisters as well.

In operation, the hand unit 50H and base unit 50B are fluidly coupled by the coupling unit 50C so that the air path may be established from the air inlet 31, through the proximal air path 30P, through the coupling unit 30C, through the distal air path 30D, and to the air outlet 32. The heating member 20 is then incorporated in the distal air path 30D formed in the hand unit 50H, and the actuator member 40 is incorporated into the proximal air path 30P formed in the base unit 50B. The baffles 33 may then be disposed along the distal air path 30D in order to suppress formation of line of sights from the heating member 20 to the air outlet 32. In addition, the MS and/or ES may be installed along or incorporated in preset locations of the hand unit 50H in order to minimize the MWs and/or EWs emitted by the heating member 20 from propagating through the air outlet 32. The user may then dispose the base unit 50B in a location which is not preferably close to himself or herself or may couple the base unit 50B with the stationary or semi-stationary object. As the user turns on the switch 14, the power is supplied to the heating and actuator members 20, 40 through the cable 12. The actuator member 40 begins to rotate its impeller and generates a pressure difference between the proximal air path 30B and ambient air, where such a pressure gradient serves as the driving force for taking ambient air into the proximal air path 30P of the base unit 50B through the air inlet 31 and for transporting air through the coupling unit 30P and the distal air path 30D toward the air outlet 32. During this operation, a motor of the actuator unit 40 constantly emits the MWs and EWs. Because the base unit 50B is disposed farther away from the user, however, a greater portion of such waves may propagate away from the air outlet 32 and user. Those MWs and EWs propagating toward the air outlet 32 and user may also be shielded by the MS and ES by various mechanisms as described in the co-pending Applications. As the air moves to the distal air path 30D and reaches the heating element 20, such air absorbs at least a portion of such heat generated by the heating element 20, gets heated, and is discharged through the air outlet 32 as a flow of heated air. It is expected that the heating element 20 may also emit the MWs and EWs during its heating operation. However, emission of such waves may be minimized by forming such a heating element 20 according to various embodiments provided in the co-pending Applications. Any remaining portion of the MWs and EWs from the heating element 20 may be shielded by the MS and ES according to various mechanisms of the co-pending Applications. The user may then position the hand unit 50H of the system 10 along a desirable direction, and the flow of heated air may be directed to his or her hair, while the MWs and EWs irradiated by the wave sources 20, 40 may be weakened because of a greater distance from such sources to the user and/or shielded by the MS and ES of the system 10. Accordingly, such a system 10 may not only protect the user from the MWs and EWs from its wave sources 20, 40 but also allow the user to handle the hand unit 50H which is lighter and/or smaller.

In another exemplary embodiment of this aspect of the present invention, a hair drying system similarly includes a body member with a hand unit, a coupling unit, and a base unit, where an actuator member may be disposed in the base unit, while a heating member may be disposed in a grip portion of the hand unit. As shown in FIG. 7B, a system 10 is generally similar to that of FIG. 7A and includes a heating member 20, a conduit member 30, an actuator member 40, and a body member 50, where the body member 50 includes a hand unit 50H, a coupling unit 50C, and a body unit 50B, except that at least a substantial portion of the heating member 20 is disposed inside the second transverse unit 52 of the hand unit 50H. Accordingly, such a grip portion of the hand unit 50H may preferably be made of and/or include the thermally resistant materials which may endure such heat generated by the heating member 20 or, in the alterative, may include such insulative materials around the heating element 20, thereby protecting the grip portion of the hand unit 50H and cables 12 running therethrough from such heat. Because the flow of heated air also flows through the first unit 51 of the hand unit 50H, at least a portion of the distal air path 30D of the first unit 51 may also be made of and/or include the thermally resistant and/or insulative materials. It is appreciated in this embodiment that the heating element 20 is disposed farther away from the air outlet 32 than that of FIG. 7A and, accordingly, a greater portion of the MWs and/or EWs may be dispersed away from such an air outlet 32. Other configurational and/or operational characteristics of the system 10 of FIG. 7B are similar or identical to those of the system of FIG. 7A.

In another exemplary embodiment of this aspect of the present invention, a hair drying system may include similar members and/or units, where an actuator member may be disposed in a base unit, and a heating member may be disposed along a coupling unit. As described in FIG. 7C, a system 10 is typically similar to that of FIG. 7A and includes a heating member 20, a conduit member 30, an actuator member 40, and a body member 50, where the body member 50 has a hand unit 50H, a coupling unit 50C, and a base unit 50B. However, at least a substantial portion of the heating member 20 may be disposed along the conduit member 30C and, therefore, transfer heat generated thereby onto the air flowing therethrough. Therefore, the coupling unit 50C may preferably be made of and/or include the thermally resistant materials which may endure such heat or, alternatively, may instead include such insulative materials around the heating element 20, thereby protecting not only the coupling unit 50C but also the cables 12 running therethrough. Because the flow of heated air flows through the hand unit 50H, the distal air path 30D of the hand unit 50H may also be made of and/or include the thermally resistant and/or insulative materials. It is appreciated in this embodiment that the heating element 20 is disposed farther away from the air outlet 32 than those of FIGS. 7A and 7B and, therefore, that a far greater portion of the MWs and EWs may be dispersed away from the air outlet 32. It is appreciated that various cables 12 running through the coupling unit 50C may not endure the heat from the heating member 20 or that including thermally protected cables may raise a cost of the system 10. In order to obviate these problems, the coupling unit 50C may define multiple lumens through one of which the cables 12 may run and in the other of which the heating element 20 may be disposed and transfer the heat onto the air flowing therethrough. Even in such an embodiment, the lumen for the cables 12 may need to be thermally insulated from the other lumen as well. Other configurational and/or operational characteristics of the system 10 of FIG. 7C are similar or identical to those of the systems of FIGS. 7A and 7B.

In another exemplary embodiment of this aspect of the present invention, a hair drying system may include similar members and units, where both of an actuator member and a heating member may be disposed in a base unit. As described in FIG. 7D, a system 10 is typically similar to that of FIG. 7A and includes a heating member 20, a conduit member 30, an actuator member 40, and a body member 50 which in turn includes a hand unit 50H, a coupling unit 50C, and a base unit 50B. However, such a base unit 50B is arranged to include therein both of the heating and actuator members 20, 40 so that the air taken in through an air inlet 31 into a proximal air path 30P may be immediately heated by such a heating member 20, transported to a distal air path 50D through the coupling unit 50C, and discharged through an air outlet 32. Therefore, such air paths 30P, 50C, 30D may also be made of and/or include the thermally resistant materials which may endure such heat. It is appreciated in this embodiment that the heating element 20 is disposed farther away from the air outlet 32 than those shown in FIGS. 7A to 7C and, therefore, that a far greater portion of the MWs and EWs may be dispersed away from the air outlet 32. In addition, the cable 12 may be thermally protected or, in the alternative, the coupling unit 50C may define multiple lumens through one of which the cables 12 may run and in the other of which the heating element 20 may be disposed and transfer the heat to the air flowing therethrough. Other configurational and/or operational characteristics of the system 10 of FIG. 7D are similar or identical to those of the systems of FIGS. 7A to 7C.

In another exemplary embodiment of this aspect of the present invention, a hair drying system may include similar members and/or units, in which a motor and an impeller of its actuator member may be disposed in different units. As shown in FIG. 7E, a system 10 is generally similar to that of FIG. 7A and includes a heating member 20, a conduit member 30, an actuator member 40, and a body member 50 which includes a hand unit 50H, a coupling unit 50C, and a base unit 50B. The actuator member 40 also includes a motor (denoted by a rectangular block), an impeller, and a power transmission line (or an axle) 43, where the motor is disposed in the base unit 50B, the impeller is disposed in the hand unit 50H, and the axle 43 mechanically couples the impeller to the motor. Therefore, the motor generates a torque which is then transmitted to the impeller by the axle 43. In general, the axle 43 may be provided by any conventional power transmission assembly such as, e.g., a gear assembly, an universal joint, and so on. It is appreciated that ambient air is taken into the air path of the system 10 by the impeller which is disposed in one end of the hand unit 50H and that the system 10 of this embodiment defines the air path starting from an air inlet 31 of the hand unit 50H, extending through a distal air path 30D of the hand unit 50H, and terminating at an air outlet 32 of the hand unit 50H. Accordingly, the base and coupling units 50B, 50C may form a single lumen not for the air but for the cable 12.

In operation, the hand unit 50H is provided to define the air path from its air inlet 31, through its proximal air path 30P, and then to its air outlet 32. The impeller of the actuator member 40 is disposed proximal or distal to the air inlet 31. The heating member 20 is also incorporated into the the hand unit 50H, and the hand unit 50H is mechanically coupled to the base unit 50B through the coupling unit 50C. The motor of the actuator member 40 is incorporated into the base unit 50B and the cables 12 are also connected to the heating and actuator members 20, 40 to supply electric power thereto. The baffles 33 may then be disposed along the distal air path 30D in order to suppress formation of line of sights from the heating member 20 to the air outlet 32. In addition, the MS and/or ES may be installed along or incorporated in preset locations of the hand unit 50H in order to minimize the MWs and/or EWs emitted by the heating member 20 from propagating through the air outlet 32. The user may then dispose the base unit 50B in a location which is not preferably close to himself or herself or may couple the base unit 50B with the stationary or semi-stationary object. As the user turns on the switch 14, the motor of the actuator member 40 begins to rotate and generates a torque. The axle 43 transmits the torque to the impeller which generates a pressure difference between the distal air path 30D and ambient air, where the pressure gradient serves as the driving force for taking ambient air into the distal air path 30P of the hand unit 50H through the air inlet 31 and for moving the air toward the air outlet 32. During this operation, a motor of the actuator unit 40 constantly emits the MWs and EWs. Because the base unit 50B is disposed farther away from the user, however, a greater portion of such waves may then be dispersed away from the air outlet 32 and user. Those MWs and EWs propagating toward the air outlet 32 and user may also be shielded by the MS and ES by various mechanisms as described in the co-pending Applications. As the air reaches the heating element 20, it absorbs at least a portion of the heat generated by the heating element 20, gets heated, and is discharged through the air outlet 32. The MWs and EWs emitted by the heating member 20 during its heating operation may be minimized by forming the heating element 20 as described in the co-pending Applications. Any remaining portion of such waves from the heating element 20 may also be shielded by the MS and ES according to various mechanisms of the co-pending Applications. The user may position the hand unit 50H of the system 10 along a desirable direction, and the flow of heated air may be directed to his or her hair, while the MWs and EWs emitted by the wave sources 20, 40 may be weakened because of a greater distance from such sources to the user and/or shielded by the MS and ES of the system 10. Accordingly, this system 10 not only protects the user from the MWs and EWs emitted by its wave sources 20, 40 but also allows the user to handle the hand unit 50H which is lighter and/or smaller. Other configurational and/or operational characteristics of the system 10 of FIG. 7E are similar or identical to those of such systems of FIGS. 7A to 7D.

In another exemplary embodiment of this aspect of the present invention, a hair drying system may also include other members in addition to those members and/or units of the systems of FIGS. 7A to 7E for the purpose of reducing amounts of such MWs and EWs which may be irradiated by various sources, which may propagate toward the air outlet and/or user, and the like. In one example of FIG. 7F, a system 10 is similar to that of FIG. 7A and includes a heating member 20, a conduit member 30, an actuator member 40, and a body member 50 which includes a hand unit 50H, a coupling unit 50C, and a base unit 50B. However, at least a substantial portion of the heating member 20 is enclosed in a heat exchange member 60 which is incorporated in a distal air path 30D of a first unit 51 of the hand unit 50H. Accordingly, the heating member 20 may transfer the heat to the flow of air at a higher heat transfer efficiency and may require a less amount of heating elements therein than the system without such a member 60 per the same wattage, thereby reducing the amounts of the MWs and EWs emitted thereby. As described hereinabove, the heat exchange member 60 may also be incorporated in other locations of the system 10 such as, e.g., in a second unit 52 of the hand unit 50H, in the coupling unit 50C, in the base unit 50B, and the like. The heat exchange member 60 disposed in the hand unit 50H may offer an advantage of suppressing the formation of the line of sight for the MWs and/or EWs from the air outlet to the wave sources 20, 40 when incorporated with the proper MS and/or ES. In another example of FIG. 7G, a system 10 is also similar to that of FIG. 7A and includes a heating member 20, a conduit member 30, an actuator member 40, and a body member 50 which includes a hand unit 50H, a coupling unit 50C, and a base unit 50B. However, such a system 10 may also include multiple counter members 80 disposed around the heating and actuator members 20, 40. As described hereinabove, the counter members 80 may include the electric conductors capable of emitting MWs and EWs which propagate along directions at least partially opposite to the MWs and EWs irradiated by the heating and actuator members 20, 40. Accordingly, the counter members 80 may reduce the amounts of the MWs and EWs which are emitted by the sources 20, 40 and propagating through the air outlet 32 and/or to the user. Other configurational and/or operational characteristics of the system 10 of FIGS. 7F and 7G are similar or identical to those of the systems of FIGS. 7A to 7E.

In another exemplary embodiment of this aspect of the present invention, a hair drying system may include a body member which in turn includes a hand unit, a coupling unit, and a base unit, where an actuator member may be incorporated in the base unit, where a heating member may be disposed in the hand unit, and where the hand unit includes an elongated first unit but not any transverse unit. As shown in FIG. 7H, a system 10 is generally similar to that of FIG. 7A and includes a heating member 20, a conduit member 30, an actuator member 40, and a body member 50, where the body member 50 includes a hand unit 50H, a coupling unit 50C, and a body unit 50B, except that the hand unit 50H may be comprised of a single elongated first unit 51. Accordingly, such a hand unit 50H may preferably be arranged to provide a grip portion therealong, and may also include a switch 14 thereon. The coupling unit 50C is then directly connected to a proximal end of the first unit 51 of the hand unit 50H such that the air sucked into a proximal air path 30P may be moved through the coupling unit 50C into a distal air path 30D directly. Other configurational and/or operational characteristics of the system 10 of FIG. 7H are similar or identical to those of the systems of FIGS. 7A to 7G.

Configurational and/or operational variations and/or modifications of the above embodiments of the exemplary systems and various modules thereof described in FIGS. 7A through 7H also fall within the scope of this invention.

It is appreciated that various hair drying systems of FIGS. 7A to 7H are characterized by their configurations that the air outlet is incorporated in one unit but at least one of the wave sources such as the heating and actuator members is incorporated in another unit which is arranged to be disposed away from the unit including such an air outlet. Therefore, such systems guarantee that these units are spaced apart from each other by at least a minimal distance or that the user may dispose one of such units away from the other unit, thereby dispersing a greater portion of the MWs and EWs emitted by such wave sources away from the air outlet and/or user. In this aspect, the above systems are to be distinguished from conventional hair dryer holders which do not incorporate any of the heating and actuator members therein.

As described above, the hand unit may include at least one first elongated unit and at least one second transverse unit. When desirable, the hand unit may include only one of the first unit or second unit. The hand unit may be arranged to have different shapes and/or sizes as long as such a unit may form a grip portion for the user, whether such a grip may be formed in the first or second unit. Such a hand unit may also include at least one mobile section and at least one stationary section such that the mobile section may move between at least two positions while varying the distance from the air outlet to one or both of the wave sources of the system, where such sections may be defined in the first or second unit or in both of such units and where the grip portion may be formed in any of such sections as described above. When desirable, the hand unit may include at least one of the above baffles or at least one of the above bends in order to suppress formation of the line of sight between the air outlet and the wave sources.

The body member and/or its units may extend over any lengths along its curvilinear longitudinal axis and may also define a cross-section of any shapes and/or sizes, as far as such a body member may define a suitable air path from the air inlet to the air outlet of the system. When the body member includes multiple units, at least two of such units may be fluidly coupled to each other, may bifurcate or merge into each other, and the like. The above baffles and/or bends with or without any MS and/or ES may also be incorporated into various locations of the body member and/or its units when it may be desirable to block the formation of the line of sight for the MWs and/or EWs between the air outlet and the wave sources of the system. It is to be understood that the hair drying systems with multiple units such as the hand, coupling, and base units are designed to allow the user to dispose the air outlet as far away from the wave sources of the system as possible. Accordingly, the hand unit with such an air outlet is to be spaced apart from the base unit which may generally incorporate at least one of the heating and actuator members.

The main function of the coupling unit is to allow the hand (or base) unit to move (e.g., rotate, pivot, translate, reciprocate, and so on) with respect to the base (or hand) unit while maintaining the fluid and/or mechanical communication between the hand and base units. Accordingly, the coupling unit may need to movably couple with at least one of the hand and base units or, alternatively, such a coupling unit itself may need to be movable or deformable, thereby disposing the hand (or base) unit in different positions with respect to the base (or hand) unit. Such a coupling unit may preferably allow the hand (or base) unit to move in any direction and/or orientation with respect to the base (or hand) unit within a limit of a length of the coupling unit.

The coupling unit may be specifically designed to allow the hand unit to be spaced apart from the base unit by at least a distance which is greater than a length of a portion of the air path defined in the hand and/or base units by a preset number of times, where the preset number may be, e.g., about 1.0, 1.25, 1.5, 2.0, 3.0, 4.0, 5.0, 6.0, 7.0, 8.0, 9.0, and 10.0. Not only spacing the hand unit away from the base unit, the coupling unit itself may be arranged to change its length between its opposing ends. For example, at least a portion of the coupling unit may be made of and/or include at least one flexible material which may vary its shape, curvature, and/or length between such ends, may vary a distance therebetween, and the like. In another example, the coupling unit may also have multiple rigid sections movably coupled to each other and capable of varying its shape, curvature, and distance between its opposing ends. In another example, at least a portion of the coupling unit may be retractable so that it may move between a fixed number of stops or telescopically, similar to the movements of the mobile sections of the first and/or second units of the hand and/or base units. It is generally preferred that the coupling unit may be made of flexible material or may include deformable bellows therealong.

Depending upon the exact location of the heating member, the coupling unit may be arranged to be made of and/or include various materials with various properties. For example, such materials may be any conventional ones capable of defining and/or maintaining at least one lumen therein when the heating member is incorporated into the hand unit. In another example, such materials may preferably exhibit at least minimal thermal resistance when the heating member is incorporated into the coupling or base unit. In another example, the coupling may be arranged to define multiple lumens therealong, where one of such lumens may be designed to transport the flow of heated air or ambient air, while the other of such lumens may be designed for running various cables and/or axles therealong. Such lumens may be formed concentrically or side by side. When desirable, at least one MS and/or ES may be included along preset locations of the coupling unit, at least one of the above baffles and/or bends may be incorporated thereinto, and the like.

As described hereinabove, the wave sources of the system such as the actuator and heating members may be disposed in any of the above hand, coupling, and base units, as long as both of the members are not to be disposed in the hand unit. Similarly, the motor and impeller of the actuator unit may be disposed in any of the above hand, coupling, and base units, as long as both of the motor and impeller are not disposed in the hand unit.

The system may also include at least one MS and/or ES which have been described in greater detail in the co-pending Applications. For example, the system may include the MS and/or ES disposed on, over, around, in, and/or into at least a portion of the conduit, body, heating, and actuator members. Depending upon needs, such a system may include only the MS or ES. The system may also vary the distance from the air outlet to the wave sources by, e.g., releasably attaching (or detaching) an article including at least one of the MS and ES onto (or away from) various units of the body member. Such a MS may include at least one path member but may not include any magnet member, may include at least one path member and at least one magnet member, and so on, where both the path and magnet members have been disclosed in the co-pending Applications. In general, the ES may shield the user from the EWs through one or more of mechanisms as described in the co-pending Applications. When desirable, the ES may be grounded. Similarly, the MS may shield the user from the MWs through one or more of mechanisms described in the co-pending Applications. The MS (and ES) may be disposed on, over, around or in at least a portion of the conduit, body, actuator, and/or heating members. Such a MS (and ES) may be disposed over at least a (or an entire) portion of the baffle, along the bend, and the like. The system may include at least two baffles at least one of which may include the MS and/or ES and at least another of which may not include the ES and/or MS. Such a system may include more than two baffles at least two of which may be identical to each other, similar to each other or different from each other, and so on. The system may include the MS (or ES) but not the ES (or MS).

The system may be arranged to irradiate through the air outlet, hand unit, and/or coupling unit the MWs having a magnetic field strength no stronger than a preset limit when measured at a preset distance from the air outlet. In the alternative, the system may be arranged to emit through any portion thereof the MWs having a magnetic field strength no stronger than a preset limit when measured at a preset distance from the air outlet. Exemplary values of the preset limits may be 0.1 mG, 0.2 mG, 0.3 mG, 0.5 mG, 0.7 mG, 1 mG, 2 mG, 3 mG, 4 mG, 5 mG, 7 mG, 10 mG, and the like, and exemplary values of the preset distance may be 0.1 cm, 0.2 cm, 0.5 cm, 1 cm, 2 cm, 3 cm, 5 cm, 7 cm, 10 cm, 15 cm, 20 cm, 25 cm, 30 cm, and the like.

The system may include at least one switch which may be arranged to turn on and off at least one of the actuator and heating members and to be disposed in the hand, coupling, and/or base units. The system may also include multiple switches which may be disposed in at least two of such hand, coupling, and base units and may operate as two-way switches. Accordingly, one of the switches may be operated by the hand of the user, while the other switch may be operated by the foot of the user. In addition, such a system may include the heat exchange member, counter member, and other members and/or units as described in conjunction with various systems of FIGS. 1A to 6L.

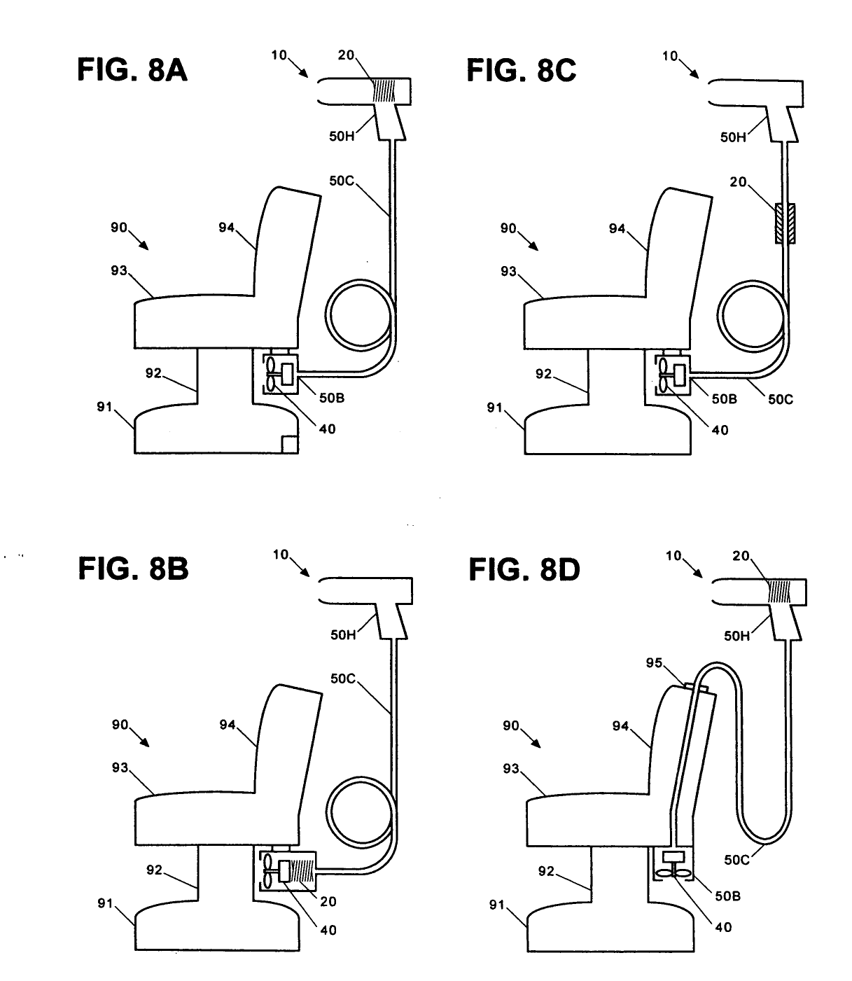

In another aspect of the present invention, a hair drying system may be arranged to work with a stationary or semi-stationary object into which at least a portion of the system may be incorporated. A major advantage of such an assembly is that the portion of the system incorporated into the object may be retained and/or supported by the object, thereby reducing weights and/or volumes of various members and/or units of the system, maintaining at least a minimal distance between various members and/or units of the system, and so on. FIGS. 8A to 8D show cross-sectional views of exemplary hair drying systems each incorporated with a stationary object according to the present invention. It is to be understood that any of the above hair drying systems of FIGS. 7A to 7H may be modified into one or more of following embodiments. Although a chair with a back reset is selected as a representative object in the following embodiments, the hair drying systems may be arranged to form assemblies with other objects as well, where such objects may be any other furnitures and/or structures which may be stationary, semi-stationary or mobile and which may have any shapes and/or sizes, as long as the portion of the hair drying systems may be supported and/or retained thereby fixedly or releasably.

In one exemplary embodiment of this aspect of the present invention, an assembly may consist of any of the above hair drying systems and a chair onto which at least a portion of the system may be releasably and/or fixedly coupled. In one example of FIG. 8A, an assembly includes a hair drying system 10 and a chair 90 which in turn includes a base 91, a shaft 92, a seat 93, and a back rest 94. The base 91 is arranged to be disposed on a floor or ground, the shaft 92 is disposed over the base 91, and the seat is coupled over the shaft 92 fixedly or movably in order to allow an user to rotate the seat 93 with respect the base 91, to flip the seat 93 in different angles with respect thereto, and the like. A hair drying system 10 may be any of the above systems of FIGS. 7A to 7E and/or modifications thereof and include a body member 50 with a hand unit 50H, a coupling unit 50C, and a base unit 50H. For example, a heating member 20 may be incorporated into the hand unit 50H, an actuator member 40 may be disposed in the base unit 50B, and the coupling unit 50C may fluidly couple the hand unit 50H with the base unit 50B. The actuator member 40 is also arranged to releasably or fixedly couple with or to be retained by at least a portion of the chair 90, e.g., under the seat 93 in this embodiment, such that the hand unit 50H is disposed apart from the base unit 50B by at least a preset minimal distance. Therefore, such an assembly of the system 10 and object 90 may allow a greater portion of the MWs and/or EWs emitted by the actuator member 40 to be dispersed from the hand unit 50H and/or the user sitting on the seat 93. In general, the base unit 50B and/or the seat 93 may define matching male and female couplers for the releasable or fixed coupling therebetween. Alternatively, the base unit 50B or the seat 93 may include a magnet and couple with each other by magnetic force. As long as the base unit 50B may releasably and/or fixedly couple with the seat 93 or other parts of the object 90, detailed modes of coupling may not be material within the scope of the present invention.

It is appreciated that the body member 50 of such a system 10 may be fabricated as an unitary article, where at least a portion or multiple portions of the system 10 may be arranged to couple with one or multiple portions of the object 90. In the alternative, various units of the body member 50 may be provided as separate articles which may releasably or fixedly couple with each other. In such an embodiment, one hand unit 50H may be arranged to be used with multiple coupling and/or base units 50C, 50B which couple with different objects. In addition, the system 10 may include other couplers which may be arranged to couple the coupling and/or hand units 50C, 50H of the system 10 with the object 90, thereby retaining such units 50C, 50H when the system 10 is not used. Other configuration and/or operational characteristics of the system 10 of FIG. 8A may be similar or identical to those of the systems of FIGS. 7A to 7H.

In another exemplary embodiment of this aspect of this invention, such an assembly may have any of the above hair drying systems and a chair onto which a greater portion of the system may be releasably or fixedly coupled. In one example of FIG. 8B, an assembly includes a hair drying system 10 and a chair 90 each of which is similar to that of FIG. BA. However, such a system 10 includes at least a substantial portion of a heating member 20 in its base unit 50B. Accordingly, the coupling unit 50C may preferably be arranged to be at least minimally heat-resistant to allow the flow of heated air therethrough. In another example of FIG. 8C, an assembly also includes a hair drying system 10 and a chair 90 each of which is similar to that of FIG. 8A. However, the system 10 incorporates the heating member 20 along the coupling unit 50C. Therefore, at least a portion of the coupling unit 50C may be at least minimally heat-resistant in order to allow the flow of heated air to the distal air path 30D. Other configuration and/or operational characteristics of the system 10 and object 90 of FIGS. 8B and 8C are similar or identical to those of the systems and objects of FIGS. 7A to 7H and FIGS. 8A.

In another exemplary embodiment of this aspect of this invention, such an assembly may have any of the above hair drying systems and a chair into which at least a portion of the system may be incorporated. For example and as shown in FIG. 8D, such an assembly includes a hair drying system 10 and a chair 90 each of which is similar to that of FIG. 8A. However, at least a substantial portion of a coupling unit 50C is incorporated into a seat 93 and/or a back rest 94 of the chair 90 such that a hand unit 50H and a base unit 50B of the system 10 may be fixedly and/or releasably coupled to such an incorporated or embedded portion of the coupling unit 50C. As described hereinabove, the hand or base unit 50H, 50B may be releasably or fixedly coupled to opposing ends of the embedded coupling unit 50C and, when desirable, a single hand or base unit 50H, 50B may be used with multiple coupling units 50C embedded in different objects 90. Other configuration and/or operational characteristics of the system 10 and object 90 of FIG. 8D are similar or identical to those of the systems and objects of FIGS. 7A to 7H and FIGS. 8A to 8C.

Configurational and/or operational variations and/or modifications of the above embodiments of the exemplary systems and various modules thereof described in FIGS. 8A through 8D also fall within the scope of this invention.

It is appreciated that such hair drying systems of FIGS. 8A to 8D offer an benefit of securing at least a portion of the coupling and/or base units of the systems onto various objects, thereby allowing the user to more freely move the hand units. Therefore, such hand units may be more easy to handle and allow the user to more readily suppress the formation of the lines of sight between the air outlets and the wave sources of the systems. In addition, such systems may more effectively suppress the noises from the actuator members.

In order to facilitate secure coupling between the object and the coupling and/or base units of the system, at least one holder or support may be incorporated into the object and/or various units of the system. Alternatively, the base unit may be arranged to as a stand-alone unit which may not be arranged to couple with any object.

It is appreciated that any of such hair drying systems of this invention may also be arranged to emit infrared rays or far-infrared rays, to emit charged ions such as cations and anions, and the like. For example, the system may include one or more ray generators which may emit the infrared or far-infrared rays when heated by the heating member and/or heated air, where such generators may be made from various compounds of silicon oxide, muscovite, tourmaline, lanthanum or other minerals capable of generating such rays when heated. Examples of such materials are provided in detail in U.S. Pat. Nos. 6,798,982 and 6,481,116, both of which are incorporated herein by reference in their entirety. Similarly, the system may also include ion generators which are described in greater detail in U.S. Pat. Nos. 6,901,936, 6,798,982, 6,725,562, and 6,640,049, all of which are incorporated herein by reference in their entirety. It is also appreciated that the ray generators may preferably be disposed to face the air outlet in order to project as much of such rays toward the user as possible. Therefore, major surfaces of such ray generators may be disposed to face the air outlet and/or at least partially transverse to the direction of air flow. Otherwise, a major portion of such rays may propagate along directions away from the air outlet or user. It is presumed that the ions formed by the ion generators are typically ionized molecules of air. Accordingly, such ion generators are also preferably disposed in a direction which may maximize a contact area between the ion generators and flow of air. Such ray and/or ion generators may be provided separately and disposed along the conduit (or air path) in the aforementioned directions. Alternatively, such ray and/or ion generators may be incorporated into and/or disposed over the above baffles and/or bends as well.

Unless otherwise specified, various features of one embodiment of one aspect of the present invention may apply interchangeably to other embodiments of the same aspect of this invention and/or embodiments of one or more of other aspects of this invention. Accordingly, any of the conduits and baffles of FIGS. 2A to 2H and FIGS. 3A to 3X may be incorporated into any conduit and body members of FIGS. 4A to 4F and FIGS. 5A to 5T. In addition, any of the above MS and/or ES may be incorporated into any members of the hair drying system of the present invention. Moreover, any of the hair drying systems of FIGS. 1A to 6L may be modified into any of such systems of FIGS. 7A to 8D in such a way that the air outlet of the systems of FIGS. 1A to 6L may be disposed in the hand unit of the systems of FIGS. 7A to 8D and that at least one of the heating and actuator members may then be disposed in the coupling and/or base units of the systems of FIGS. 7A to 8D.

The hair drying system of the present invention may also include various control mechanisms commonly employed in other conventional hair drying devices. For example, the system may include various control mechanisms, power supply mechanisms, mechanisms for controlling temperature or flow rate, and/or safety mechanisms.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

What is claimed is:

1. A hair drying system for generating a flow of heated air through at least one air outlet thereof while one of preventing and minimizing formation of a line of sight between said air outlet and at least one source of said system which irradiates magnetic waves and electric waves of electromagnetic waves comprising:
at least one conduit member which is configured to define therealong at least one conduit for a flow of air, to define at least one air inlet in at least one end of said conduit, and to form said air outlet in at least another end of said conduit;
at least one actuator member which is configured to take air into said conduit through said air inlet, to move said air through said conduit, and to discharge said air out of said conduit through said outlet, thereby generating said flow of said air while irradiating said waves; and
at least one heating member which is configured to be disposed along said conduit (or near or on said air inlet), to generate heat by flowing electric current therein while irradiating said waves, and to transfer at least a portion of said heat onto said air flowing through said conduit, thereby generating said flow of heated air,
wherein said conduit member is configured to prevent (or at least minimize) formation of said line of sight between said air outlet and at least one of said actuator and heating members but to allow said flow through said conduit.

2. The system of claim 1, wherein said conduit member has along said conduit at least one baffle which is configured to obstruct a cross-section of said conduit while allowing said flow through said conduit, thereby one of preventing and minimizing formation of said line of sight between said air outlet and at least one of said heating and actuator members.

3. The system of claim 2, wherein said conduit member is configured to have a plurality of baffles at least two of which are configured to obstruct different areas of said cross-section of said conduit.

4. The system of claim 3, wherein said baffles are configured to overlap at least portions of each other for obstructing an entire portion of said cross-section of said conduit while allowing said flow of said heated air through said conduit.

5. The system of claim 2 further comprising at least one magnetic shield which is configured to one of prevent and minimize propagation of said magnetic waves therethrough and to be disposed in at least a portion of said baffle for obstructing a line of sight for said magnetic waves between said air outlet and said at least one of said actuator and heating members.

6. The system of claim 5 further comprising at least one electric shield which is configured to one of prevent and minimize propagation of said electric waves therethrough and to be also disposed in at least a portion of said baffle for obstructing a line of sight for said electric waves between said air outlet and said at least one of said actuator and heating members.

7. The system of claim 1, wherein said conduit member is configured to form along said conduit at least one bend which is configured one of to prevent and to minimize formation of said line of sight between said air outlet and at least one of said heating and actuator members.

8. The system of claim 7 further comprising at least one magnetic shield which is configured to one of prevent and minimize propagation of said magnetic waves therethrough and to be incorporated along at least a portion of said conduit for obstructing a line of sight for said magnetic waves between said air outlet and said at least one of said actuator and heating members.

9. The system of claim 7 further comprising at least one electric shield which is configured to one of prevent and minimize propagation of said electric waves therethrough and to be also incorporated along at least a portion of said conduit for obstructing a line of sight for said electric waves between said air outlet and said at least one of said actuator and heating members.

10. The system of claim 1, wherein said conduit is configured to include at least one stationary unit and at least one mobile unit which is configured to move between at least two states relative to said stationary unit, wherein said air outlet is incorporated into said mobile unit, and wherein said at least one of said members is incorporated into said stationary unit, thereby varying a distance from said air outlet to said at least one of said members as said mobile unit moves between said states.

11. The system of claim 1, wherein said conduit is configured to include at least one stationary unit and at least one mobile unit which is configured to move between at least two states with respect to said stationary unit, wherein said air outlet is incorporated into said stationary unit, and wherein said at least one of said members is incorporated into said mobile unit, thereby varying a distance from said air outlet to said at least one of said members as said mobile unit moves between said states.

12. The system of claim 1, wherein said actuator and heating members are configured to irradiate said waves propagating along at least partially opposite directions, thereby canceling at least portions of said waves irradiated from one of said actuator and heating members by at least portions of said waves irradiated from the other of said actuator and heating members.

13. The system of claim 1further comprising at least one counter member, wherein said actuator member is configured to irradiate first of said waves, wherein said heating member is configured to irradiate second of said waves, and wherein said counter member is configured to irradiate third of said waves propagating in a direction which is at least partially opposite to a direction of at least one of said first and second waves, thereby canceling at least portions of at least one of said first and second waves by at least portions of said third waves.

14. A hair drying system for generating a flow of heated air through at least one air outlet thereof while one of preventing and minimizing formation of a line of sight for magnetic and electric waves between said air outlet and at least one source of said system irradiating said waves and protecting a target from said waves comprising:
at least one conduit member which is configured to define therealong at least one conduit for a flow of air, to define at least one air inlet in at least one end of said conduit, and to form said air outlet in at least another end of said conduit;
at least one actuator member which is configured to take air into said conduit through said air inlet, to move said air through said conduit, and to discharge said air out of said conduit through said outlet, thereby generating said flow of said air while irradiating said waves;
at least one heating member which is configured to be disposed along at least a portion of said conduit, to generate heat by flowing electric current therein while emitting said waves, and to transfer at least a portion of said heat onto said air flowing through said conduit, thereby generating said flow of heated air; and
at least one magnetic shield which is configured to prevent at least a portion of said magnetic waves from penetrating therethrough, to be disposed in said conduit member in at least one location thereof which is selected between at least one of said actuator and heating members and air outlet, and to obstruct a cross-section of said conduit while allowing said flow, thereby one of preventing and minimizing formation of said line of sight for said magnetic waves therebetween and protecting said target from said waves; and

15. The system of claim 14 further comprising at least one electric shield which is then configured to prevent at least a portion of said electric waves from penetrating therethrough, to be disposed in said conduit member in at least one location thereof which is selected between said air outlet and at least one of said actuator and heating members, and to obstruct a cross-section of said conduit while allowing said flow, thereby one of preventing and minimizing formation of said line of sight for said electric waves therebetween and protecting said target from said waves.

16. The system of claim 14, wherein said conduit member includes along said conduit at least one baffle which is configured to obstruct a cross-section of said conduit while allowing said flow of air through said conduit and to also include said magnetic shield in at least a portion thereof, thereby one of preventing and minimizing formation of a line of sight for said magnetic waves between at least one of said heating and actuator members and said air outlet.

17. The system of claim 14, wherein said conduit member is configured to form along said conduit at least one bend, wherein at least a portion of said conduit is configured to incorporate said magnetic shield, and wherein said conduit with said bend is further configured to one of prevent and minimize formation of a line of sight for said magnetic waves between said air outlet and at least one of said heating and actuator members.

18. A method of forming a hair drying system for taking in air by its actuator member while emitting electromagnetic waves, heating said air by its heating member while emitting said waves, transporting said heated air along its conduit, and discharging said heated air through its air outlet by said actuator member while reducing an amount of said waves through said air outlet comprising the steps of:
disposing at least a portion of at least one of said members along said conduit; and
configuring said conduit to one of prevent and minimize formation of a line of sight from said air outlet to at least one of said actuator member and heating member, thereby performing said reducing while discharging said heated air out of said system.

19. The method of claim 18 further comprising the steps of:
providing at least one magnetic shield for one of preventing and minimizing propagation of at least portions of said waves therethrough; and
installing said magnetic shield in at least one portions of said conduit, thereby performing said reducing.

20. The method of claim 18 further comprising the steps of:
providing at least one magnetic shield for one of preventing and minimizing propagation of at least portions of said waves therethrough; and
installing said electric shield in at least one portions of said conduit, thereby performing said reducing.
